(19) United States
(12) Patent Application Publication
(10) Pub. No.: US 2024/0061966 A1
(43) Pub. Date: Feb. 22, 2024

(54) SYSTEMS FOR AND METHODS OF SHAPING NON-SLIDING ORTHODONTIC ARCHFORMS

(71) Applicant: Swift Health Systems Inc., Irvine, CA (US)

(72) Inventors: Todd Oda, Torrance, CA (US); Alston Chung, Redondo Beach, CA (US); Kevin Ruckley, San Diego, CA (US)

(21) Appl. No.: 18/448,414

(22) Filed: Aug. 11, 2023

Related U.S. Application Data
(60) Provisional application No. 63/371,595, filed on Aug. 16, 2022.

(51) Int. Cl. G06F 30/10; A61C 7/20; B21F 1/00

(52) U.S. Cl. CPC G06F 30/10; A61C 7/20; B21F 1/00

(57) ABSTRACT

Systems for and method of shaping non-sliding orthodontic archforms. A system with a robot and a plurality of arms. The robot can indicate a position for the plurality of arms based on a virtual model of a patient's teeth in aligned positions. The plurality of arms can be moved to the positions indicated by the robot. An archform can be coupled to the plurality of arms to assume a custom shape corresponding to the patient's teeth in the virtual model in the aligned positons and configured to move the patient's teeth to the aligned positions. The archform can be set in the custom shape by heat such that the custom shape is the memorized shape of the archform.

### CROSS REFERENCE TO RELATED APPLICATIONS

This application claims priority to U.S. Provisional Patent Application No. 63/371,595, filed Aug. 16, 2022, which is incorporated herein by reference in its entirety. Any and all applications, if any, for which a foreign or domestic priority claim is identified in the Application Data Sheet of the present application is hereby incorporated by reference under 37 CFR 1.57.

### BACKGROUND

### Field

The present disclosure relates in some aspects to systems for and methods of shaping orthodontic appliances such as archforms and in certain aspects to systems for and methods of shaping non-sliding orthodontic archforms.

### SUMMARY

Teeth can be moved by bonding orthodontic brackets to the lingual or buccal surfaces of a patient's teeth and coupling an archform to the bonded orthodontic brackets. The archform can exert forces on the brackets using sliding or non-sliding mechanics, which can cause the patient's teeth to move toward a planned alignment. Custom shaping an archform to move the patient's teeth to the planned alignment can be difficult, expensive, and/or time consuming. Disclosed herein are methods and systems for shaping an archform in a custom 3D shape that at least addresses the foregoing issues. The methods and systems are described in reference to custom 3D shaping a non-sliding archform but the disclosed methods and systems can be used to custom 3D shape sliding or partially sliding archforms as well.

In some variants, a system for custom shaping an archform for orthodontic treatment is disclosed herein. The system can include a plurality of arms. Each of the plurality of arms can include a clamp that may hold a portion of the archform. The system can include a robot that may include a probe. The robot may be able to indicate with the probe positions for each of the plurality of arms based on a positioning of digital markers in a virtual model of teeth of a patient in a planned alignment. The archform may assume a custom nonplanar shape corresponding to the positioning of the digital markers in the virtual model with the archform held by clamps of the plurality of arms in positions indicated by the robot.

In some variants, the custom nonplanar shape may move the teeth of the patient to positions corresponding to the planned alignment of digital teeth in the virtual model with the archform, in the custom nonplanar shape, coupled to brackets in a patient's mouth.

In some variants, the system may include a heating element that may heat set the archform with the archform in the custom nonplanar shape.

In some variants, the portion of the archform may be a connector that can be coupled to an orthodontic bracket.

In some variants, the archform may include a shape memory material.

In some variants, the probe may include a plurality of protrusions and each of the plurality of arms may include a plurality of holes that may correspond to the plurality of protrusions. The plurality of protrusions may be inserted into the plurality of holes to orient each of the plurality of arms to a position indicated by the robot.

In some variants, the probe may include a plurality of holes and each of the plurality of arms may include a plurality of protrusions corresponding to the plurality of holes. The plurality of protrusions may be inserted into the plurality of holes to orient each of the plurality of arms to a position indicated by the robot.

In some variants, each of the plurality of arms may include a feature that can interface with the probe of the robot to assist in positioning the plurality of arms in the positions indicated by the robot.

In some variants, each of the plurality of arms may include one of a plurality of holes and a plurality of protrusions. The probe may include the other of the plurality of holes and the plurality of protrusions to facilitate positioning the plurality of arms in positions indicated by the robot.

In some variants, the clamp may include a screw that can hold the portion of the archform.

In some variants, the holder may include a moveable jaw and a fixed jaw that can clamp the portion of the archform.

In some variants, the moveable jaw may be disposed on pins. The moveable jaw may be translated on the pins toward and away from the fixed jaw.

In some variants, the holder may include a plurality of pins. The plurality of pins may interface with the portion of the archform to secure the portion of the archform.

In some variants, each of the plurality of arms may be magnetically attracted to the probe.

In some variants, the robot may be positioned above the plurality of arms.

In some variants, each of the plurality of arms may include electrical leads that can apply an electrical current to the archform to heat set the archform in a custom shape.

In some variants, a system for custom shaping an archform for orthodontic treatment is disclosed herein. The system may include a plurality of arms. Each of the plurality of arms may include a holder that can secure a portion of the archform. The system may include a robot that can have an indicator. The robot may indicate with the indicator positions for the plurality of arms based on a planned alignment of digital teeth in a virtual model. The archform may assume a custom nonplanar shape corresponding to the planned alignment of digital teeth in the virtual model with the archform held by the holders of the plurality of arms in positions indicated by the robot.

In some variants, a method of custom shaping an archform is disclosed herein. The method can include indicating positions for a plurality of arms that may hold portions of an archform. The positions may correspond to positions of digital markers in a virtual model of teeth of a patient in a planned alignment. The method can include moving the plurality of arms to the indicated positions. The method can include securing the portions of the archform to the plurality of arms such that the archform assumes a custom nonplanar shape corresponding to the positions of the digital markers in the virtual model of teeth of the patient in the planned alignment.

In some variants, indicating positions for the plurality of arms may include actuating a robot to indicate the positions.

In some variants, the custom nonplanar shape may move the patient's teeth toward positions corresponding to the planned alignment of the digital teeth in the virtual model when the archform is coupled to brackets in a patient's mouth.

In some variants, the custom nonplanar shape may move the patient's teeth toward positions corresponding to the planned alignment of the digital teeth in the virtual model when the archform is bonded to the patient's teeth.

In some variants, the portions of the archform are connectors that may couple with orthodontic brackets.

In some variants, securing the portions of the archform may include clamping the portions with clamps of the plurality of arms.

In some variants, securing the portions of the archform may include coupling the clamps to the plurality of arms.

In some variants, securing the portions of the archform with the clamps may include positioning connectors of the archform between a movable jaw and a fixed jaw of the clamp of each of the plurality of arms and advancing the moveable jaw toward the fixed jaw to clamp the connectors.

In some variants, clamping the portions with clamps of the plurality of arms may include positioning connectors of the archform between a screw and a fixed jaw of each clamp of each of the plurality of arms and advancing the screw toward the fixed jaw to clamp the connector between the screw and the fixed jaw.

In some variants, securing the portions of the archform with the clamps may include disposing connectors of the archform on pins of the clamps.

In some variants, the archform may be a non-sliding archform that may be installed on the lingual side of a patient's teeth.

In some variants, the method may include heat setting the archform in the custom nonplanar shape such that the custom nonplanar shape is the default shape of the archform.

In some variants, heat setting may include heating the archform with a heat gun.

In some variants, heat setting may include applying an electrical current to the archform.

In some variants, the method may include heat treating the archform to set a transition temperature for the archform between a martensite phase and an austenite phase.

In some variants, actuating the robot to indicate positions for the plurality of arms may include moving a probe with protrusions to the positions.

In some variants, moving the plurality of arms to the positions indicated by the robot may include moving each of the plurality of arms to position the protrusions of the probe through holes in the plurality of arms.

In some variants, a method of custom shaping an archform is disclosed herein. The method may include receiving scan data of a patient's mouth. The method may include creating a virtual model of the patient's teeth with the scan data. The method may include moving teeth of the virtual model to a planned alignment. The method may include placing digital brackets on the teeth of the virtual model. The method may include positioning digital markers in the digital brackets. The method may include actuating a robot to indicate positions for a plurality of arms based on the positioning of the digital markers. The method may include moving the plurality of arms to the positions indicated by the robot. The method may include securing an archform to the plurality of arms such that the archform assumes a custom nonplanar shape corresponding to the positing of the digital markers in the digital brackets in the virtual model.

In some variants, the method may include moving a heating element with the robot to heat set the archform in the custom nonplanar shape.

In some variants, the method may include heat treating the archform to set a transition temperature for the archform between a martensite phase and an austenite phase.

In some variants, securing the archform to the plurality of arms may include clamping connectors of the archform with a plurality of clamps and coupling the plurality of clamps to the plurality of arms.

In some variants, clamping the connectors may include rotating screws of the plurality of clamps to secure the connectors between the screws and fixed jaws of the clamps.

In some variants, clamping the connectors may include rotating screws of the plurality of clamps to secure the connectors between moveable jaws and fixed jaws of the clamps.

In some variants, actuating the robot to indicate positions for the plurality of arms may include moving a probe with protrusions to the positions.

In some variants, moving the plurality of arms to the positions indicated by the robot may include moving each of the plurality of arms to position the protrusions of the probe through holes in the plurality of arms.

In some variants, a system for custom shaping an archform for orthodontic treatment is disclosed herein. The system can include a plurality of arms. Each of the plurality of arms can include a clamp that can hold a portion of the archform. The system can include an automated probe that can indicate positions for each of the plurality of arms based on a positioning of digital markers in a virtual model of teeth of a patient in a planned alignment. The archform can assume a custom nonplanar shape corresponding to the positioning of the digital markers in the virtual model with the archform held by clamps of the plurality of arms in positions indicated by the automated probe.

In some variants, the custom nonplanar shape can move the teeth of the patient to positions corresponding to the planned alignment of digital teeth in the virtual model with the archform, in the custom nonplanar shape, coupled to brackets in a patient's mouth.

In some variants, the system can include a heating element that can heat set the archform with the archform in the custom nonplanar shape.

In some variants, the portion of the archform can be a connector that can be coupled to an orthodontic bracket.

In some variants, the archform can include a shape memory material.

In some variants, the automated probe can include a plurality of protrusions and each of the plurality of arms can include a plurality of holes corresponding to the plurality of protrusions. The plurality of protrusions can be inserted into the plurality of holes to orient each of the plurality of arms to a position indicated by the automated probe.

In some variants, the automated probe can include a plurality of holes and each of the plurality of arms can include a plurality of protrusions corresponding to the plurality of holes. The plurality of protrusions can be inserted into the plurality of holes to orient each of the plurality of arms to a position indicated by the automated probe.

In some variants, each of the plurality of arms can include a feature that can interface with the automated probe to assist in positioning the plurality of arms in the positions indicated by the automated probe.

In some variants, each of the plurality of arms can include one of a plurality of holes and a plurality of protrusions. The automated probe can include the other of the plurality of holes and the plurality of protrusions to facilitate positioning the plurality of arms in positions indicated by the automated probe.

In some variants, the clamp can include a screw that can hold the portion of the archform.

In some variants, the holder can include a moveable jaw and a fixed jaw that can clamp the portion of the archform.

In some variants, the moveable jaw can be disposed on pins. The moveable jaw can be translated on the pins toward and away from the fixed jaw.

In some variants, the holder can include a plurality of pins. The plurality of pins can interface with the portion of the archform to secure the portion of the archform.

In some variants, each of the plurality of arms can be magnetically attracted to the probe.

In some variants, the automated probe can be positioned above the plurality of arms.

In some variants, each of the plurality of arms can include electrical leads that can apply an electrical current to the archform to heat set the archform in a custom shape.

In some variants, the system can include one or more temperature sensors.

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure.

FIG. 1A illustrates an archform.

FIG. 1B illustrates a connector of the archform.

FIG. 1C illustrates the archform with a custom shape corresponding to a planned alignment of a patient's teeth.

FIG. 2 illustrates an orthodontic bracket.

FIG. 3 illustrates the connector of the archform coupled to the orthodontic bracket.

FIG. 4A illustrates another archform.

FIG. 4B illustrates another archform.

FIG. 5A illustrates a system for custom shaping an archform.

FIG. 5B illustrates another view of the system shown in FIG. 5A without a robot.

FIG. 6 illustrates an arm of the system.

FIG. 7A illustrates an end portion of the arm (e.g., holder) that holds the connector of an archform.

FIG. 7B illustrates a probe of the robot of the system.

FIG. 7C illustrates the probe and end portion of the arm interfacing to properly position the holder of the arm.

FIGS. 8A and 8B illustrate fixed jaws of the end portion (e.g., holder) of the arm of the system.

FIG. 8C illustrates the connector of the archform positioned between the fixed jaws and pins of the end portion (e.g., holder) of the arm of the system.

FIGS. 8D and 8E illustrate a movable jaw of the arm (e.g., holder) of the system.

FIGS. 8F and 8G illustrate the movable jaw and the fixed jaw clamping the connector of the archform.

FIG. 9 illustrates an arm segment of the system.

FIG. 10 illustrates the robot indicating a position for the arm segment.

FIG. 11 illustrates a holder of the arm segment decoupled from the arm segment and holding an archform.

FIG. 12 illustrates the holder holding the archform and being coupled with the arm segment.

FIGS. 13A and 13B illustrate a moveable jaw that can be incorporated into the holder to clamp the archform.

FIG. 14 illustrates the plurality of arms and probe of the robot.

FIG. 15 illustrates an enlarged view of the probe of the robot.

FIGS. 16A, 16B, and 16C illustrate the system with different lighting to indicate status.

FIG. 17 illustrates a schematic of a system including a scanning device, design system, shaping system, and/or clinician system.

FIG. 18 illustrates a method of developing and communicating a virtual model of a patient's teeth for a treatment plan.

FIG. 19 illustrates a method of shaping an archform.

FIGS. 20A-20M illustrate various user interfaces for the system.

FIG. 21 illustrates a system for custom shaping an archform.

FIG. 22 illustrates an arm of the system.

FIG. 23 illustrates a probe of a robot and end portion of the arm interfacing to properly position the holder of the arm.

FIGS. 24A and 24B illustrate various views of a holder.

FIG. 24C illustrates the holder being coupled to the end portion of the arm.

FIGS. 25A and 25B illustrate an archform clamped in the holders of the arms of the system.

FIG. 26 illustrates a holder, while clamping the archform, being coupled to the end portion of the arm.

FIG. 27 illustrates the probe and a heat gun.

FIG. 28 illustrates the heat gun heating the archform to shape set the archform in the configuration held by the holders of the arms.

FIG. 29A illustrates a temperature sensor disposed proximate the heat gun.

FIG. 29B illustrates a temperature sensor disposed on an arm.

FIGS. 30-37 illustrate various user interfaces for the system.

### DETAILED DESCRIPTION

Malocclusion of the teeth may be treated using orthodontic brackets and archforms to move the patient's teeth using sliding or non-sliding mechanics. For example, scans of a patient's teeth can be taken and a digital model (e.g., virtual model) of the patient's teeth can be created, at least in part, from the scans. The teeth of the digital model can be moved from positions of malocclusion (e.g., first positions) to second positions, which may be a planned alignment of the teeth, which may be a final planned alignment of the teeth. Digital brackets can be placed, respectively, on the lingual or buccal surfaces of the teeth in the digital model. In some variants, the digital brackets can be placed before moving the teeth of the digital model from the positions of malocclusion (e.g., first positions) to the second positions (e.g., planned alignment). The positions of the digital brackets on the teeth of the digital model in the second positions can correspond to a custom shape of an archform that can move the patient's teeth from the first positions of malocclusion to the second positions. For example, digital markers can be positioned on and/or in the digital brackets to indicate positions for the connectors of the archform with the archform in a custom 3D shape that can move the patient's teeth to the second positions. In some variants, the digital brackets may include features to indicate placement of the digital markers. In some variants, a software program may automatically place the digital markers on and/or in the digital brackets. In some variants, the digital brackets may include digital markers. In some variants, no digital brackets are used and the positions of the teeth in the digital model can correspond to a custom shape of an archform that can move the patient's teeth from the first positions to the second positions. For example, the digital markers can be positioned on and/or proximate the digital teeth in the digital model without digital brackets.

A system can include a plurality of arms and a robot that can custom 3D shape an archform based on the digital model. For example, the robot can indicate a position for each of the plurality of arms in space that corresponds to a position of a digital marker disposed on and/or in a digital bracket in the digital model. As described herein, each digital marker can correspond to a connector of the archform. An operator can move each of the plurality of arms to a position indicated by the robot. The operator can couple the archform to each of the plurality of arms such that the archform assumes a custom 3D shape corresponding to the positions of the digital markers in the digital model. In some variants, the plurality of arms can automatically move to positions indicated by the robot. In some variants, the robot can couple the archform to each of the plurality of arms. In some variants, the plurality of arms can automatically move to positions corresponding to the positions of the digital markers in the digital model with the teeth in the second positions without the robot indicating the positions. In some variants, the system can be used to custom 3D shape an archform based on the positioning of digital markers on digital teeth in the digital model without digital brackets. In some variants, a digital archform can be designed in the digital model with the teeth of the digital model in the second positions and the system can custom shape the archform based on the digital archform. In some variants, the system and/or digital model can compensate for material characteristics of the archform. For example, the forces exerted by the archform to move the patient's teeth toward the second positions may decrease as the patient's teeth get closer to the second positions to the extent that, if not taken into account, the archform may be unable to completely move the patient's teeth to the second positions. Accordingly, the archform can be custom 3D shaped to compensate for these decreasing forces. For example, absent the reactionary forces of the patient's teeth in the second positions, connectors of the custom-shaped archform may be positioned beyond the positions of the corresponding digital markers, digital brackets, and/or digital teeth of the digital model in the planned alignment to compensate for the decreasing forces.

The archform, which may also be referred to as an archwire, can be made of a shape memory material, such as a shape memory alloy (e.g., nickel-titanium alloy such as Nitinol) and/or a shape memory polymer. The archform can be cut (e.g., laser, waterjet, plasma cut, punching, etc.) from a sheet of material (e.g., shape memory material). In some variants, the archform can be bent with a wire bender from a wire of material (e.g., shape memory material). The archform can include connectors (e.g., bracket connectors, anchors) that can be coupled to brackets or bonded directly to teeth and interproximal segments (e.g., interproximal loops) that can be disposed between connectors and can move one or more teeth of the patient. When cut from the sheet of material, the archform can have a substantially flat two-dimensional shape and/or otherwise planar shape. When the wire is bent with the wire bender, the archform can have a substantially flat two-dimensional shape and/or otherwise planar shape. The archform can be deflected from the two-dimensional shape and coupled, as detailed herein, to the holders of the plurality of arms of the system to assume the custom nonplanar shape. For example, the connectors of the archform can be coupled to the holders of the plurality of arms such that the connectors are in positions corresponding to the positions of the digital markers in the digital model of the patient's teeth in the second positions. While retained in the custom nonplanar shape by the holders of the plurality of arms, the archform can be heat set. The setting of the archform can be accomplished by way of exposure to heat with a heating element, which can at least be accomplished with an oven, furnace, heat gun, and/or other suitable devices. For example, the robot can apply heat to the archform with a heating element, such as a heat gun. In some variants, electrical current can be applied to the archform to set the archform in the custom shape. Setting the archform can set a new default or memorized shape (e.g., configuration) for the archform such that the archform is biased toward the default or memorized shape when deflected therefrom. Accordingly, if the archform is deflected from the memorized custom nonplanar shape, the archform can exert forces to return the archform back to the memorized custom nonplanar shape.

An indirect bonding (IDB) tray can be formed based on the digital model. The teeth of the digital model, with the digital brackets disposed thereon, can be returned back to the positions of malocclusion that can reflect the current positions of the patient's teeth. In some variants, the IDB tray can be formed based on the digital model with digital brackets placed on the maloccluded teeth of the digital model prior to movement of the teeth to the second positions. An IDB tray can be 3D printed based on the digital model and/or over molded on a physical model of the patient's teeth. The IDB tray can be sized and shaped to fit over the teeth of the patient. The IDB tray can include wells (e.g., pockets, recesses, etc.) that can house orthodontic brackets therein. The wells can be positioned based on the corresponding positioning of the digital brackets in the digital model.

Orthodontic brackets can be placed in respective wells of the IDB tray with contact surfaces (e.g., bonding surfaces) exposed. An adhesive can be applied to the contact surfaces and the loaded IDB tray can be placed over the teeth of the patient, positioning the orthodontic brackets at locations on the teeth of the patient that correspond to the positioning of the digital brackets on the teeth in the digital model in the first positions. The orthodontic brackets can be bonded to the teeth of the patient, which can be facilitated by exposing the adhesive to air, light (e.g., UV light), heat, low temperatures, and/or chemical(s).

With the orthodontic brackets bonded to the teeth of the patient, the custom shaped archform can be deflected from the custom 3D shape and coupled to the bonded orthodontic brackets. The connectors of the archform can be coupled, e.g., locked, to the bonded orthodontic brackets such that the archform does not slide with respect to the brackets. As described herein, the deflected archform can exert forces on the teeth of the patient as the archform exerts forces to move back toward the undeflected position (e.g., memorized custom nonplanar shape), which can move the teeth of the patient, using non-sliding mechanics, toward seconds positions that correspond to the second positions of the teeth in the digital model (e.g., planned alignment of the teeth). In some variants, the archform can be deflected from the custom shape and bonded directly to the patient's teeth, including buccal or lingual surfaces.

In some variants, a series of archforms can be sequentially installed in the patient's mouth (e.g., coupled to the brackets) and replaced to move the patient's teeth from positions of malocclusion to the second positions. For example, an initial archform set in the custom nonplanar shape may be used for an initial stage of treatment for initially moving the teeth of the patient toward the second positions. An intermediate archform set in the custom nonplanar shape, which may be stiffer than the initial archform, may be used for an intermediate stage of treatment for moving the teeth of the patient closer toward the second positions. A final archform set in the custom nonplanar shape, which may be stiffer than the intermediate archform, may be used for a final stage of treatment for moving the teeth of the patient closer toward or to the second positions. In some variants, the interproximal segments, which can include interproximal loops, can be increasingly stiffer with each successive archform (e.g., the interproximal segments of the intermediate archform are stiffer than those of the initial archform). In some variants, one archform is used in a treatment plan instead of multiple. In some variants, two, three, four, five, or more archforms may be used for each arch (e.g., upper and lower arches) in a treatment plan. Malocclusion of the teeth may be treated using one or more archforms to move the patient's teeth using non-sliding and/or sliding mechanics.

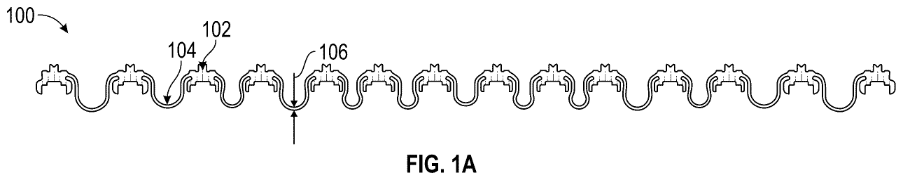

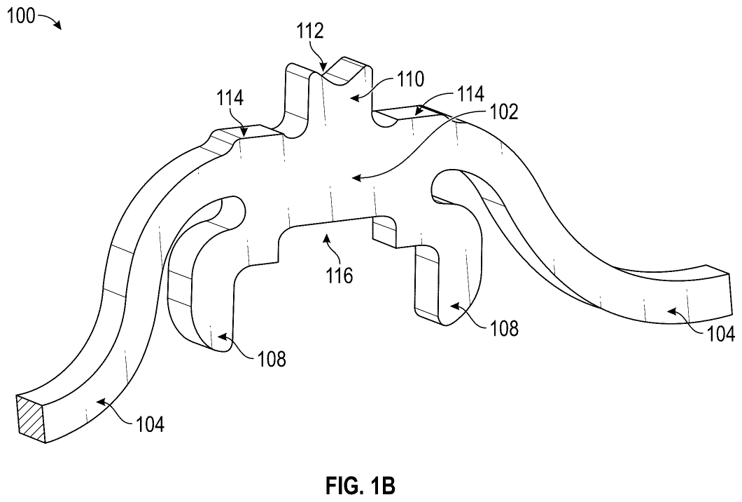

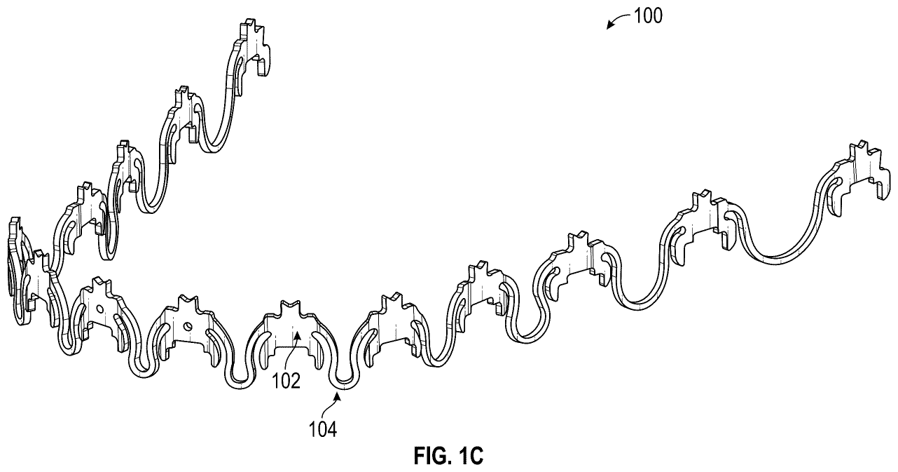

FIG. 1A illustrates an example embodiment of an archform 100, which can also be referred to as an archwire. The illustrated embodiment of the archform 100 along with other embodiments of the archform are described in U.S. patent application Ser. No. 17/303,860, filed Jun. 9, 2021, now published as U.S. Publication No. 2021/0401548, the entirety of which is hereby incorporated by reference herein. As will be described in detail below, the present disclosure includes aspects of a system for and method of shaping an archform such as the archform 100 described herein and in U.S. Pat. No. 9,427,291. However, while the systems for and methods of shaping an archform are particularly useful in forming the described archform 100 it should be appreciated that aspects of the system for and method of shaping an archform described herein can have utility in forming other types of orthodontic archforms including archforms that utilize sliding mechanics and/or positioned buccally rather than lingually. The archform 100 can have a polygonal (e.g., rectangular, square), circular, oval, irregular, and/or other shaped cross-section. The archform 100, as described herein, can be cut (e.g., laser, waterjet, punching, etc.) from a sheet of material, such as shape memory material, which can include shape memory alloys (e.g., nickel titanium such as Nitinol) and/or shape memory polymers. The archform 100, as illustrated in FIG. 1A, has a planar (e.g., flat) shape. The archform 100 can correspond to a segment of an upper or lower dental arch of a patient. The archform 100 can correspond to an entirety of an upper or lower dental arch of a patient.

The archform 100 can include a plurality of connectors or connector portions 102 (e.g., bracket connectors, anchors) that can be coupled to orthodontic brackets to install the archform 100 in the mouth of a patient and/or be directly bonded to a patient's teeth without an orthodontic bracket. The archform 100 can include a plurality of interproximal segments 104. The interproximal segments 104 can be disposed between adjacent connectors 104. The interproximal segments 104 can correspond to interdental spaces between adjacent teeth of the patient. The interproximal segment 104 can include loops. The loops can extend in a gingival direction when the archform 200 is installed in the mouth, which can improve aesthetics and/or facilitate flossing. The loops can open to move adjacent teeth apart from each other. The loops can close to move adjacent teeth closer together. The loops can be various shapes, including U, T, tear-drop, triangular, rectangular, boot, and/or others. The loops of the archform 100 can have varying rigidity. For example, the forces to move molars may be greater than other teeth; accordingly, the loops adjacent the molars may be more rigid than loops not adjacent molars. The rigidity can vary due to the curvature of the loop, shape of the loop, size of the loop, and/or width (e.g. dimension 103). In some variants, the loops of the intermediate archform may be more rigid than corresponding loops of the initial archform, and the loops of the final archform may be more rigid than the corresponding loops of the intermediate archform. The loops can extend (e.g., curve) gingivally down from one connector 102 to an intermediate position and back up occlusally to another adjacent connector 102 such that the loop is open in an occlusal direction, which may be beneficial for flossing.

FIG. 1B illustrates the connector 102 (e.g., bracket connector, anchor, male fastener) of an archform 100. The connector 102 can be coupled to an orthodontic bracket such that the connector 102 does not slide with respect to the orthodontic bracket. In some variants, the connector 102 can be directly coupled (e.g., bonded, adhered) to the tooth of a patient. The connector 102 can be oriented in different orientations to move a tooth of a patient. The connector 102 can be disposed between interproximal segments 104. The interproximal segments 104, as described herein, can apply forces to adjacent connector(s) 102 to move teeth of a patient.

The connector 102 can have arms 108. The arms 108 can extend in a direction that is opposite that of a tab 110 (e.g., tongue) of the connector 102. The arms 108 can extend in at least an occlusal or gingival direction. The arms 108 can grip one or more features of an orthodontic bracket to help secure the connector 102 and/or provide improved control of a tooth of the patient. The arms 108 can grip a retainer of the orthodontic bracket. For example, the arms 108 can grip, hold, grasp, hug, snap around, and/or otherwise interface with the mesial and distal sides of the retainer. In some variants, the arms 108 can hold the archform 100 (e.g., connector 102) in place on the bracket as an operator positions a tool to secure the connector 102 to the bracket. The arms 108 can include outer sides that are curved, which can help the arms 108 to better grip the retainer of the bracket.

A recess 116, also referred to as a gap, can be disposed between the arms 108. The recess 116 can receive a C spring of the orthodontic bracket and/or other feature when the connector 102 is locked into a slot of the orthodontic bracket. The periphery defining at least a portion of the recess 116 can contact the C spring. The C spring can apply a force against the periphery of the recess 116 to push the connector 102 against stops of the bracket which can position a portion of the connector 102 under overhangs of the stops. The connector 102 can include contact surfaces 114 which can contact the stops of the orthodontic bracket. The contact surfaces 114 can be flat to provide a secure point of contact with the stops of the orthodontic bracket. The stops of the orthodontic bracket can have corresponding flat surfaces. The contact surfaces 114 can be disposed on a side of the connector 102 that is opposite the arms 108 and/or recess 116. The contact surfaces 114 can be disposed on opposing sides of the tab 110.

The tab 110 can be disposed on a side of the connector 110 that is opposite the arms 108 and/or recess 116. The tab 110 can be disposed in a gap between stops of the orthodontic bracket when the connector 102 is disposed in the slot of the orthodontic bracket. The tab 110 can contact inner sides of the stops, which can help to prevent sliding of the connector 102 in a mesial-distal direction relative to the orthodontic bracket. The tab 110 can extend in a gingival or occlusal direction. The tab 110 can include a groove 112. The groove 112 can be disposed on an end of the tab 110. The groove 112 can receive a tool to facilitate positioning the connector 102 into the slot of the orthodontic bracket or removing the connector 102 therefrom. The groove 112 can help to prevent inadvertent sliding of the tool being used to place the connector 102 into the slot of the orthodontic bracket. The connector 102 can include curves to reduce stress concentrators.

FIG. 1C illustrates the archform 100 in a custom non-planar shape (e.g., custom 3D shape, custom memorize shape, custom memorized 3D shape). The custom non-planar shape corresponds to a planned alignment of a patient's teeth. As described herein, the archform 100 may correspond to a segment or the entirety of a patient's upper or lower dental arch. As illustrated in FIG. 1C, the archform 100 has an arch shape.

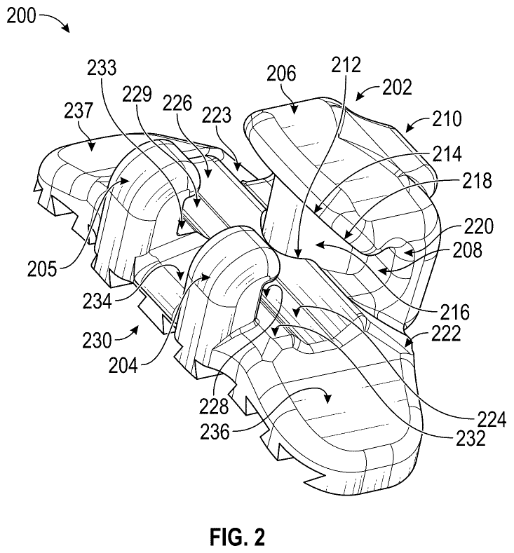

FIG. 2 illustrates an orthodontic bracket 200. The bracket 200 can be disposed on the lingual or buccal side of a patient's teeth. The bracket 200 can couple with the connector 102 of the archform 100 to facilitate moving a patient's teeth using non-sliding mechanics. In some variants, sliding and/or non-sliding mechanics can be used. In some variants, the bracket 200 can have utility when used with archforms of different configurations than those described herein. The bracket 200 can include a slot 208, also referred to as a receiving region or receiving space, that can receive the connector 102 of the archform 100 therein such that the connector 102 is prevented from sliding relative to the bracket 200 when installed in a patient's mouth. The slot 208 can be positioned between a retainer 202 and stops 204, 205. The slot 208 can be at least partially defined between the retainer 202, stops 204, 205, and a face 224 of the bracket 200.

As described herein, the retainer 202 can help to retain the connector 102 within the slot 208. The retainer 202 can at least be positioned proximate or at a gingival or occlusal side of the bracket 200. The retainer 202 can extend from the face 224 of the bracket 200. The retainer 202 can include one or more features to improve handling the bracket 200. For example, the retainer 202 can have a protuberance 210, also referred to as a bump, protrusion, or engagement region, that can be gripped by a tool during handling of the bracket 200. The protuberance 210 can extend in a gingival or occlusal direction.

The retainer 202 can include one or more features to improve retention of the connector 102 received in the slot 208 of the bracket 200. For example, the retainer 202 can include an overhang 206, e.g., extension. The overhang 206 can help hold the connector 102 within the slot 208. The overhang 206 can be offset from the face 224. The overhang 206 can extend over the slot 208 and/or face 224. The overhang 206 can include a curved portion 214 that extends over the slot 208 and/or face 224 of the bracket 200. The retainer 202 and/or overhang 206 can include an angled surface 218 that can facilitate the connector 102 being positioned within the slot 208 of the bracket 200 at an angle before being rotated toward the face 224 of the bracket 200 and being locked within the bracket 200, such as in the slot 208. The retainer 202 can include a recess 220, also referred to as a gap, undercut, cutout, space, etc., that can facilitate the connector 102 being rotated in and out of the slot 208 of the bracket 200 as detailed herein.

The bracket 200 can include a spring 216 (e.g., lock spring) that can facilitate locking the connector 102 of the archform 100 within the bracket 200. The spring 216 can be a compressible material with resilient properties that can be biased to a certain position. The spring 216 can be a C spring, rounded spring, leaf spring, etc. The spring 216 can be housed within an opening 212. The opening 212 can be disposed through at least a portion of the retainer 202. The C spring 216 can be inserted into the opening 212 by way of a face of the bracket 200 that is opposite the face 224. The C spring 216 can be exposed to the slot 208 such that the connector 102 can contact the C spring 216 when positioned within the slot 208. The C spring 216 can be oriented with a longitudinal axis thereof oriented perpendicularly relative to the plane of the face 224. The opening 212 can be contoured and/or shaped to prevent titling and/or rattling of the C spring 216 within the opening 212. The opening 212 can be bounded by a periphery that can help to prevent the C spring 216 from deflecting beyond a desired range (e.g., beyond elastic deformation). With the connector 102 of the archform 100 in the bracket 200, the C spring 216 can apply a force to the connector 102 that pushes the connector 102 against and/or at least partially under the stops 204, 205 such that the connector 102 is locked within the slot 202 of the bracket 200.

The stops 204, 205 can be proximate an opposite end of the bracket 200 relative to the retainer 202. In some variants, the stops 204, 205 can be in a mirrored configuration about a central plane of the bracket 200. The stops 204, 205 can include receiving spaces 228, 229, respectively. The receiving spaces 228, 229 can be at least partially bounded by extensions (e.g., overhangs) of the stops 204, 205. The receiving spaces 228, 229, which can also be referred to as pockets or cutouts, can receive, respectively, a portion of the connector 102 therein to secure the connector 102 within the slot 208. In some variants, the bracket 200 can include two stops 204, 205. In some variants, the bracket 200 may include one, three, or four or more stops that can help retain the connector 102 of the archform 100 within the bracket 200. The stops 204, 205 can be spaced apart from each other, which can be in the mesial-distal direction. A gap 234 can separate the stops 204, 205. The gap 234 can receive the tab 110 of the connector 102, as described herein. The portion of the face 224 spanning the gap 234 can be at least flat, angled, or curved. The portion of the face 224 spanning the gap 234 can be angled relative to other portions of the face 224 and/or curved at an end of the bracket 200.

The bracket 200 can include ramps 232, 233. The ramps 232, 233 can also be referred to as inclined surfaces, protrusions, angled surfaces, wedges, bumps, etc. The ramps 392, 393 can extend away from the face 224 of the bracket 200. The ramps 232, 233 can push the connector 102 against the stops 204, 205 to help secure the connector 102 within the slot 208. The ramps 232, 233 can push the connector 102 against the overhangs of the stops 204, 205. The ramps 232, 233 can include a flat surface that can engage the connector 102 when the connector 102 is secured within the slot 208. In some variants, the ramps 232, 233 can extend beyond a width of the stops 204, 205, respectively, which can help improve rotational control of a tooth.

The bracket 200 can include a protrusion 226 (e.g., bump). The protrusion 226 can extend from the face 224. The protrusion 226 can apply a force against the connector 102, when positioned within the slot 208, to push the connector 102 against the stops 204, 205 and/or overhang 206 of the retainer 202 to help secure the connector 102. The protrusion 226 can extend laterally beyond a width of the retainer 202, which can help improve rotational control of a tooth. The protrusion 226 can extend laterally beyond the stops 204, 205. In some variants, the opening 212 can disrupt a portion of the protrusion 226.

The bracket 200 can include inclined surfaces 222, 223 that can facilitate inserting a connector 102 within the slot 208 of the bracket 200 before rotating the connector 102 toward the face 224 of the bracket 200 to lock the connector 102 into place. The inclined surfaces 222, 223 can be positioned on opposing sides of the retainer 202.

The bracket 200 can include lateral extensions 236, 237, which can also be referred to as lateral wings. The lateral extensions 236, 237 can help the bracket 200 to better control movement of a molar or other tooth. For example, the lateral extensions 236, 237 can facilitate better rotational control. The lateral extensions 236, 237 can also provide more surface area for a textured surface 230 for improved bonding.

The bracket 200 can include a textured surface 230, also referred to as a surface with undercuts, cuts, gaps, voids, and/or slots. The textured surface 230 can be disposed on a side of the bracket 200 that is opposite the face 224. The textured surface 230 can facilitate bonding the bracket 200 to a surface of the patient's teeth. Specifically, an adhesive applied to the textured surface 230 can bond the textured surface 230 to the surface of the patient's tooth. The textured surface 230 can provide an increased surface area to facilitate improved bonding compared to an un-textured surface.

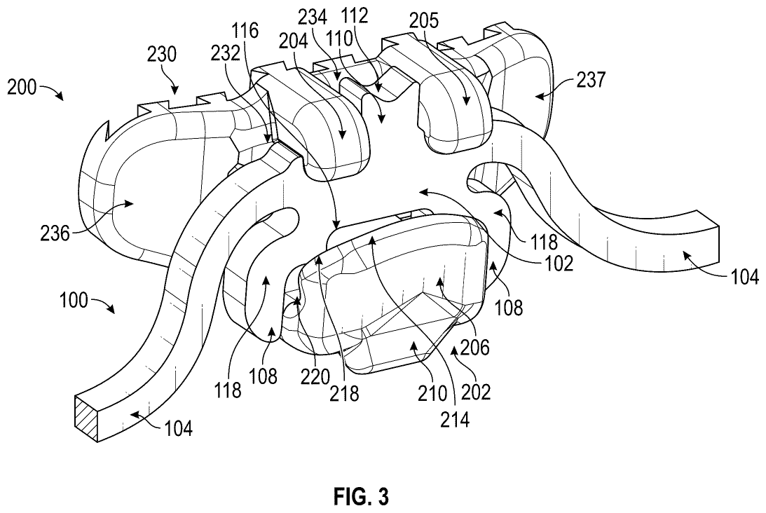

FIG. 3 illustrates the connector 102 coupled to the bracket 200. As illustrated, the connector 102 is disposed in the slot 208 of the bracket 200. The C spring 216 can push the connector 102 against the stops 204, 205 and/or under at least a portion of the stops 204, 205. The contact surfaces 114 can contact the stops 204, 205. The force applied by the C spring 216 can lock the connector 102 under the overhangs of the stops 204, 205 and the overhang 206 of the retainer 202.

The bracket 200 and/or connector 102 of the archform 100 can include modifications to accommodate the various teeth of the patient, such as the molars, bicuspids, lower anterior, and upper central teeth.

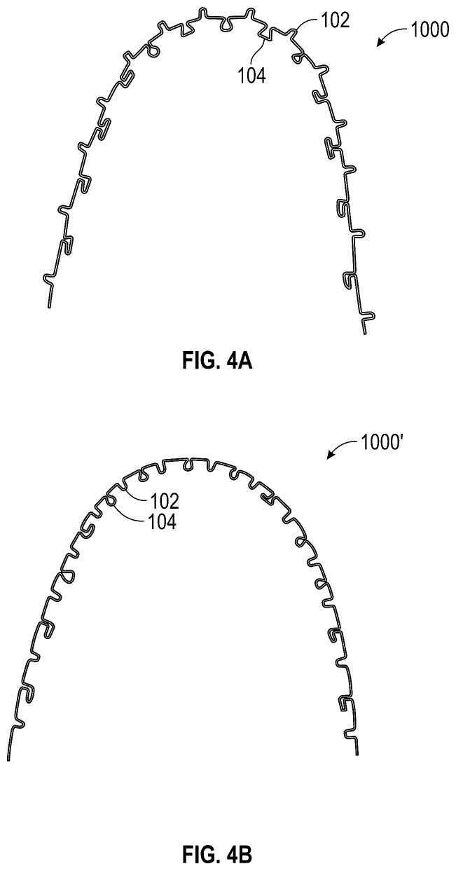

FIG. 4A illustrates an archform 1000 (e.g., archwire). The archform 1000 can have varying cross-sections, which can at least include circular, oval, polygonal (square, rectangular, etc.), irregular, and/or others. The archform 1000 can be formed with a wire bender. The archform 1000, as illustrated, is custom shaped to correspond to a planned alignment of a patient's teeth. The archform 1000 can correspond to a segment of a patient's dental arch or the entirety of the patient's dental arch. The archform 1000 can include connectors 102 that can be coupled to orthodontic brackets such that the connectors 102 do not slide with respect to the orthodontic brackets. The connectors 102 can be loops (e.g., male loops) that extend occlusally or gingivally relative to a longitudinal axis of the archform 1000. The loops can be various shapes, including U, T, tear-drop, triangular, rectangular, boot, and/or others.

The archform 1000 can include interproximal segments 104, which can include loops. The interproximal segments 104 can be disposed between adjacent connectors 102. The interproximal segments 104 can extend gingivally relative to a longitudinal axis of the archform 1000, which can facilitate flossing and/or hide the loops from view. When the archform 1000 is installed in a patient's mouth, the interproximal segments 104 can exert forces on the teeth of the patient to move the patient's teeth using non-sliding mechanics. In some variants, the interproximal segments 104 can include loops that extend in the gingival and/or occlusal direction. The connectors 102 and loops of the interproximal segments 104 can extend in opposite directions (e.g., one in the occlusal direction and the other in the gingival direction), the same directions, or a mix of the opposite and same.

FIG. 4B illustrates an archform 1000′ similar to the archform 1000 but with the connectors 102 extending in the same direction as the loops of the interproximal segments 104 (e.g., gingivally relative to the longitudinal axis of the archform 2001). The archforms 1000, 1000′ can be custom shaped and heat treated as described herein.

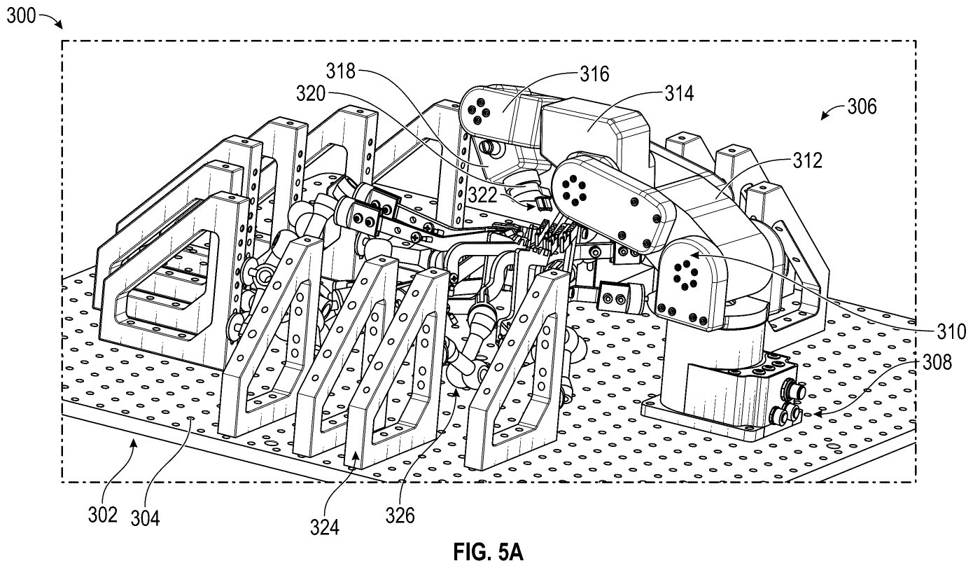

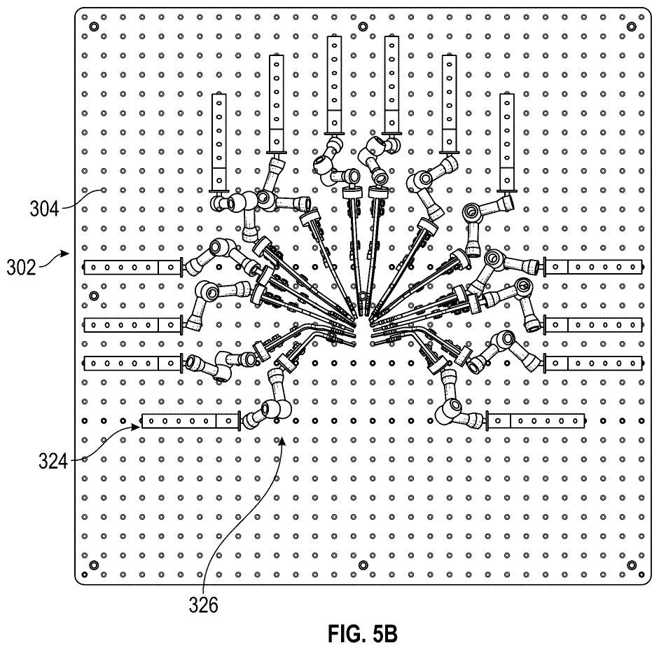

FIG. 5A illustrates a shaping system 300 that can custom shape an archform, which can at least include the archforms described herein. The shaping system 300 can include a robot 306 (e.g., machine) and/or a plurality of arms 326. The robot 306 can perform automated movements (e.g., tasks), which may increase accuracy and/or repeatability of the various processes described herein. The robot 306 may include servos, actuators, motors, and/or other mechanisms to perform movements. The robot 306 can include joints (e.g., ball, hinge, pin, screw, prismatic, knuckle, turnbuckle, bolt, cotterpin, universal, etc.) to facilitate movements. The robot 306 may include one or more sensors, which may include optical, proximity, position, pressure, force, temperature, etc. In some variants, the robot 306 may be fully automated (e.g., no manual movement of the robot 306 is permitted when active). In some variants, the robot 306 may be moved manually by an operator to perform a movement. In some variants, some of the steps of a process may be performed by way of manual manipulation of the robot 306 by an operator and other steps of the process may be performed by way of automated movement by the robot 306.

The robot 306 and/or plurality of arms 326 can be disposed on a surface 302 (e.g., platform) with a plurality of holes 304. The plurality of holes 304 can be in a grid pattern or other type of fixed pattern. The plurality of holes 304 can facilitate coupling the robot 306 and plurality of arms 326 to the surface 302 such that the robot 306 and plurality of arms 326 are fixed in place relative to each other. The plurality of holes 304 can facilitate coupling the robot 306 and plurality of arms 326 to the surface 302 such that the relative positioning of the robot 306 and plurality of arms 326 is known. In some variants, the robot 306 may be disposed above the surface 302 upon which the plurality of arms 326 are mounted. In some variants, the robot 306 may be positioned at an opening of a U-shape formed by the plurality of arm 326. In some variants, the shaping system 300 may include a plurality of robots 306, which may at least include two, three, four, or more robots 306. In some variants, one or more robots 306 may be positioned above the arms 326 and/or the surface 302 upon which the plurality of arms 326 are mounted and/or one or more robots 306 may be positioned on the surface 302. In some variants, one or more robots 306 may be disposed on a surface that is transverse relative to the surface 302.

The robot 306, as described herein, can indicate the position for each of the plurality of arms 326 (e.g., holders of each of the plurality of arms 326) to custom shape an archform. The robot 306 can include a base 308. The base 308 can be coupled to the surface 302 such that the base 308 does not move relative to the surface 302. The robot 306 can include sensor(s), actuator(s), motor(s), arm(s), controller(s), processor(s), memory device(s), communication interface(s) (e.g., wireless and/or wired data interface(s)), and/or other hardware to perform the actions (e.g., processes, methods, steps) performed herein.

The robot 306 can include one or more mounts and/or members rotatably coupled together to facilitate movement, which can at least include a first mount 310, first member 312, second member 314, second mount 316, third member 318, fourth member 320, and/or probe 322. The first mount 310 can be rotatably mounted to the base 308. The first mount 310 can rotate about a longitudinal axis of the base 308. The first member 312 can be rotatably coupled to the first mount 310. The second member 314 can be rotatably coupled to the first member 312. The second mount 316 can be rotatably coupled to the second member 314. The second mount 316 can rotate about a longitudinal axis of the second member 314. The third member 318 can be rotatably coupled to the second mount 316. The fourth member 320 can be rotatably coupled to the third member 318. The fourth member 320 can rotate about a longitudinal axis of the third member 318.

The fourth member 320 can include a probe 322, which can also be referred to as an indicator, guide, pointer, and/or protrusion. The robot 306 can indicate a position for one of the arms 326 (e.g., holder of the arm 326) with the probe 322 based on the position of a corresponding digital marker, digital bracket, and/or tooth in the digital model with the teeth in the planned alignment. An operator can move the arm 326 to interface with the probe 322 to position the arm 326 (e.g., holder of the arm 326). The robot 306 can be used to indicate positions for all of the plurality of arms 326. The robot 306 can indicate positions for holders of all the plurality of arms 326. The holders of the plurality of arms 326 can hold (e.g., secure, retain, clamp) the archform (e.g., connectors of the archform) in a custom 3D shape (e.g., custom nonplanar shape) corresponding to the digital teeth and/or digital brackets in the digital model with the digital teeth in the planned alignment. In some variants, each of the arms 326 can move to a position based on the positions of the corresponding digital markers, digital brackets and/or teeth in the digital model with the teeth in the planned alignment without the assistance of the robot 306.

The plurality of arms 326 can include any number of arms 326. For example, many adults have 32 teeth; accordingly, the plurality of arms 326 may include 16 arms—one for each tooth of the upper or lower arch of the patient. In many instances, adults have one or more molars removed; accordingly, the plurality of arms 326 may include fewer arms 326 (e.g., less than 10, 10, 12, 14, or more than 14). Each of the plurality of arms 326 may be mounted to the surface 302. For example, each of the plurality of arms 326 can include a base 324, which can also be referred to as a mount or frame, that can be coupled to the surface 302. Each of the plurality of arms 326 can include one or more joints and/or segments to allow the arms 326 to be placed in and/or move to various positions. FIG. 5B illustrates the shaping system 300 with the plurality of arms 326 arranged on the surface 302 to hold an archform in a custom shape.

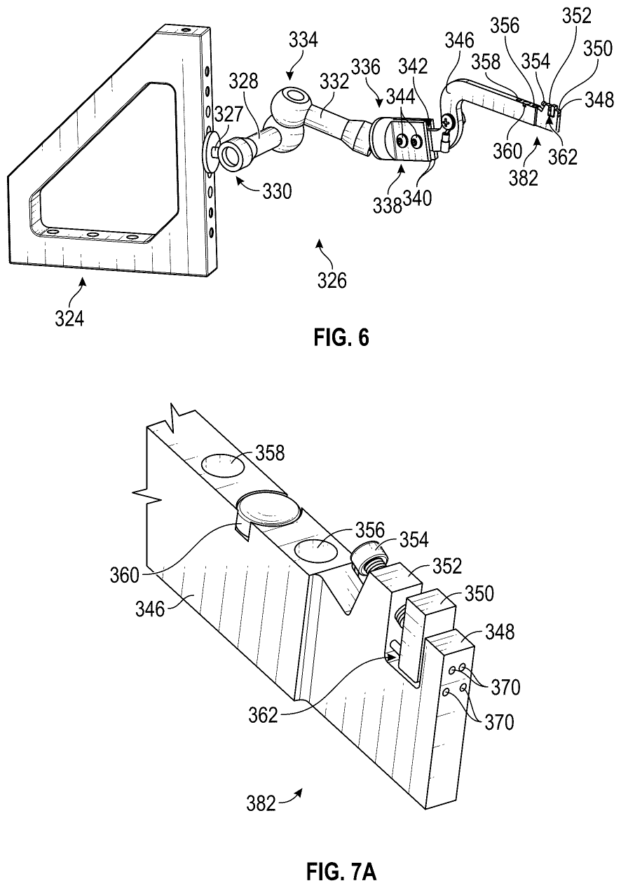

FIG. 6 illustrates an arm 326. The arm 326 can include a plurality of segments (e.g., members) and/or joints to allow the arm 326 to move to various positions (e.g., configurations). The arm 326 can be moved by an operator to position a holder 382 of the arm 326 in a position indicated by the robot 306. In some variants, the arm 326 can be powered to move to a position indicated by the robot 306. In some variants, the arm 326 can be commanded, via a controller, to move to a position and include one or more motors to move the arm 326 to the position. The arm 326 can include a first mount 327, first joint 330, first segment 328, second joint 334, second segment 332, third joint 336, second mount 338, and/or third segment 346. The first mount 327 can be coupled to the base 324. The first segment 328 can be rotatably coupled to the first mount 327 at a first joint 330, which can be a ball joint. The second segment 332 can be rotatably coupled to the first segment 328 at a second joint 334. The second mount 338 can be rotatably coupled to the second segment 332 at a third joint 336, which can be a ball joint.

The second mount 338 can include a pair of flanges 340 (e.g., panels). The flanges 340 can be arranged parallel to each other. The flanges 340 can be the same size and shape. The flanges 340 can be separated by a gap 342. The third segment 346 can be inserted into the gap 342 between the flanges 340 and secured in place, which can include being secured by bolt(s) 344. The third segment 346 can include one or more curves. The third segment 346 can be planar. In some variants, the third segment 346 can curve out of plane, as shown in some of the third segments 346 illustrated in FIG. 5B.

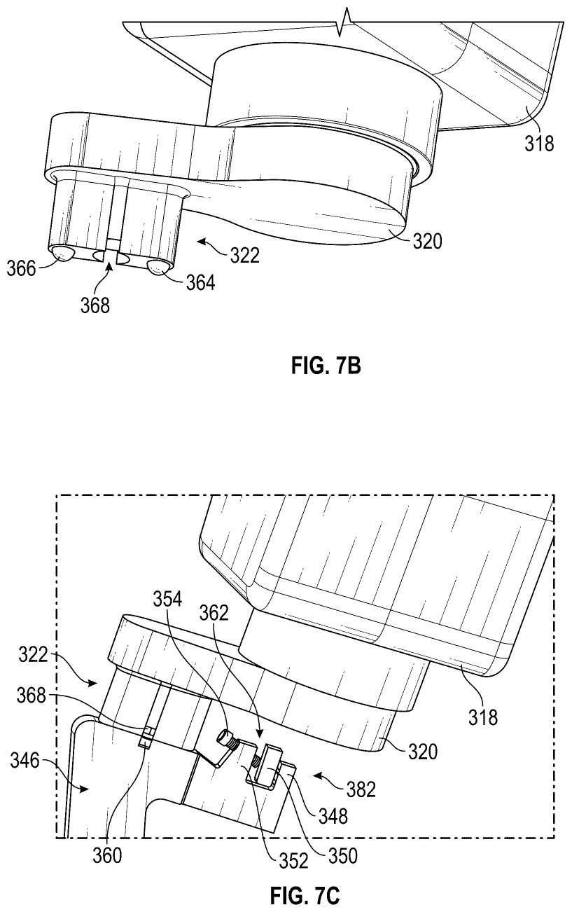

An enlarged view of the end portion of the third segment 346 is illustrated in FIG. 7A. The third segment 346 can include a first hole 356 and/or second hole 358 to receive protrusions of the probe 322 of the robot 306 to facilitate proper positioning of the holder 382 of the arm 326. In some variants, the third segment 346 can include one or more protrusions (e.g., two) that are received by one or more holes (e.g., two) of the probe 322 to facilitate proper positioning of the holder 382 of arm 326.

The third segment 346 can include a magnet 360. The magnet 360 can be disposed between the first hole 356 and second hole 358. The magnet 360 can be disposed in a recess of the third segment 346. The magnet 360 can be attracted to a corresponding magnet of the probe 322 to help facilitate the interface between the first and second holes 356, 358 and the protrusions of the probe 322. In some variants, the magnet 360 can be attracted to a ferromagnetic material (e.g., iron), nickel, and/or cobalt of the probe 322. In some variants, the magnet 360 can be incorporated into the probe 322 and the third segment 346 can include a ferromagnetic material (e.g., iron), nickel, and/or cobalt.

The third segment 346 can include a holder 382, which can also be referred to as a retainer and/or clamp. In some variants, the holes, magnet, and/or protrusions can be incorporated into the holder 382. The holder 382 can hold the archform to retain the archform in a custom 3D shape. The holder 382 can hold the connector of the archform. The holder 382 can be disposed at an end portion of the third segment 346. In some variants, the holder 382 may be coupled to the third segment 346. In some variants, the holder 382 may be integrally formed with the third segment 346.

The holder 382 can include a first fixed jaw 348 and a moveable jaw 350, which can also be referred to as a block or member. The first fixed jaw 348 and the moveable jaw 350 can cooperate to secure (e.g., clamp, retain) the archform (e.g., connector) therebetween. The moveable jaw 350 can be moved toward and away from the first fixed jaw 348 to clamp or release an archform disposed therebetween. The first fixed jaw 348 can remain fixed in place. The moveable jaw 350 can translate toward and away from the first fixed jaw 348. The faces of the first fixed jaw 348 and moveable jaw 350 that face each other can be flat and/or parallel relative to each other.

The holder 382 can include a second fixed jaw 352. A gap 362 can space the first fixed jaw 348 and the second fixed jaw 352 away from each other. The faces of the first fixed jaw 348 and second fixed jaw 352 that face each other can be flat and/or parallel relative to each other. The moveable jaw 350 can be disposed in the gap 362 between the first fixed jaw 348 and the second fixed jaw 352. The moveable jaw 350 can translate toward and away from the second fixed jaw 352. The moveable jaw 350 can slide along pins, rods, or the like disposed between the first fixed jaw 348 and the second fixed jaw 352. The pins can be disposed in apertures 370 disposed in the first fixed jaw 348. The connectors of the archforms can be disposed (e.g., mounted) on the pins to help secure the connectors to the holders 382.

A screw 354, bolt, or the like can be used to translate the moveable jaw 350. The screw 354 can extend through the second fixed jaw 352 and contact the moveable jaw 350. The screw 354 can be disposed through the second fixed jaw 352 at an angle relative to a longitudinal axis of the second fixed jaw 352 and/or the surface of the second fixed jaw 352 that faces the moveable jaw 350. The screw 354 can be rotated in a first direction to advance toward the moveable jaw 350, contacting with and translating the moveable jaw 350 toward the first fixed jaw 348. The screw 354 can be rotated in a second direction, opposite the first, to retract away from the moveable jaw 350, allowing the moveable jaw 350 to be moved away from the first fixed jaw 348. An end of the screw 354, opposite the head, can contact the moveable jaw 350 as the screw 354 is rotated in the first direction to translate the moveable jaw 350 toward the first fixed jaw 348. In some variants, the end of the screw 354 can be coupled to the movable jaw 350 such that rotation of the screw 354 in the first direction moves the moveable jaw 350 toward the fixed jaw 348 and rotation of the screw 354 in the second direction moves the moveable jaw 350 away from the fixed jaw 348.

FIG. 7B illustrates a view of the fourth member 320 and probe 322. The fourth member 320 can include a portion with a smaller periphery compared to the remainder of the fourth member 320; the probe 322 can be disposed on the smaller periphery.

The probe 322 can extend from a face of the fourth member 320. The probe 322 can have an elongate periphery with rounded ends. The probe 322 can include a first protrusion 364 and a second protrusion 366. The first protrusion 364 and second protrusion 366 can be disposed on an end of the probe 322 opposite the fourth member 320. The first protrusion 364 can be disposed proximate a first side of the probe 322. The second protrusion 366 can be disposed proximate a second side of the probe 322 opposite the first side. The first protrusion 364 and second protrusion 366 can extend away from a face of the probe 322 that is offset from the fourth member 320. The first protrusion 364 and second protrusion 366 can be the same size and/or shape. In some variants, the first protrusion 364 and second protrusion 366 cam be different sizes and/or shapes. The first protrusion 364 and second protrusion 366 can have a size and/or shape that corresponds with the first hole 356 and second hole 358, respectively. The first protrusion 364 and/or second protrusion 366 can be rounded protrusions, which can help guide the first protrusion 364 and second protrusion 366 into the first hole 356 and second hole 358, respectively. The first protrusion 364 and/or second protrusion 366 can be bumps, half spheres, hemispheres, and/or other shapes. In some variants, the probe 322 can include more than two protrusions.

The probe 322 can include a recess 368, which can also be described as a hole. The recess 368 can house a magnet to attract the magnet 360 of the third segment 346, which can help guide the protrusions of the probe 322 into the holes of the third segment 346. In some variants, the recess 368 can house a ferromagnetic material (e.g., iron), nickel, and/or cobalt that can be attracted to the magnet 360, which can help guide the protrusions of the probe 322 into the holes of the third segment 346. In some variants, the probe 322 may not have a recess 368. In some variants, the probe 322 can be made of and/or include a ferromagnetic material (e.g., iron), nickel, and/or cobalt.

FIG. 7C illustrates the probe 322 interfacing with the third segment 346. As described herein, the first protrusion 364 and second protrusion 366 of the probe 322 can be disposed in the first hole 356 and second hole 358 of the third segment 346, which can ensure that the holder 382 of the arm 326 is properly positioned. The magnet 360 can be attracted to a magnet disposed in the probe 322 and/or a ferromagnetic material (e.g., iron), nickel, and/or cobalt incorporated in the probe 322.

The robot 306 can maneuver the probe 322 to a position corresponding to the position of a digital marker of the virtual model with the teeth in the planned alignment. In some variants, the robot 306 can maneuver the probe 322 to a position corresponding to the position of a digital tooth, digital bracket, and/or connector of a digital archform in the virtual model of the patient's teeth in the planned alignment. An operator can maneuver the arm 326 such that the first protrusion 364 and second protrusion 366 of the probe 322 are inserted into the first hole 356 and second hole 358 of the third segment 346 to position the holder 382 in the correct location for custom shaping the archform. In some variants, the arm 326 can include one or more sensors and/or motors to automatically move the arm 326 to interface with the probe 322. In some variants, the probe 322 can emit a signal which may guide the arm 326 to interface with the probe 322. Once the probe 322 interfaces with the third segment 346, the arm 326 can be fixed (e.g., locked in place) to ensure that the arm 326 does not move. The robot 306 can proceed to indicate the positions of the holders 382 for each of the plurality of arms 326 until all arms 326 needed to custom shape the archform are positioned. With an arm 326 properly positioned, the connector of the archform can be secured in the holder 382. In some variants, the archform can be secured in the holder 382 prior to positioning the arm 326. In some variants, the archform can be secured to the holders 382 and then coupled to the arms 326. Once secured in the holders 382 of the positioned plurality of arms 326, the archform will be held in a custom shape that corresponds to the digital markers in the virtual model of the patient's teeth with the teeth in the planned configuration, which may also correspond to the positioning of digital teeth, digital brackets, and/or connectors of a digital archform in the virtual model of the patient's teeth in the planned alignment.

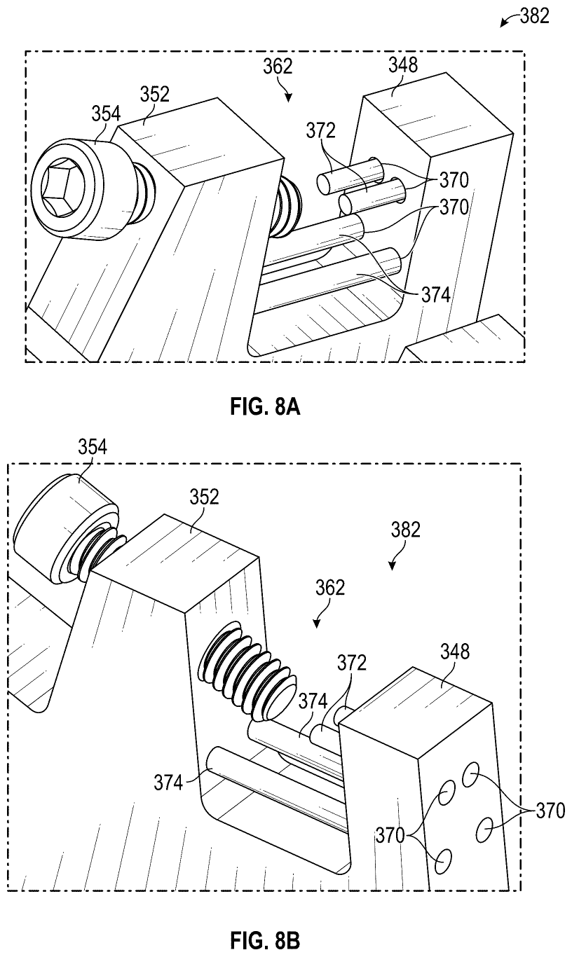

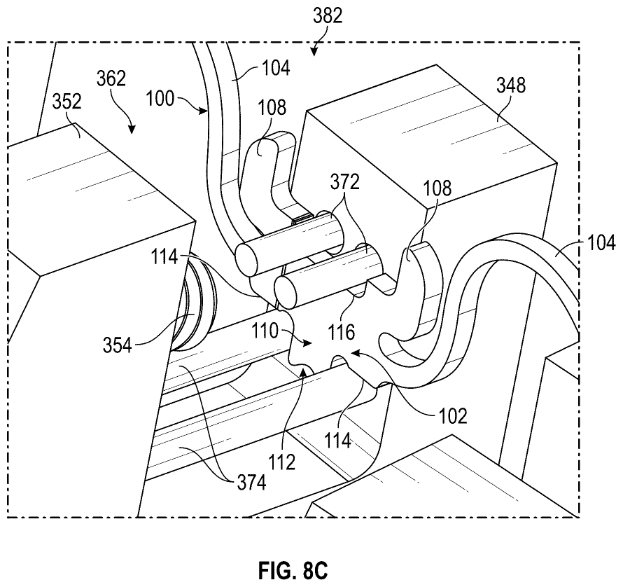

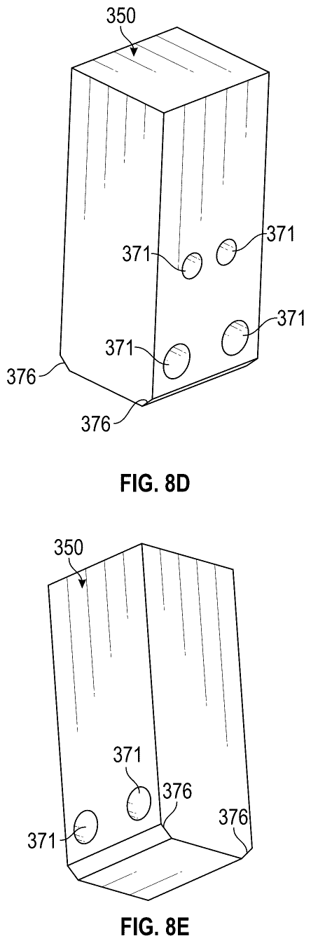

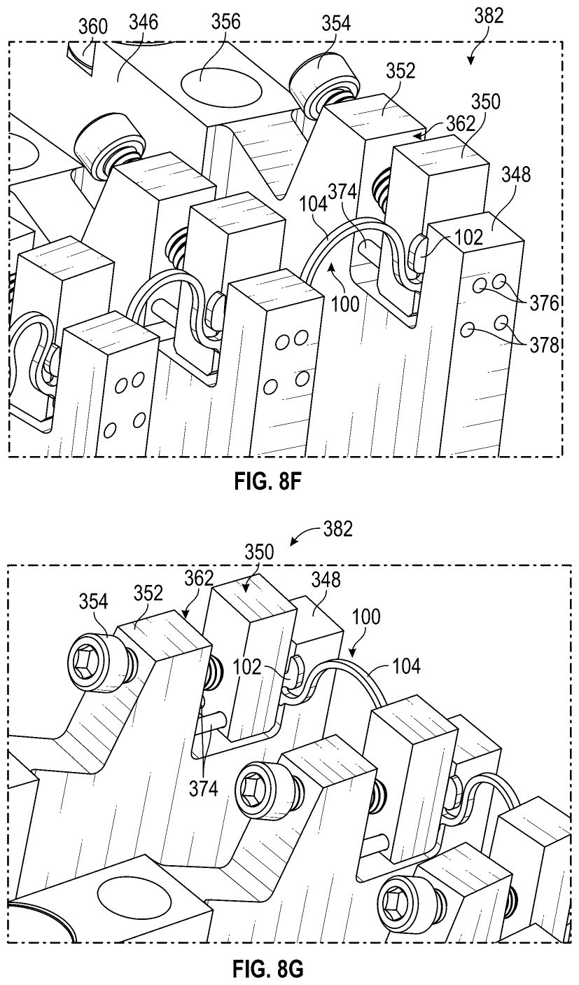

FIGS. 8A and 8B illustrate views of the holder 382. As described herein, the holder 382 can include a plurality of pins (e.g., rods, bars, rails), which can at least include upper pin(s) 372 and/or lower pin(s) 374. The moveable jaw 350 can translate (e.g., slide) along the upper pins 372 and/or lower pins 374. The connectors of the archform can be disposed (e.g., mounted) on the upper pin(s) 372 and/or lower pin(s) 374 to help secure the connectors to the holders 382. The upper pins 372 and/or lower pins 374 can be elongate. The upper pins 372 and/or lower pins 374 can have various cross-sectional shapes, which can at least include circular, oval, polygonal (e.g., triangle, square, rectangle, pentagon, etc.), irregular, and/or others. The lower pins 374 can have a cross-sectional size that is larger than that of the upper pins 372. The upper pins 372 and/or lower pins 374 can be disposed in apertures 370 in the first fixed jaw 348. The lower pins 374 can extend from the first fixed jaw 348 to the second fixed jaw 352. The upper pins 372 can be disposed above the lower pins 374. The upper pins 372 can be closer together compared to the lower pins 374. The upper pins 372 can extend from the first fixed jaw 348 to position(s) between the first fixed jaw 348 and the second fixed jaw 352. In some variants, the lower pins 374 can include two pins. In some variants, the upper pins 372 can include two pins.

FIG. 8C illustrates the connector 102 of the archform 100 disposed between the first fixed jaw 348 and second fixed jaw 352 on the upper pins 372 and lower pins 374. The tab 110 of the connector 102 can be disposed between the lower pins 374. The contact surfaces 114 of the connector 102 can contact the lower pins 374. The upper pins 372 can be disposed in the recess 116 of the connector 102.

FIGS. 8D and 8E illustrate various views of the moveable jaw 350 (e.g., block). The moveable jaw 350 can be various shapes, which can at least include a rectangular prism. The moveable jaw 350 can include chamfers 376. The chamfers 376 can be on the lower edges of the moveable jaw 350, which can include a lower leading edge and lower trailing edge of the moveable jaw 350 in the direction of motion of the moveable jaw 350. The chamfers 376 can help to prevent the moveable jaw 350 from binding up during translation. The moveable jaw 350 can include a plurality of apertures 371 that correspond to and receive the upper pins 372 and/or lower pins 374. The apertures of the plurality of apertures 371 that correspond to the upper pins 372 can be smaller than the apertures of the plurality of apertures 371 that correspond to the lower pins 374. The plurality of apertures 371 can be various sizes and shapes that correspond to the upper pins 372 and/or lower pins 374. The apertures of the plurality of apertures 371 that correspond to the upper pins 372 can extend partially through the moveable jaw 350, which can prevent the moveable jaw 350 from being advanced too close to the first fixed jaw 348. The upper pins 372 can contact an ending of the apertures 371, stopping the advancement of the moveable jaw 350 toward the first fixed jaw 348. The apertures of the plurality of apertures 371 that correspond to the lower pins 374 can extend entirely through the moveable jaw 350, enabling the lower pins 374 to extend through the entirety of the moveable jaw 350.

FIGS. 8F and 8G illustrate the moveable jaw 350 disposed on the upper pins 372 and lower pins 374 and securing the connector 102 disposed on the upper pins 372 and lower pins 374 between the moveable jaw 350 and the first fixed jaw 348. As illustrated, the screw 354 has been rotated in the first direction, translating the moveable jaw 350 toward the first fixed jaw 348 until securing the connector 102 of the archform 100 between the moveable jaw 350 and first fixed jaw 348. As described herein, the connectors 102 of the archform 100 can be secured within the holder 382 of the plurality of arms 326 such that the archform 100 is disposed in the custom 3D shape, which may correspond to the digital markers in the virtual model with the teeth in the planned alignment. While in the custom shape, the archform 100 can be set by way of exposure to heat. For example, a heat gun can heat the archform 100 to set the archform 100 in the custom shape. The robot 306 may include a heating element, such as a heat gun, that the robot 306 can manipulate to heat set the archform 100. In some variants, an operator can expose the archform 100 to heat with a heating element, such as a heat gun. In some variants, the archform 100 can be disposed in a furnace or oven to set the archform 100 in the custom shape. In some variants, an electrical current can be applied to the archform 100 to set the archform 100 in the custom shape. In some variants, the holder 382 and/or third segment 346 can include a conductive material (e.g., copper) such that an electrical current applied to the holder 382 and/or third segment 346 can be applied to the archform 100 held by the holder 382 to set the archform 100 in the custom shape. In some variants, electrical current can be applied to each interproximal segment 104 (e.g., loop) of the archform 100. The electrical power applied to each interproximal segment 104 can be measured down to the milliohms. The applied power can dictate the heat of the archform which, in turn, can dictate the setting of the archform. Each loop of the interproximal segments 104 can be designed differently. In some variants, the arm 326 (e.g., the holder 382 and/or third segment 346) can include an electrical lead connected to a power source to apply an electrical current to the archform 100.

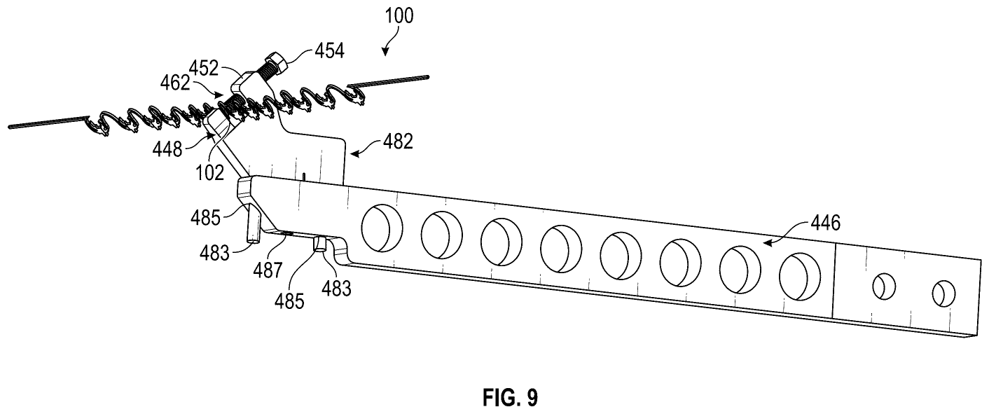

FIG. 9 illustrates a third segment 446, which can be incorporated on an end portion of an arm 326 of the shaping system 300 as described herein. A holder 482, which can be a clamp, jig, and/or fastener, can be coupled to the third segment 446 and hold (e.g., clasp, retain, secure) a connector 102 of an archform 100. For example, the holder 482 may be disposed on an end portion of the third segment 446. The holder 482 can include pins 483, which can be rods, protrusions, cylinders, bars, etc. The holder 482 may include 2, 3, 4, or more pins 483. The pins 483 can be positioned through holes 485 in the third segment 446 to position (e.g., disposed, orient) the holder 482 on the third segment 446. The holder 482 can be fastened to the third segment 446 by way of a variety of techniques, which can at least include a screw, bolt, or the like. For example, the screw can be threaded through a hole 487 and into a threaded hole of the holder 482.

Similar to the holder 382, the holder 482 can include a first fixed jaw 448 and a second fixed jaw 452. A gap 462 can space the first fixed jaw 448 and the second fixed jaw 452 away from each other. The faces of the first fixed jaw 448 and second fixed jaw 452 that face each other can be flat and/or parallel relative to each other. A screw 454, bolt, or the like can be threaded through the second fixed jaw 452 to clamp a connector 102 of the archform 100 between the first fixed jaw 448 and the screw 454 (e.g., end portion of the screw 454). The screw 454 can be rotated in a first direction to advance toward the first fixed jaw 448 to clamp the connector 102 between the screw 454 and the first fixed jaw 448. The screw 454 can be rotated in a second direction to move the screw 454 away from the first fixed jaw 448 to release the connector 102.

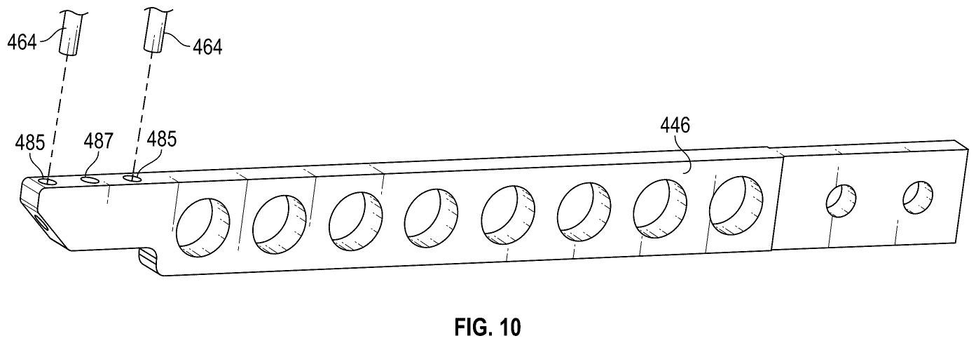

FIG. 10 illustrates pins 464, which can be rods, protrusions, cylinders, bars, etc., of the robot 306. For example, the pins 464 may be disposed on a probe of the robot 306. The robot 306 may include 2, 3, 4, or more pins 464. The robot 306 may position the pins 464 at a location in space to indicate a position for the third segment 446 to shape the archform 100 according to the virtual model of the patient's teeth in the planned alignment. As described herein, the robot 306 may, based on a virtual model of the patient's teeth in an aligned configuration, indicate a position for each arm 326 of the shaping system 300 to hold the archform 100 in a configuration that, once installed in the patient's mouth, will move the teeth toward a digitally planned alignment. For example, the robot 306 may indicate positions for each arm 326 based on the positions of digital markers in the virtual model of the patient's teeth in the aligned configuration. The robot 306 may factor in the geometry of the arm 326 and/or holder 482 when indicating a position for the third segment 446. An operator may maneuver the arm 326 (e.g., third segment 446) to position the pins 464 of the robot 306 through the holes 485 of the third segment 446. The arm 326, which includes the third segment 446, may be locked in position after positioning in the location indicated by the robot 306. In some variants, the arm 326 may automatically move to a position indicated by the robot 306. In some variants, the arms 326 may automatically move to positions based on the digital markers in the digitally planned alignment without a robot 306 indicating positioning.

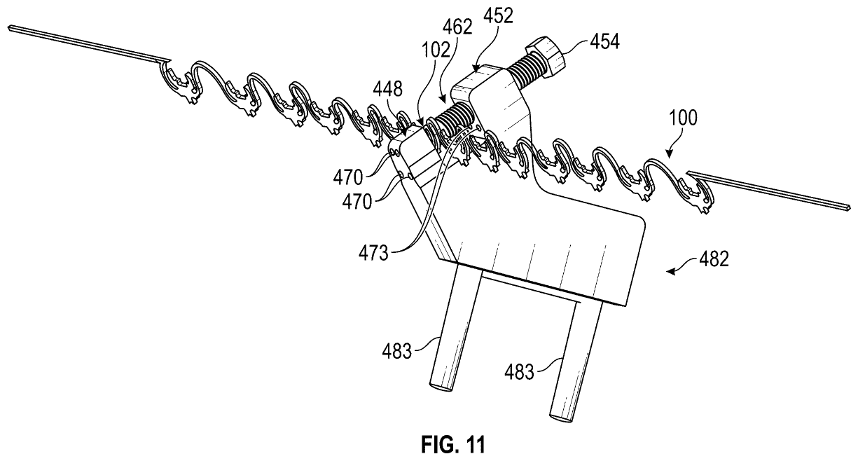

As described herein, the holder 482 may be decoupled from the third segment 446, as shown in FIG. 11. In some embodiments, the holder 482 may be coupled to a connector 102 of an archform 100 while decoupled from the third segment 446, which may be more convenient for an operator. For example, the operator may place the connector 102 on pins disposed between the first fixed jaw 448 and the second fixed jaw 452, as described herein. Lower pins, such as lower pins 374, may be disposed in the lower apertures 470 in the first fixed jaw 448 and apertures 473 in the second fixed jaw 452. In some variants, the lower pins may extend from the first fixed jaw 448 to the second fixed jaw 452. In some variants, the lower pins may extend from the first fixed jaw 448 to a position between the first fixed jaw 448 and the second fixed jaw 452. Upper pins, such as upper pins 372, may be disposed in the upper apertures 470 of the first fixed jaw 448. In some variants, the upper pins may extend from the first fixed jaw 448 to the second fixed jaw 452. In some variants, the upper pins may extend from the first fixed jaw 448 to a position between the first fixed jaw 448 and the second fixed jaw 452. The pins may help prevent movement of the connector 102, as at least shown and described in reference to FIG. 8C. With the connector 102 disposed on the pins, the screw 454 may be rotated in the first direction to advance toward the first fixed jaw 448 to secure (e.g., pin, clamp) the connector 102 between the screw 454 and the first fixed jaw 448.

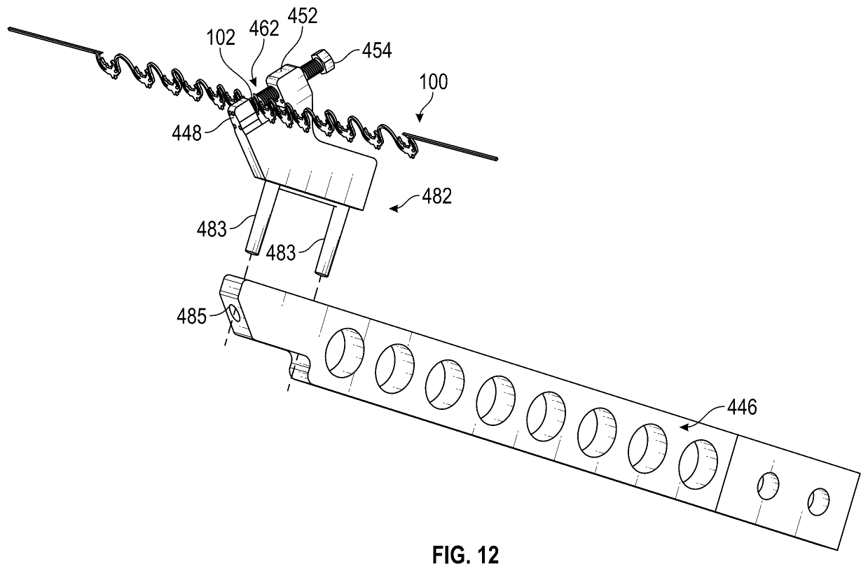

With the connector 102 secured in the holder 482, the holder 482 may be coupled to the positioned arm 326 (e.g., third segment 446). As shown in FIG. 12, the pins 483 of the holder 482 may be advanced through the holes 485 of the third segment 446 to position the connector 102 according to the position of a digital marker in the virtual model with the teeth in the planned alignment. The holder 482 and third segment 446 may be fastened together, which may include by way of a screw, bolt or the like extending into the holder 482 and third segment 446. In some embodiments, the holder 482 may be positioned on and fastened to the third segment 446 prior to clamping the connector 102 with the holder 482.

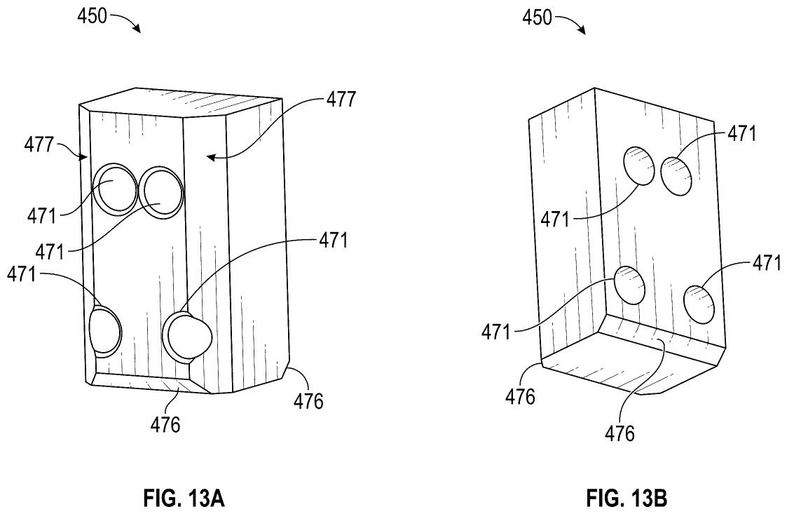

In some variants, the holder 482 may include a moveable jaw 450, which can be similar to the moveable jaw 350 described herein. As shown in FIGS. 13A and 13B, the moveable jaw 450 may include apertures 471, which can include upper apertures and lower apertures. The pins of the holder 482 may be disposed through the apertures 471 to suspend the moveable jaw 450 between the first fixed jaw 448 and second fixed jaw 452. The screw 454 can then be rotated in the first direction to push the moveable jaw 450 toward the first fixed jaw 448 to secure the connector 102 between the moveable jaw 450 and the first fixed jaw 448. The screw 454 can be rotated in a second direction, opposite the first, to allow the moveable jaw 450 to be moved to release the connector 102. In some embodiments, the moveable jaw 450 may be coupled to the screw 454.

The moveable jaw 450 may be a variety of shapes, which may at least include a rectangular prism. In some variants, the moveable jaw 450 may be a cylindrical shape. The moveable jaw 450 may include chamfers 476, which may be disposed along the lower leading and trailing edges of the moveable jaw 450 to prevent binding and/or improve contact between the moveable jaw 450 and the first fixed jaw 448 and/or connector 102. The face of the moveable jaw 450 facing the first fixed jaw 448 may be parallel to the face of the first fixed jaw 448 facing the moveable jaw 450. The moveable jaw 450 may include chamfers 477 disposed along longitudinal edges of the face of the moveable jaw 450 that faces the first fixed jaw 448, which can help to ensure that the moveable jaw 450 is contacting the connector 102 of the archform 100 and not other features of the archform 100 such as the portions of the archform 100 between adjacent connectors 102 (e.g., loops 104).

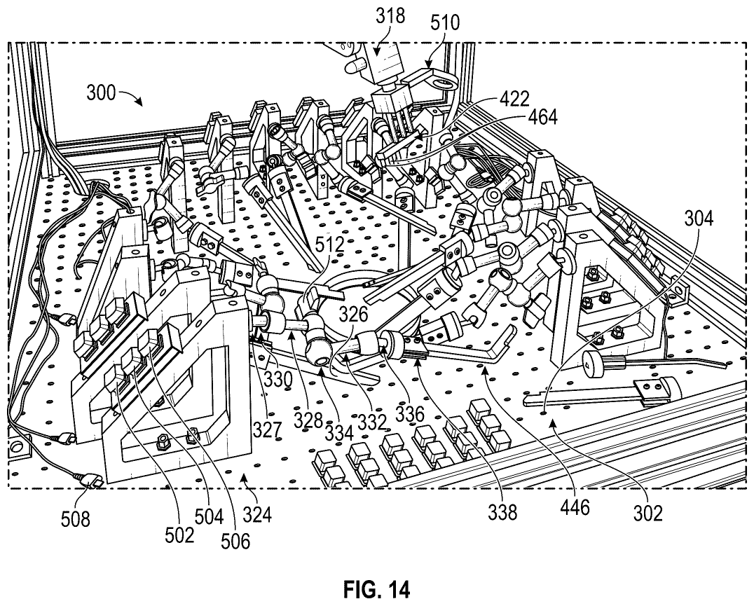

FIG. 14 shows the shaping system 300 with the third segments 446. As illustrated, the third segment 446 may include angled portions, curved portions, straight portions, and/or other features. Each of the arms 326 may be mounted to a base 324, which may be a mount and/or an upright. Each of the bases 324 may include an indicator light. When a patient case is loaded into the shaping system 300, the indicator lights on the bases 324 of the arms 326 that will be used to hold the archform 100 for shaping can emit light and/or emit a predetermined color of light. For example, the indicator lights on the bases 324 of the arms 326 that require positioning may emit a red light to indicate that the arms 326 should be positioned. If an arm 326 does not need to be used (e.g., in the case of a missing tooth), the indicator light on the base 324 for that arm 326 may not emit light or may emit a color of light that communicates to an operator that the arm 326 will not be used. After an arm 326 is positioned, as described herein, the operator may push a button 502 (e.g., push button) to indicate that the arm 326 has successfully been positioned, which can result in the indicator light emitting a different color (e.g., green) to communicate that the arm 326 has been positioned. In some variants, the shaping system 300, which may include the robot 306 and/or arms 326, may include one or more sensors that may detect when an arm 326 has successfully been positioned.

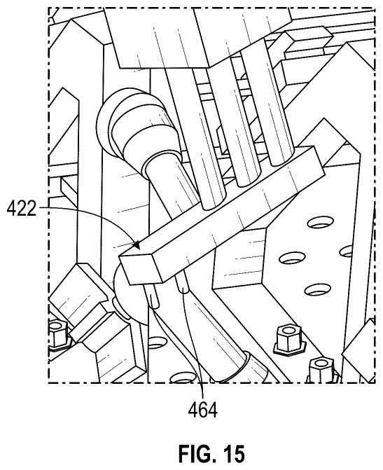

The robot 306, as described herein, may include pins 464. The pins 464 may be disposed on the probe 422 of the robot 306, which may include extending downward from the probe 422 as shown in FIGS. 14 and 15. The pins 464 can be used to position the arms 326 as described herein. For example, to position the arms 326, the arms 326 can be moved such that the pins 464 extend through the apertures 485 of the arm 326 (e.g., third segment 446) and the holder 482 (e.g., upper surface) contacts the probe 422 (e.g., lower surface). The arms 326 may include locks 512 that can be manipulated to lock the arms 326 in the positions indicated by the robot 306.

The robot 306 may include a heating element, such as a heat gun, to apply heat to the archform 100 held in the custom 3D shape by the plurality of arms 326 to heat set the archform 100 in the custom 3D shape. The robot 306 may apply heat to the entirety of the archform 100 at the same time to heat set the archform 100. The robot 306 may sequentially apply heat to the connectors 102 and/or loops 104 of the archform 100. The robot 306 may include a support 510, which may be a holder, retainer, clip, sleeve, arm, finger, etc. The support 510 may extend from the probe 422. The support 510 may hold a heating element, such as a heat gun, to apply heat to an archform 100 held by the arms 326. For example, with the archform 100 held by the arms 326 in the custom 3D shape, the robot 306 may apply heat by way of a heating element (e.g., heat gun) to the archform 100 such that the custom 3D shape is the default memorized shape of the archform 100. Once heat set, the archform 100 will move back toward the default shape when deflected therefrom. As described herein, the archform 100 can be heat treated to set a transition temperature between an austenite and martensite phase. In some variants, the archform 100 heat set in the custom 3D shape can be placed in an oven to be heat treated to set a transition temperature.

The archform 100 can be deflected from the default memorized shape and coupled to the patient's teeth, which may include by way of brackets. With the archform 100 deflected from the default shape (e.g., memorized shape, heat set shape) and coupled to the patient's teeth, the archform 100 can move back toward the default shape and exert forces on the patient's teeth such that the patient's teeth move toward the digitally planned alignment.

The bases 324 can include a third button 502, second button 504, and/or first button 506, which can be push buttons. The shaping system 300 and/or shaping system 301 can include a plurality of cables 508 (e.g., data cables, power cables, etc.) that can connect the bases 324 to a computing device in communication with the robot 306 and/or the robot 306. In some variants, the third button 502, second button 504, and/or first button 506 can be positioned at other locations in the shaping system 300 and/or shaping system 301. In some variants, the third button 502, second button 504, and/or first button 506 can be virtual buttons incorporated into a user interface of the shape shaping system 300 and/or shaping system 301.

The first button 506 can, when interacted with (e.g., touched, pushed), command the robot 306 to move the probe 422 to a position proximate an indicating position for the arm 326 corresponding to the first button 506 (e.g., spaced perpendicularly away along a vector from the indicating position), which may be referred to as the approach position. For example, the robot 306 can move the probe 422 to the approach position such that if the probe 422 were advanced along a vector to the indicating position (i.e., the position at which then the arm 326 is moved to interface with the positioned probe 422 to properly position the arm 326) the pins 464 would insert into the apertures 485 of the arm 326 if the arm 326 were properly positioned. In some variants, the first button 506 must be held for the robot 306 to move such that, if not held, the robot 306 will cease to move toward the approach position. In some variants, the robot 306 can move to the indicating position when the first button 506 is manipulated (e.g., pressed).

The second button 504 can, when interacted with (e.g., pushed), command the robot 306 to move the probe 422 along a vector from the approach position to the indicating position. The robot 306 can move the probe 422 along the vector such that the pins 464 maintain a fixed orientation and translate along the vector as the probe 422 moves to the indicating position. In some variants, the second button 504 must be held for the robot 306 to move such that, if not held, the robot 306 will cease to move toward the indicating position. The operator can press the first button 506 to move (e.g., retract) the probe 422 back to ward the indicating position from the approach position or a position along the vector between the approach position and the indicating position.

The third button 502 can, when interacted with (e.g., pushed), communicate to the shaping system 300 and/or shaping system 301 that the arm 326 has been positioned. As detailed herein, with the probe 422 in the indicating position (e.g., position corresponding to the placement of a digital marker in the virtual model), the arm 326 can be moved such that the pins 464 are insert into the apertures 485 of the arm 326 until a surface of the probe 422 proximate the pins 464 contacts an upper surface of the third segment 446 of the arm 326. The arm 326, in some variants, can be locked in place when positioned. In some variants, the operator can push the first button 506 corresponding to another arm 326 to prompt the robot 306 to move the probe 422 toward an approach position for the another arm 326. In some variants, the operator can push the first button 506 corresponding to the same arm 326 to prompt the robot 306 to retract the probe 422 back to the approach position for the same arm 326 prior to pushing the first button 506 for another arm 326 to prompt the robot 306 to move to the approach position for the another arm 326.

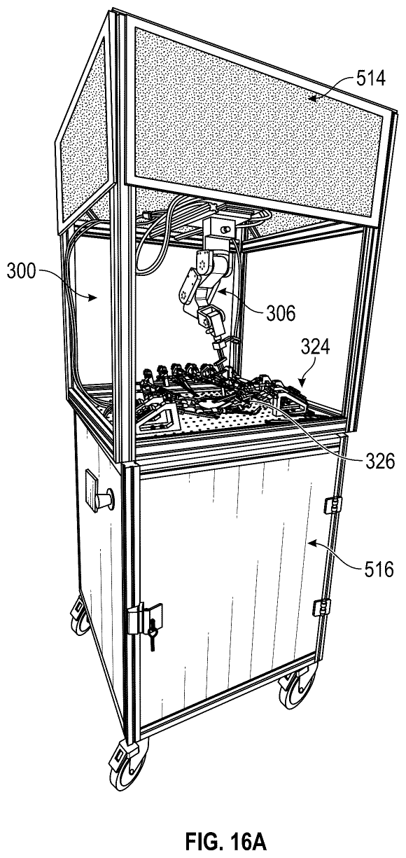

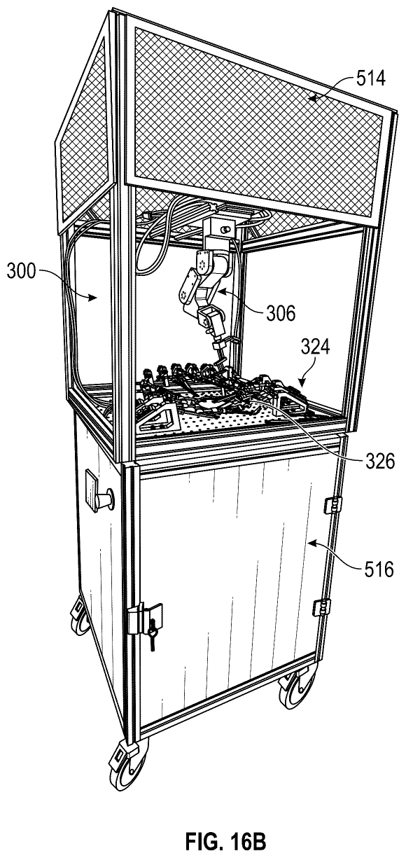

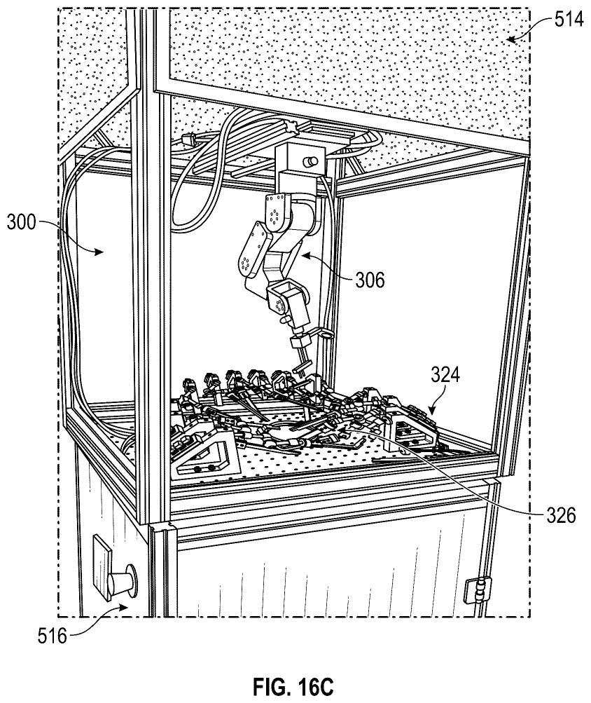

The robot 306 and plurality of arms 326 and bases 324 can be disposed on and/or in a frame 516 (e.g., chamber, which can include walls), as shown in FIGS. 16A-16C. The frame 516 can protect the robot 306, arms 326, and/or base 324. The frame 516 can protect the operator from collision with the features of the shaping system 300. The frame 516 may be positioned on wheels to enable the shaping system 300 to be conveniently moved. In some embodiments, the robot 306 may be positioned above the plurality of arms 326 and bases 324. In some embodiments, the robot 306 may be positioned to the side of the plurality of arms 326. In some embodiments, the shaping system 300 may include a plurality of robots 306, which may help to position the arms 326 at an accelerated rate.

The shaping system 300 can include an indicator 514, which may be a visual indicator such as a light source. The indicator 514 may emit a light to visually indicate to an operator the status of the shaping system 300. In some variants, the indicator 514 may emit different colors of light depending on the status of the shaping system 300. For example, the indicator 514 may emit a first color light (e.g., white) to indicate that the shaping system 300 is not active. The indicator 514 may emit a second color light (e.g. green) to indicate that the shaping system 300 is indicating positions for the arms 326. The indicator 514 may emit a third color light (e.g., red) to indicate that the shaping system 300 is performing the heat setting process (e.g., exposing the archform 100 to a heating element to set the custom shape of the archform 100). The indicator 514 may emit fourth color light (e.g., blue) to indicate that the archform 100 is cooling. The indicator 514 may emit a fifth color light (e.g., yellow) and/or emit a blinking light to indicate that the archform 100 is ready for removal from the arms 326. The colors provided are exemplary and not limiting. The indicator 514 may emit lights in a pattern (e.g., flashing lights) to indicate the status of the shaping system 300. In some variants, the indicator 514 (e.g., speaker) may audibly indicate the status of the shaping system 300. In some embodiments, the indicator 514 (e.g., display) may display text and/or symbols to indicate the status of the shaping system 300.

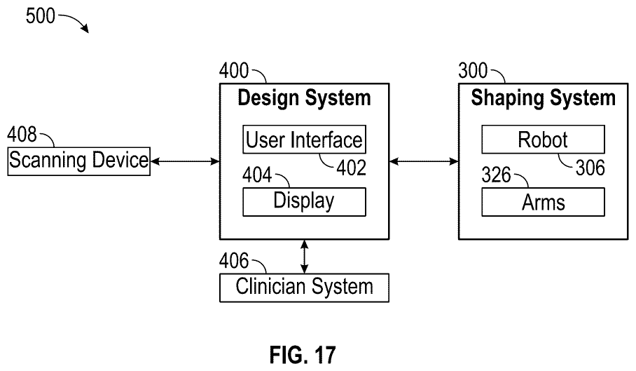

FIG. 17 illustrates a schematic of a system 500 that can include a scanning device 408, design system 400, shaping system 300, and/or clinician system 406. The systems, devices, and/or features of the system 500 can communicate via wireless and/or wired communication.

The scanning device 408 can be used to perform a scan (e.g., 3D scan(s) and/or 2D scan(s)) of the inside of the patient's mouth (e.g., dental arches). The scan can capture data regarding the type, size, shape, contours, surface features, positioning, and/or other characteristics of the patient's teeth, gums, and/or bone structure. The scans can be taken by the patient, caretaker of the patient, and/or clinician. The scan can be performed using a camera and/or sensor of a computer, device connected to a computer, and/or a mobile device, such as a smartphone. In some variants, an application can be used to perform the scans-providing the patient with instructions on how to perform the scan and when a scan is successful. The scan can be performed using the mobile device's built-in camera or via an attachment that operatively connects to the mobile device or computer. The scan data can be sent to a design system 400.

The design system 400, which can include a user interface 402 and/or display 404, can create and/or be used to create a virtual digital model of the patient's teeth in first positions (e.g., maloccluded positions) based on the scan data. The digital model can represent the unique size, shape, contours, surface features, positioning, orientation, and/or other characteristics of the patient's teeth, gums, and/or bone structure. The digital model can be displayed to an operator via a display 404 and/or user interface 402 of the design system 400 for viewing and/or manipulation. The design system 400 can segment and/or be used to segment the digital teeth of the digital model to enable movement of the digital teeth of the digital model. The operator can move the digital teeth of the virtual model to second positions (e.g., an alignment, planned alignment, final alignment). The operator can select, modify, design, and/or place digital brackets on the digital teeth of the virtual model. In some variants, the operator can select, modify, design, and/or couple one or more digital archforms to the digital brackets. In some variants, the operator can determine and/or select, modify, and/or design a number of archforms to be used during treatment (e.g., one, two, three, four, or more). In some variants, the operator can determine, select, and/or design a rigidity for the archform(s), which can include increasing a rigidity of the archform(s) in a sequence of implementation. In some variants, the operator can design and/or modify the digital archform(s) based on the qualities of a patient's teeth (e.g., accommodate for a missing tooth by omitting one or more connectors and/or interproximal loops). In some variants, the operator can move the digital teeth with the digital brackets disposed thereon from the second positions back to first positions, which can ensure that the digital teeth and/or digital brackets do not interfere with each other during movement. In some variants, the operator can place digital brackets on the digital teeth with the digital teeth in the first positions prior to moving the teeth to the second positions, which can ensure that the digital teeth and/or digital brackets do not interfere with each other during movement. In some variants, the operator can place digital markers on and/or in the digital brackets (e.g., in the slots of the digital brackets) to virtually plan the positioning of the connectors of the archform. In some variants, the operator can place digital markers on and/or proximate the digital teeth to virtually plan the positioning of the connectors of the archform. In some variants, a software program can automatically place digital markers on and/or in the digital brackets (e.g., in the slots of the digital brackets). In some variants, a software program can automatically place digital markers on and/or proximate the digital teeth. In some variants, a software program can initially place the digital markers and the operator can then alter the positioning. In some variants, the operator can select, modify, design, and/or couple a digital archform directly to the digital teeth of the digital model. In some variants, a software program can automatically move the digital teeth of the virtual model to second positions; select, modify, design, and/or place digital brackets on the digital teeth of the virtual model; select, modify, design, and/or couple an archform to the digital brackets; determine, select, and/or design a rigidity for the archform(s); design and/or modify the digital archform(s) based on the qualities of a patient's teeth; move the digital teeth with the digital brackets disposed thereon from the second positions back to first positions; place digital markers on and/or in the digital brackets and/or on and/or proximate the digital teeth; and/or select, modify, design, and/or couple a digital archform directly to the digital teeth of the digital model. In some variants, user preference data corresponding to a patient can be received by the design system 400 and considered by the operator and/or software program.

Treatment data, which can include scan data and/or data manipulated, associated, and/or created by the design system 400, can be communicated to a clinician system 406. The treatment data can at least include data relating to the virtual model with virtual teeth in the first positions; the virtual model with teeth in the second positions; a movement path of the teeth from the first to second positions; selection, modification, design, and/or placement of digital brackets; placement of digital markers; selection, modification, design, and/or coupling of archform(s); rigidity and/or modification of archform(s); patient preference(s), and/or other data. The clinician system 406 can be accessed by a clinician to review the treatment data. The clinician can advise as to alterations to the treatment plan and/or data; these advisements can be communicated to the design system 400 for consideration by the operator. For example, the clinician can review a virtual model of the teeth in the second positions (e.g., alignment) and indicate changes, which are communicated to the design system 400 and/or by way of other communication channels to the operator of the design system 400. In some variants, a patient can review treatment data, which can include a virtual model of the teeth in the second positions, and request alterations; these requested alterations can be considered by the operator and/or clinician.

Treatment data can be communicated to the shaping system 300. The shaping system 300 can include the robot 306 and/or plurality of arms 326, as described herein. The robot 306 can indicate positions for the plurality of arms 326 (e.g., holders 382 of the arms 326, third segments 446 of the arms 326) based on the digital marker positions in the virtual model with the digital teeth in the second positions (e.g., planned alignment). In some variants, the robot 306 can indicate positions for the plurality of arms 326 (e.g., holders 382 of the arms 326, third segments 446 of the arms 326) based on the digital teeth and/or digital brackets in the virtual model with the digital teeth in the second positions (e.g., planned alignment). In some variants, the robot 306 can indicate positions for the arms 326 (e.g., holders 382, third segments 446) based on a digital archform in the virtual model.

An operator can move each of the arms 326, respectively, to positions indicated by the robot 306, as described herein, and lock the arms 326 in place. For example, the robot 306 can indicate positions, based on the digital markers in the virtual model, with the probe 422 and pins 464. The operator can move each arm 326 to position the pins 483 through the holes 485 of each of the third segments 446. The operator can clamp the connectors 102 of the archform 100 in the holders 482 and couple the holders 482 to the arms 326, as described herein, such that the archform 100 takes on a custom 3D shape corresponding to the digital marker positions in the virtual model.

In another example, an operator can move each of the arms 326, respectively, to position holders 382 of the arms 326 in positions indicated by the robot 306. For example, the robot 306 can indicate positions, based on the digital markers in the virtual model, with the probe 322 and the first and second protrusions 364, 366. The operator can move each arm 326 to position the first and second protrusions 364, 366 in the first and second holes 356, 358. The arms 326 can be locked in the indicated positions. The operator can clamp the connectors 102 of the archform 100 in the holders 382 such that the archform 100 takes on a custom 3D shape corresponding to the digital marker positions in the virtual model.

With the archform 100 held in the custom 3D shape, the archform 100 can be heat set as described herein to set the custom 3D shape as the default shape of the archform 100. For example, the robot 306 can, with a heating element such as a heat gun, heat set the archform 100 in the custom 3D shape. In some variants, the archform can be set by way of exposure to an electrical current, which can be applied through the arms 326.

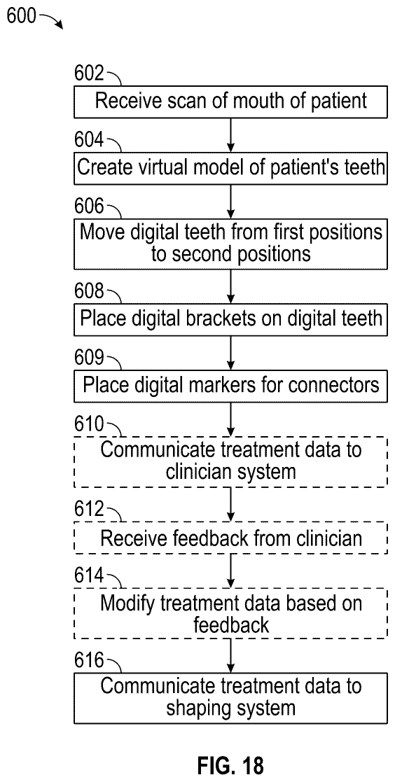

FIG. 18 illustrates an example method 600 of creating treatment data (e.g., a treatment plan), which can include a virtual model, for a patient and communicating the treatment data to a shaping system. This flow diagram is provided for the purpose of facilitating description of aspects of some embodiments. The diagram does not attempt to illustrate all aspects of the disclosure and should not be considered limiting.

At block 602, the design system 400 can receive scan data of a patient's mouth from a scanning device 408. A scan (e.g., 3D scans and/or 2D scans) can be taken of the inside of the patient's mouth (e.g., dental arches, gums, bone structure, etc.). The scan can capture data regarding the type, size, shape, contours, surface features, positioning, and/or other characteristics of the patient's teeth. The scans can be taken by the patient, caretaker of the patient, and/or clinician. The scan can be performed using a camera and/or sensor of a computer, device connected to a computer, and/or a mobile device, such as a smartphone. In some variants, an application can be used to perform the scans—providing the patient with instructions on how to perform the scan and when a scan is successful. The scan can be performed using the mobile device's built-in camera or via an attachment that operatively connects to the mobile device or computer.

At block 604, a virtual model (e.g., digital model) of the patient's teeth can be created by the design system 400 based on scans of the inside of the patient's mouth. The virtual model can represent the unique size, shape, contours, surface features, positioning, and/or other characteristics of the patient's teeth. In some variants, the virtual model can be automatically generated by software implemented on a computing device using the scans of the inside of the patient's mouth. In some variants, the design system 400 can segment each digital tooth of the virtual model to enable movement of the digital teeth with respect to each other. The virtual model can digitally represent the patient's teeth in first positions (e.g., maloccluded positions).

At block 606, the digital teeth can be moved from the first positions to second positions (e.g., an alignment, planned alignment, final alignment, planned configuration). The digital teeth can be moved by an operator utilizing the design system 400 and/or a software program. In some variants, the operator and/or software program can consider patient and/or clinician input when moving the digital teeth to the second positions. In some variants, the operator can modify the second positions of the digital teeth as planned by the software program.

At block 608, digital brackets suitable for bonding on surfaces of the digital teeth can be selected from a variety of digital brackets and placed on the surfaces of the digital teeth. An operator utilizing the design system 400 and/or a software program can select and/or place digital brackets on the digital teeth. The digital brackets can be placed on buccal or lingual surfaces of the digital teeth. Certain types and/or sizes of brackets may be more suitable and/or preferred for bonding on a given tooth but not others.

At block 609, digital markers can be placed on and/or in the digital brackets to indicate positions (e.g., orientation, placement, etc.) for the connectors 102 of the archform 100. For example, the digital markers may be placed in the receiving spaces (e.g., slots) of the digital brackets to indicate the positions for the connectors 102 of the archform 100. The digital markers may, in some variants, be sized and shaped the same as the connectors 102. In some variants, a digital archform can be coupled to the digital brackets. In some variants, the archform 100 may be directly bonded to a patient's teeth without brackets 200. In some variants, the archform 100 may be directly bonded to some of the patient's teeth and coupled to brackets bonded to some of the patient's teeth. Accordingly, in some variants, the digital markers may be disposed on and/or proximate the digital teeth to allow for bonding directly to the teeth without the use of a bracket. An operator utilizing the design system 400 and/or a software program can place the digital markers as described herein. In some variants, a software program can automatically place the digital markers as described herein.

At block 610, treatment data can be communicated from the design system 400 to the clinician system 406. Treatment data, which can include scan data and/or data manipulated, associated, and/or created by the design system 400, can be communicated to a clinician system 406. The treatment data can at least include data relating to the virtual model with virtual teeth in the first positions; the virtual model with teeth in the second positions; a movement path of the teeth from the first to second positions; selection, modification, design, and/or placement of digital brackets; selection, modification, design, and/or coupling of archform(s); rigidity and/or modification of archform(s); patient preference(s), and/or other data; and placement (e.g., orientation, positioning, etc.) of digital markers. The clinician system 406 can be accessed by a clinician, such as an orthodontist, to review the treatment data. The clinician can advise as to alterations to the treatment plan and/or data. At block 612, this feedback (e.g., advisements) of the clinician can be communicated to and received by the design system 400 for consideration. For example, the clinician may advise as to alterations to the planned alignment. The clinician may advise as to bracket type and/or placement. The clinician may advise as to the size, shape, and/or stiffness of an archform. The clinician may advise as to the number of archforms to use in a treatment plan.

At block 614, the treatment data (e.g., virtual model with teeth in second positions, selection and placement of digital brackets, placement of digital markers, etc.) can be modified based on the feedback from the clinician. In some variants, the operator and/or software program can modify the treatment data based on the feedback from the clinician.

At block 616, the treatment data, which can at least include the data, virtual models, placement of the digital markers in the digital model, etc. described herein, can be communicated (e.g., wirelessly and/or wired) to the shaping system 300 (e.g., robot 306). In some variants, data regarding the placement of the digital markers can be communicated to the shaping system 300 (e.g., robot 306).

In some variants, a clinician, such as an orthodontist, can communicate treatment plan data directly to the shaping system 300. In some variants, the clinician may alter a treatment plan and directly communicate the altered treatment plan to the shaping system 300. For example, in some variants, a clinician may review treatment plan data, which may include a virtual model of the patient's teeth in a planned alignment with one or more brackets and digital markers positioned. The clinician may alter the position of one or more teeth, bracket selection, bracket placement, digital marker placement, and/or other aspects of the treatment plan data and communicate the altered treatment plan to the shaping system 300 to shape the archform. In some variants, a clinician may receive data for a virtual model of the patient's teeth in the maloccluded positions, and the clinician and/or clinician system 406 may perform the steps described in reference to blocks 606-609 and communicate the treatment plan data to the shaping system 300. In some variants, scan data of a patient's mouth can be received by the clinician system 406 and the clinician system 406, which may include one or more computing devices, can create a virtual model of the patient's teeth with teeth in maloccluded positions. The orthodontist and/or clinician system 406 may then perform one or more of the steps described in reference to blocks 606-609 and communicate the treatment plan data to the shaping system 300.

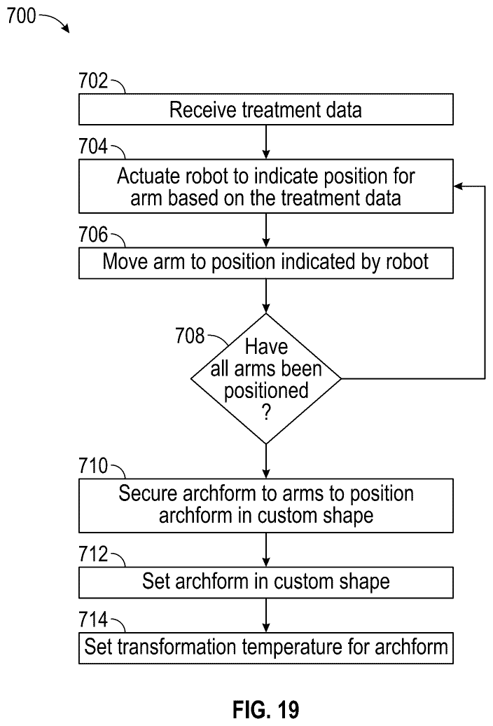

FIG. 19 illustrates an example method 700 of custom shaping an archform based on treatment data. This flow diagram is provided for the purpose of facilitating description of aspects of some embodiments. The diagram does not attempt to illustrate all aspects of the disclosure and should not be considered limiting.

At block 702, the shaping system 300 (e.g., robot 306) can receive treatment data. For example, the shaping system 300 (e.g., robot 306) may receive treatment data regarding the positions (e.g., orientation, placement, etc.) of the digital markers in the virtual model with the digital teeth in the second positions. In some variants, the shaping system 300 (e.g., robot 306) can convert positions of the digital markers to a G-code to correlate the positions of the digital makers in 3D space. In some variants, the treatment data may include data regarding the virtual model with digital teeth in the section positions, selection and placement of digital brackets, etc.

At block 704, the robot 306 can be actuated to indicate a position for an arm 326 of the shaping system 300 based on the treatment data. For, example, the robot 306 can be actuated to indicate a position corresponding to a digital marker. The robot 306 can be actuated to indicate a position for the third segment 446 of the arm 326. The robot 306 may include a probe 422 that may have pins 464 that can be moved to a position in 3D space based on the position of a digital marker of the treatment data. In another example, the robot 306 can be actuated to indicate a position for a holder 382 of the arm 326 of the shaping system 300 based on the position of the digital marker. As described herein, the robot 306 can include a probe 322, which can include a first protrusion 364 and/or second protrusion 366. The probe 322 can indicate a position for the holder 382 of the arm 326 (e.g., third segment 346 and/or holder 382), as described herein.

At block 706, the arm 326 can be moved to the position indicated by the robot 306. As described herein, the operator can move the third segment 446 of the arm 326 to a position indicated by the robot 306. For example, the third segment 446 may include holes 485. The operator can move the arm 326 to place the pins 464 of the probe 422 through the holes 485 to position the arm 326 in 3D space. The arm 326 can be moved until the third segment 446 is contacting the probe 422 with the pins 464 disposed through the holes 485. In another example, the arm 326 may include a holder 382 coupled thereto or integrally formed therewith. As described herein, the third segment 346 of the arm 326 and/or holder 382 can include a first hole 356 and second hole 358 that correspond to the first protrusion 364 and/or second protrusion 366 of the probe 322 of the robot 306. Accordingly, the arm 326 can be maneuvered such that the first protrusion 364 and second protrusion 366 are inserted into the first hole 356 and second hole 358, respectively, to properly position the holder 382 of the arm 326. Magnet(s) and/or ferrous materials (e.g., iron), nickel, and/or cobalt can be incorporated in the arm 326, third segment 446, and/or probe 422 to facilitate interfacing the pins 464 with holes 485. Magnet(s) and/or ferrous materials (e.g., iron), nickel, and/or cobalt can be incorporated in the arm 326, third segment 346, and/or probe 322 to facilitate interfacing the first hole 356 and second hole 358 with the first protrusion 364 and second protrusion 366. The steps described in reference to block 704 and block 706 can be repeated until all arms 326 are positioned. The arms 326 can be locked in positions indicated by the robot 306.

At block 708, it can be determined if all arms 326 have been positioned. In some variants, the operator can instruct the shaping system 300 that all arms 326 have been positioned. In some variants, the shaping system 300 (e.g., robot 306) can determine if all arms 326 have been positioned based on indicating the positions for the arms 326. If all arms 326 have not been positioned, the process can return to block 704. If all arms 326 have been positioned, the process can proceed to block 710. In some variants, the shaping system 300 may determine if all arms 326 have been positioned. In some variants, the operator can indicate to the shaping system 300 (e.g., robot 306) that all arms 326 have been positioned.

At block 710, the archform 100 can be secured to the arms 326 to assume a custom 3D shape. As described herein, a connector 102 of the archform 100 can be clamped by the holder 482 and then coupled to the third segment 446. For example, the connector 102 can be disposed in the gap 462 of the holder 482 between the upper pins 372 and lower pins 374 of the holder 482. The screw 454 may be advanced to clamp the connector 102 between the first fixed jaw 448 and the end of the screw 454. In some variants, the screw 454 may push a moveable jaw 450 disposed on the upper pins 372 and lower pins 374 to clamp the connector 102 between the first fixed jaw 448 and the moveable jaw 450. With the holder 482 clamping the connector 102, the holder 482 may be coupled to the third segment 446. The pins 483 of the holder 482 may be inserted through the holes 485 until the third segment 446 prevents further advancement to position the holder 482. A screw or the like may secure the holder 482 to the third segment 446. In some variants, a magnetic force may be sufficient to secure the holder 482 to the third segment 446. The same process can be performed for each arm 326 and connector 102 until the archform 100 is held in a custom 3D shape. In some variants, the holders 482 may be secured to the third segments 446 prior to clamping the connectors 102 in the holders 482. With the archform 100 held in the custom 3D shape, the connectors 102 are placed in positions corresponding to the digital markers in the virtual model of the patient's teeth.

In another example, the connectors 102 of the archform 100 can be coupled to the holders 382 of the arms 326. As described herein, the connectors 102 of the archform 100 can be disposed on the upper pins 372 and lower pins 374 and between the first fixed jaw 348 and moveable jaw 350 of the holder 382. The moveable jaw 350 can be translated, by way of rotation of the screw 354, toward the first fixed jaw 348 to clamp the connector 102 between the first fixed jaw 348 and the moveable jaw 350. The same process can be performed for each arm 326 and connector 102 until the archform 100 is held in a custom 3D shape. With the archform 100 held in the custom 3D shape, the connectors 102 are placed in positions corresponding to the digital markers in the virtual model of the patient's teeth.

At block 712, the archform 100 can be set in the custom 3D shape such that the custom 3D shape is a memorized shape (e.g., default shape) of the archform 100 (e.g., the archform 100 applies forces to return to the custom 3D shape if deflected therefrom). As described herein, the archform 100 can be made of a shape memory material (e.g., shape memory allow, shape memory, etc.) that can be heat treated to set a new memorized shape (e.g., default shape) for the archform 100. For example, the archform 100 can be made of nickel titanium (Nitinol). The archform 100 can be set by way of exposure to heat, as described herein. For example, a heating element, such as a heat gun, can apply heat to set the archform 100 in the custom shape. As described herein, the robot 306 can manipulate a heating element, such as a heat gun, to heat the archform 100 (e.g., connectors 102, loops 104) to set a new custom 3D shape for the archform 100. In some variants, a furnace, oven, or the like can heat set the archform 100. In some variants, an electrical current can be applied to the archform 100 (e.g., connectors 102 and/or interproximal loops 104) to heat the archform 100 to set the archform 100 in the custom shape. The archform 100 can cool after being heated.

At block 714, the archform 100 can be heat treated to set a transformation temperature for the archform 100. The transition temperature for the archform between martensite and austenite for the archform can be set. The archform can be in a martensite phase when the temperature of the archform is below the transition temperature and in an austenite phase when the temperature of the archform is above the transition temperature. The archform can be heat treated such that the transition temperature for the archform is between 75 and 97 degrees Fahrenheit. In some variants, the archform can be heat treated such that the transition temperature for the archform is between 80 and 90 degrees Fahrenheit. In some variants, the archform can be heat treated such that the transition temperature for the archform is 70, 71, 72, 73, 74, 75, 76, 77, 78, 79, 80, 81, 82, 83, 84, 85, 86, 87, 88, 89, 90, 91, 92, 93, 94, 95, 96, 97, or 98 degrees Fahrenheit or a temperature between any of the foregoing values. The archform can be heat treated such that the archform is in a martensite phase when the temperature of the archform is between 65 and 75 degrees Fahrenheit, which can typically correspond with room temperature. In some variants, the archform can be heat treated such that the archform is in a martensite phase when the temperature of the archform is between 60 and 80 degrees Fahrenheit or any subrange or value therebetween. The archform can be heat treated such that the archform is in an austenite phase when the temperature of the archform is between 97 and 99 degrees Fahrenheit, which can typically correspond with body temperature. In some variants, the archform can be heat treated such that the archform is in an austenite phase when the temperature of the archform is between 90 and 100 degrees Fahrenheit or any subrange or value therebetween. In the martensite phase, the archform can be flexible and/or pliable to facilitate easy installation. In the austenite phase, the archform can be rigid and/or springy (e.g., activated) to exert forces on the patient's teeth after installation. Accordingly, as a clinician handles and installs the archform in a patient's mouth, the archform can be pliable to facilitate easy handling and installation. After installation, the archform 100 can be heated by the patient's mouth to or above the transition temperature such that the archform is in the austenite phase and activated toward the custom nonplanar shape. In the austenite phase, the archform can be rigid and/or springy to exert forces on the patient's teeth to move the patient's teeth. In the austenite phase, the archform 100 can assume the custom nonplanar shape (e.g., memorized shape, default shape), exerting forces on the patient's teeth when coupled (e.g., coupled via brackets) to the patient's teeth. The heat treating of the archform can include heating the archform in an oven and/or furnace. In some variants, the archform 100 can be heat set in the custom nonplanar shape and the transition temperature set at the same time.

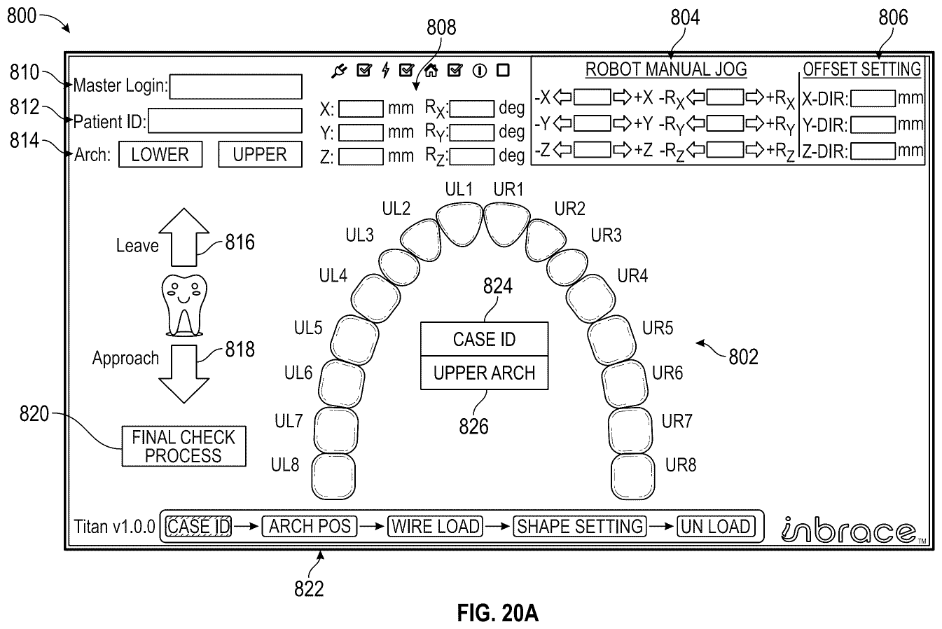

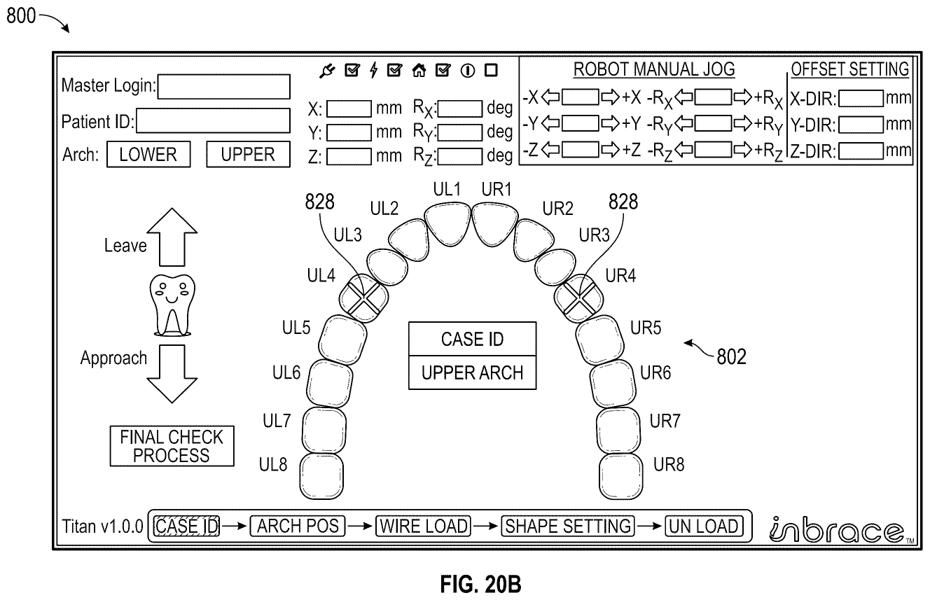

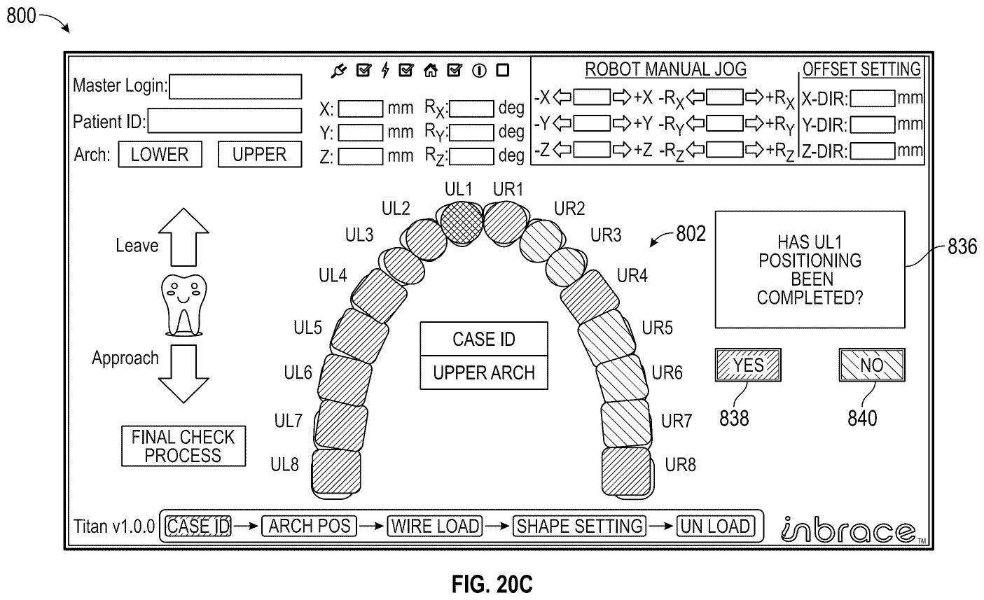

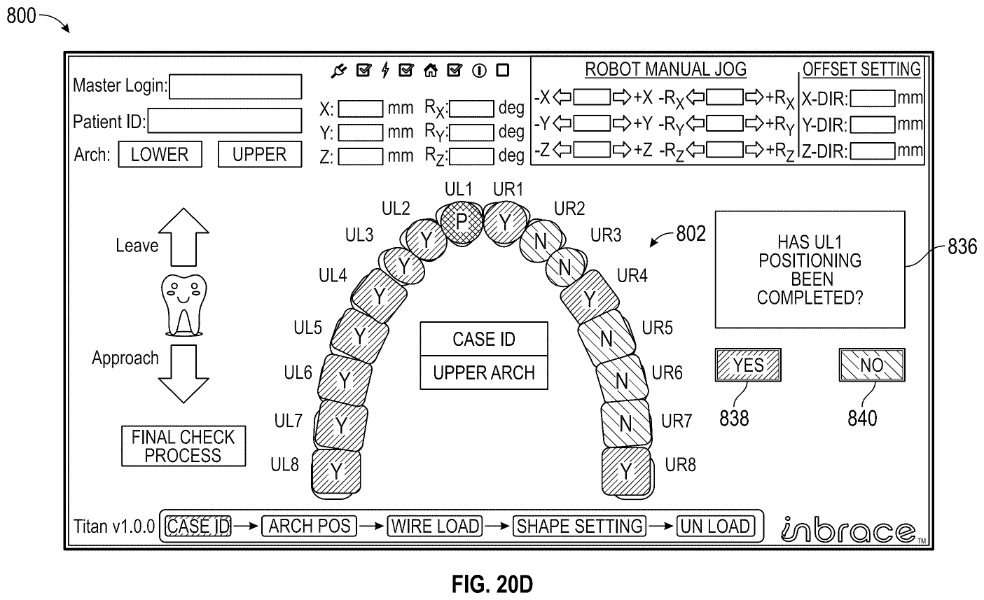

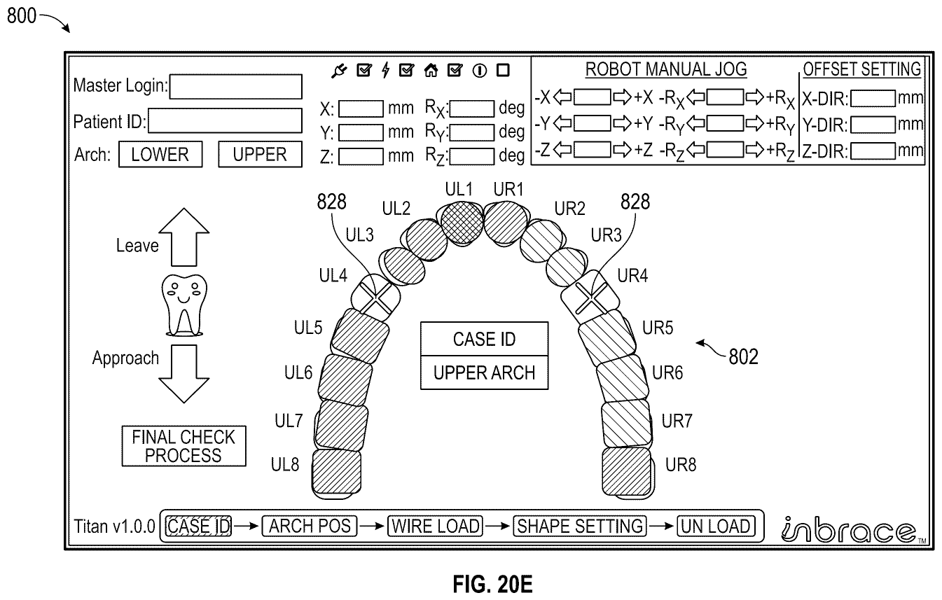

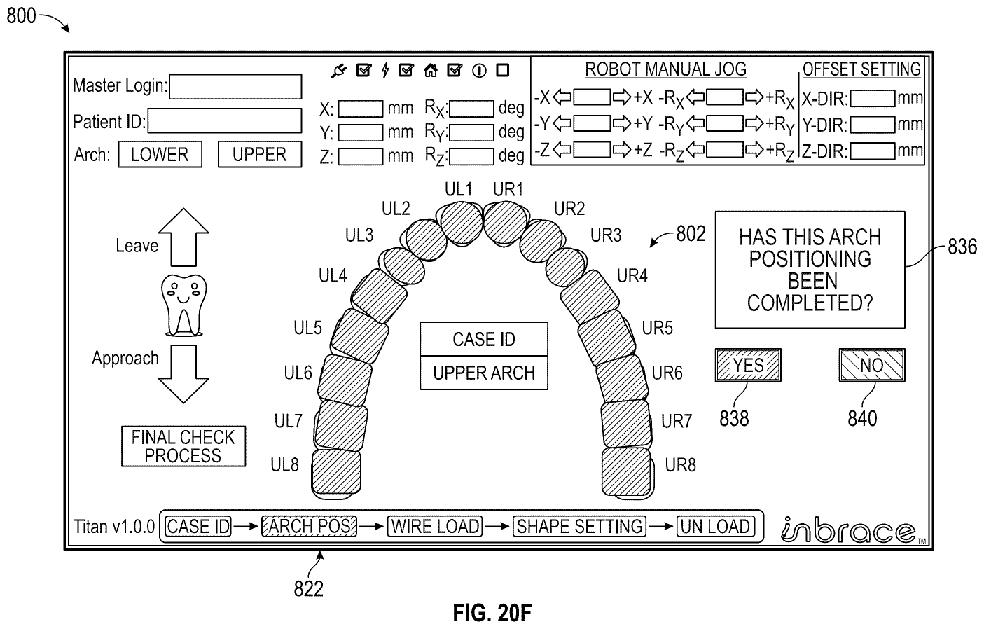

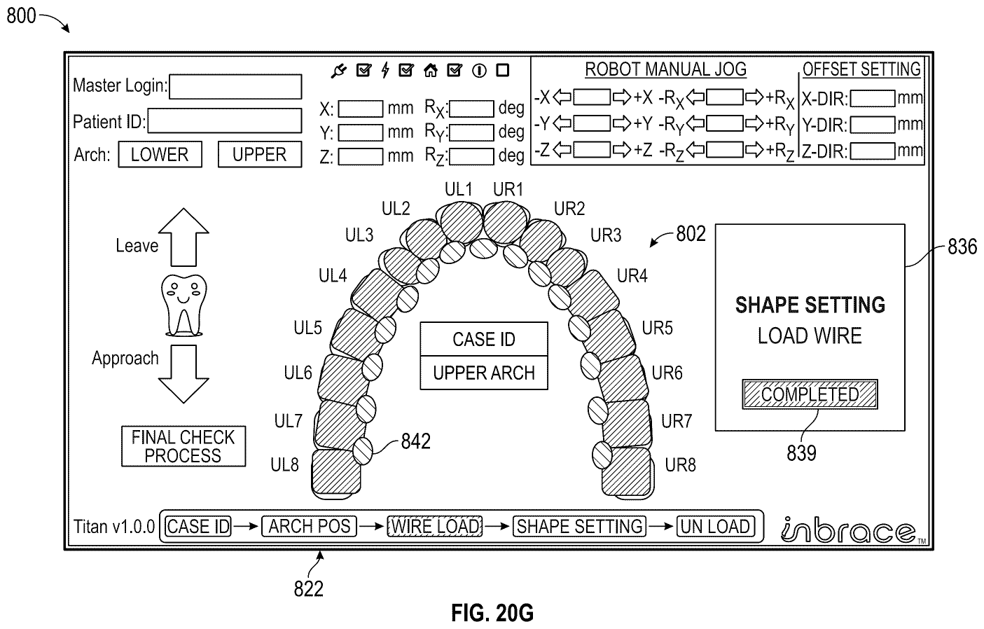

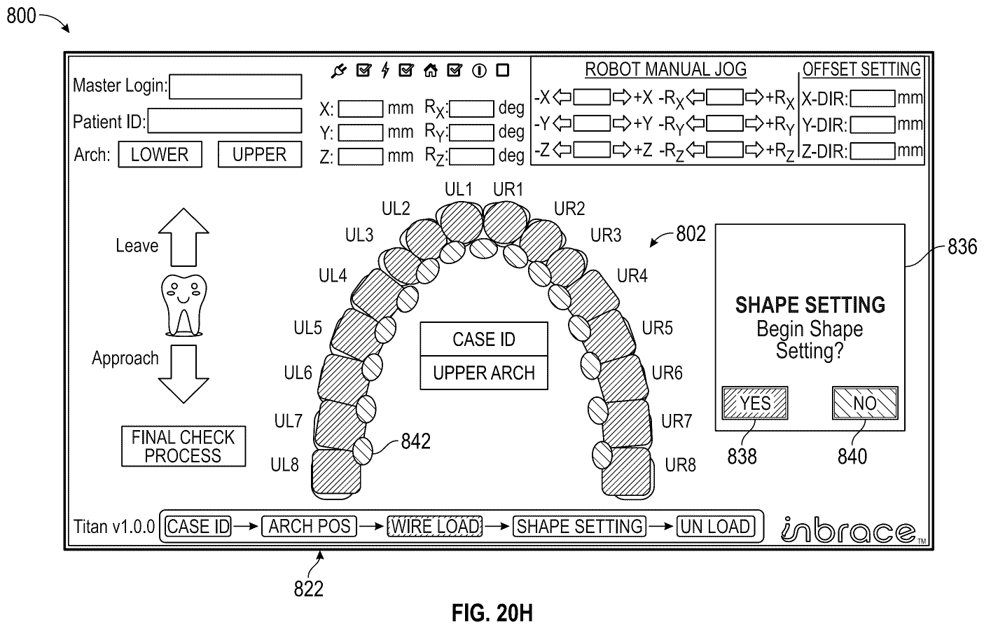

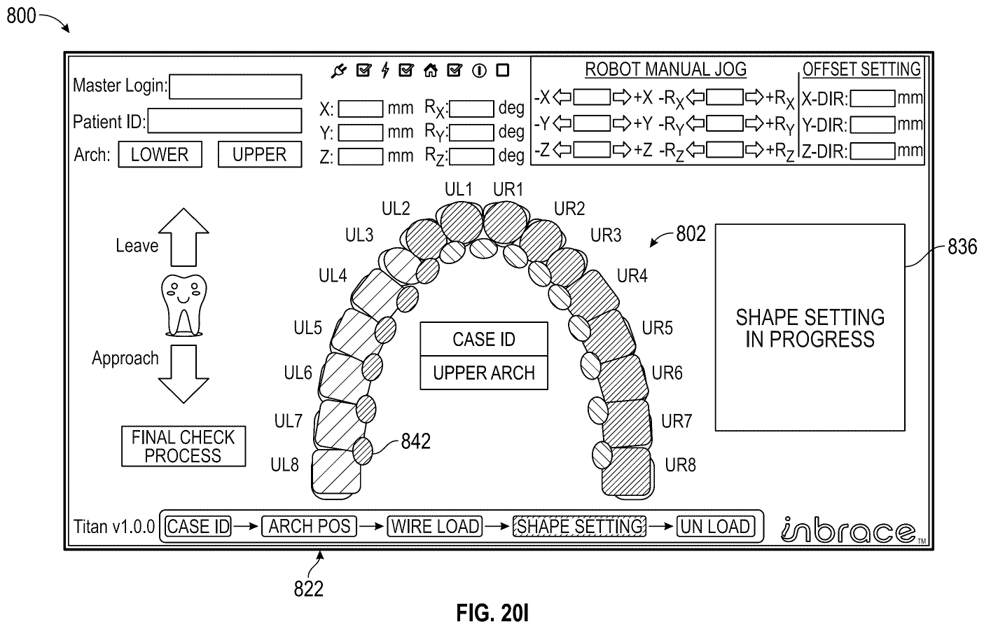

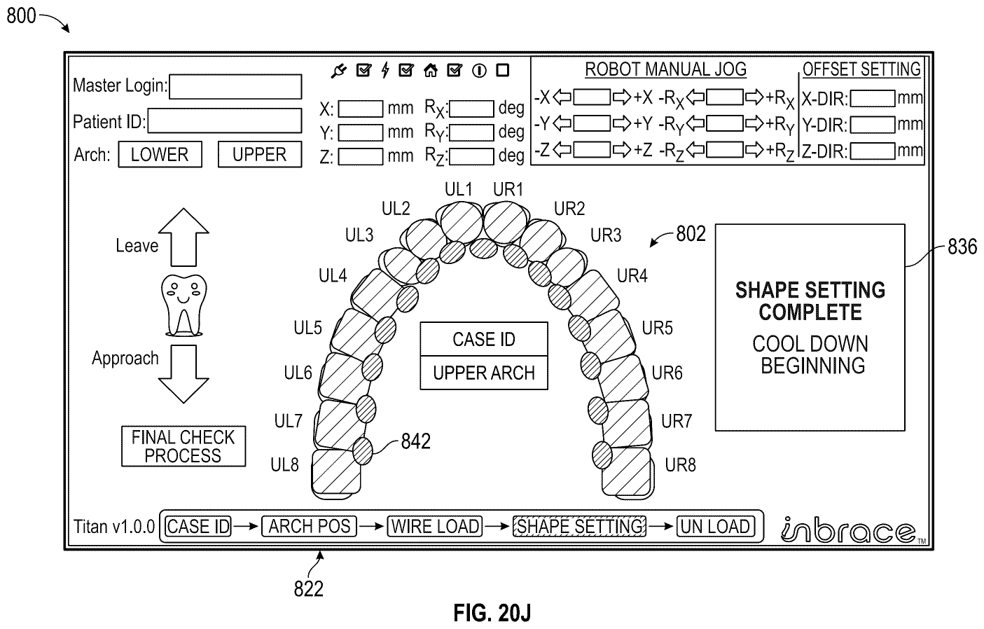

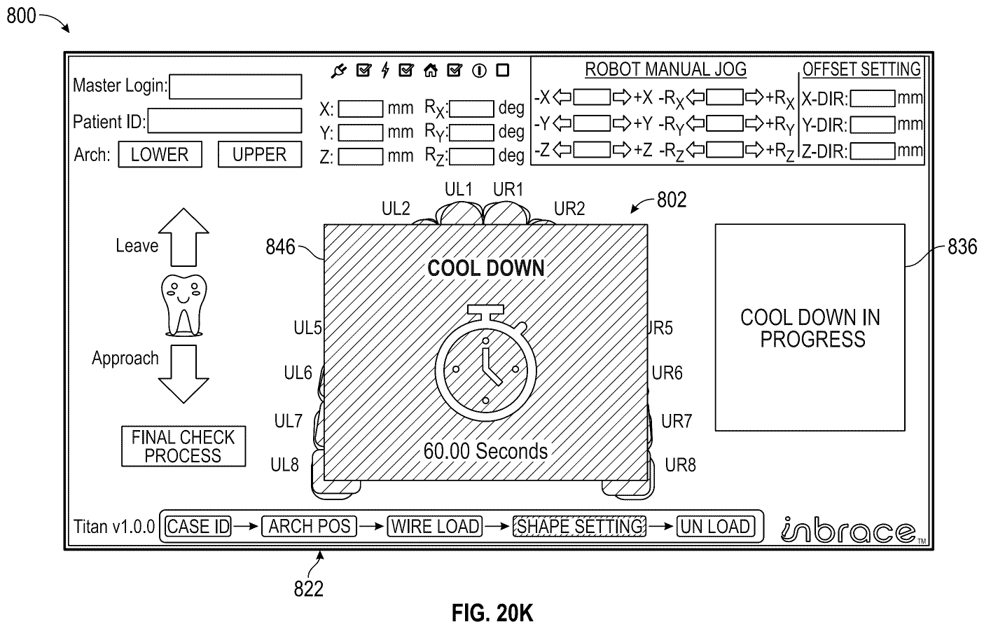

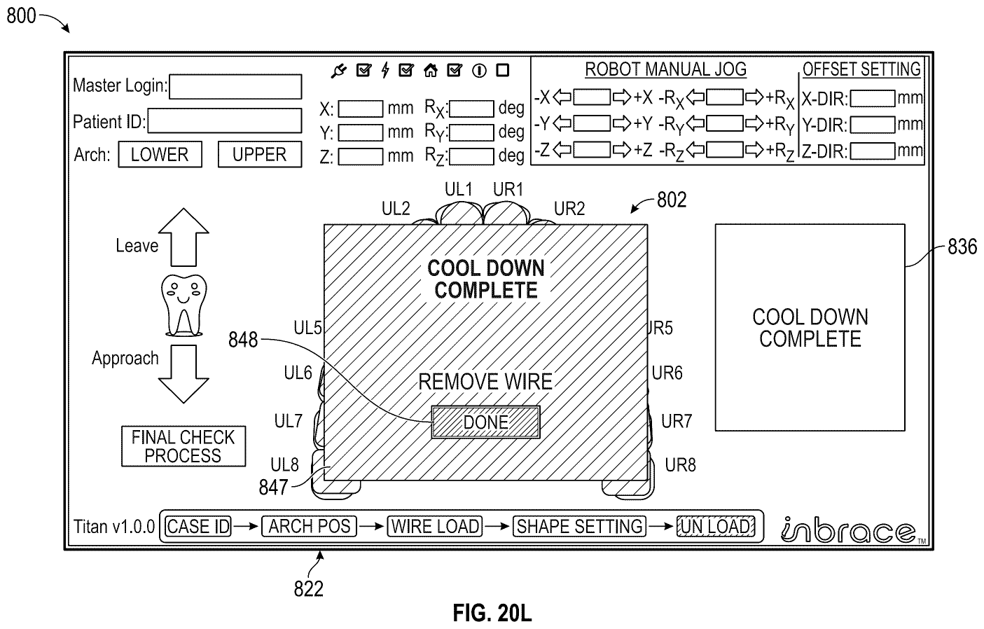

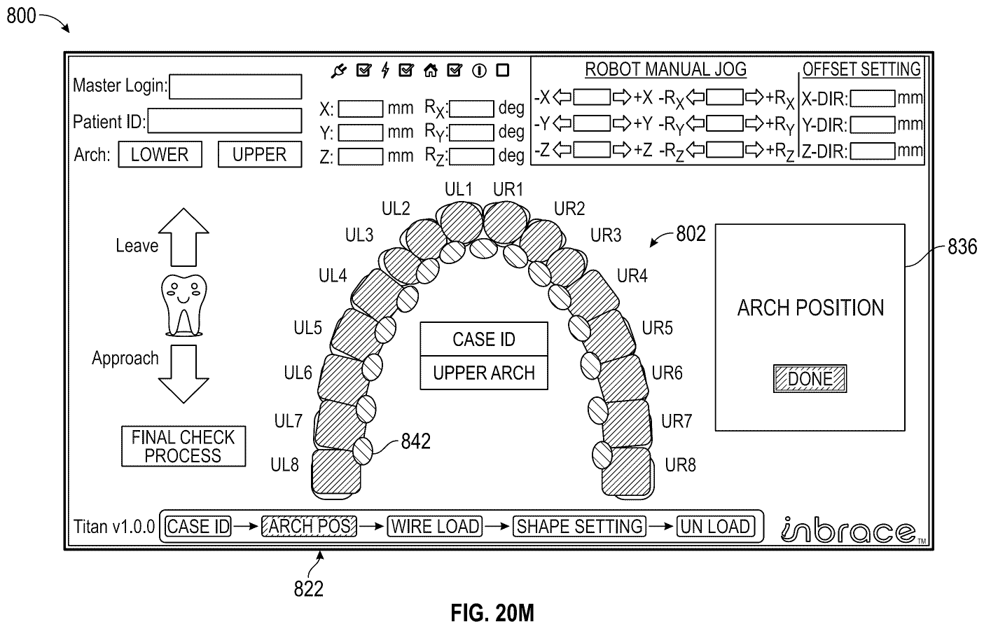

FIGS. 20A-20M illustrate various example user interfaces that can be used with the shaping system 300 and/or shaping system 301. FIGS. 20A-20M illustrate example user interfaces that may guide an operator through the shape setting process for one or more archforms 100 using the shaping system 300 and/or shaping system 301. The user interfaces can be displayed on a touch screen to both communicate information to an operator and/or receive input from the operator. The shaping system 300 and/or shaping system 301 may include another input device, such as a keyboard, pointing device (e.g., mouse), to enable an operator or the like to input to provide information and/or commands to the shaping system 300 and/or shaping system 301. The user interfaces shown are exemplary and should not be considered limiting.

As shown in FIG. 20A, the user interface 800 may include a master login input field 810. An engineer can input login information in the master login input field 810 to access restricted information and/or facilitate restricted control, reposition the robot 306, and/or alter offset settings for the robot 306. For example, the user interface 800 may include manual robot jog input fields and commands 804, which may be restricted to engineer access, that an engineer may use to move the robot 306 to positions in space (e.g., move the probe 322, 422 to a position in space). The user interface 800 may include manual robot offset input fields 806, which may be restricted to engineer access, that an engineer may use to alter the offset of the robot 306. For example, the robot 306 may include different probes 322, 422, which may have different geometries. Accordingly, the engineer may input information in the manual robot offset input fields 806 to enable the shaping system 300 to account for the geometry of the different probes 322, 422 when indicating positions for the arms 326.

The user interface 800 may include robot position indicator information 808, which may indicate the positioning of the probes 322, 422 to the operator and/or engineer.

The user interface 800 may include a patient identification number input field 812. An operator may input a patient's identification number or identifier in the patient identification number input field 812 to select (e.g., load, identify) a patient's case information. The patient's case information can include data regarding the virtual model of the patient's teeth in a planned alignment. The patient's case information can include data regarding the positioning of the digital markers in the virtual model. The patient's information can include data regarding bracket type (e.g., geometry), placement, etc. in the virtual model. The patient's information can include data regarding the shape of the archforms (e.g., upper and lower archforms) to move the patient's teeth to the digitally planned alignment.

The user interface 800 may include an arch selection input 814, which may include an interface (e.g., virtual buttons) to select between the upper arch and the lower arch. As explained herein, the shaping system 300 can be used to custom shape archforms 100 for treating the upper or lower arches of the patient. Accordingly, the data for custom shaping an archform 100 with the shaping system 300 for either the upper or lower arch may be selected. For example, an operator may indicate the upper arch (e.g., interact with the upper arch button) to command the robot 306 to indicate positions for the arms 326 to shape an archform 100 corresponding to the upper arch. An operator may indicate the lower arch to command the robot 306 to indicate positions for the arms 326 to shape an archform 100 corresponding to the lower arch.

The user interface 800 may include a robot arm retraction control 816, which may be a virtual button. An operator may interact with (e.g., touch) the robot arm retraction control 816 (e.g., virtual button) to command the robot 306 to retract the probe 322, probe 422 as described herein. An operator may interact with (e.g., touch) the robot arm approach control 818 (e.g., virtual button) to command the robot 306 to advance the probe 322, 422 as described herein. The robot 306 may retract and/or advance the probe 322, 422, relative to an indicating position, in a direction that would not move an arm 326 corresponding to the indicating position if the arm 326 were properly positioned, as described herein.

The user interface 800 may include a final check process interface 820. The final check process interface 820 may, when interacted with, prompt the robot 306 to verify there are not singularities, missing data, and/or errors in the treatment data. In some variants, the robot 306 may run a virtual simulation indicating the positions for all of the arms 326 to verify one or more of the foregoing.

The user interface 800 may include a case identification number 824 displayed. The case identification number 824 may correspond to the patient identification number input in the patient identification number input field 812. The user interface 800 may display an arch indicator 826, which may indicate whether the shaping system 300 is ready for and/or in the process of shape setting the upper arch or lower arch. For example, if the operator selects the lower arch with the arch selection input 814 then the arch indicator 826 would display “lower arch.” Alternatively, if the operator selects the upper arch with the arch selection input 814 then the arch indicator 826 would display “upper arch.”

The user interface 800 may include an arch status indicator 802. The arch status indicator 802 may digitally represent an arch of teeth (e.g., the lower or upper arch). For example, as shown in FIG. 20A, the arch status indicator 802 digitally represents an upper arch with UL1-UL8 and UR1-UR8. As described herein, a connector 102 can correspond to an individual tooth of the arch. Accordingly, UL1 may correspond to a connector 102, UL2 may correspond to another connector 102, UL3 may correspond to yet another connector 102, etc. A connector 102 may correspond to each and every tooth of a dental arch and/or dental arch segment. A connector 102 may correspond to some teeth of a dental arch segment. Accordingly, the represented teeth in the arch status indicator 802 may correspond to associated connectors 102. As described herein, loops 104 may be disposed between adjacent connectors 102.

The user interface 800 may include a process status indicator 822, which may indicate the current status of and/or step of the shape setting process being performed by the shaping system 300. The process status indicator 822 may display various possible steps and/or statuses in sequence, as illustrated in FIG. 20A. The process status indicator 822 may display an archwire setting flow chart and indicate the current step and/or status of the shaping system 300. For example, the process status indicator 822 may at least display one or more of the possible steps for the process of shape setting the archform 100, which can at least include Case ID, Arch Pos (e.g., Arch Positioning), Wire Load, Shape Setting, and/or Unload. As the shaping system 300 progresses through the steps, the process status indicator 822 can highlight and/or otherwise indicate (e.g., indicate, emphasize, etc.) when a step is complete. In some variants, the process status indicator 822 may indicate when a step is being performed. The Case ID step can correspond to the operator inputting a patient's identification number in the patient identification number input field 812 and/or selecting the lower or upper arch to retrieve data regarding positioning an archform 100. The indication of the Arch Pos (e.g., Arch Positioning) step can correspond to the shaping system 300 being used to place the arms 326 in a custom configuration for holding the archform 100 in a custom 3D shape that can move the patient's teeth toward a digitally planned alignment. The indication of the Wire Load step can correspond to the loading (e.g., placing, retaining, holding, coupling) the archform 100 to the arms 326. The indication of the Shape Setting step can correspond to the heat setting of the archform 100 in the custom 3D shape with a heating element (e.g., heat gun) such that the custom 3D shape is the default (e.g., memorized) shape of the archform 100. The indication of the Unload step can correspond to the unloading (e.g., decoupling, removing) the archform 100 from the arms 326.

As shown in FIG. 20B, the arch status indicator 802 can indicate when one or more teeth of a patient's dental arch will not be coupled to a connector 102 for treatment. For example, the arch status indicator 802 may include one or more no treatment indications 828. As shown in FIG. 20B, the no treatment indications 828 are shown as Xs over the UL4 and UR4 teeth of the arch status indicator 802 to indicate that no connectors 102 corresponding to UL4 and UR4 need to be positioned. For example, the archform 100 may omit connectors 102 corresponding to UL4 and UR4. The digital teeth representations of the arch status indicator 802 marked with no treatment indication 828 may correspond to missing teeth of the patient. For example, if a patient is missing UL4 and UR4, then no connectors 102 corresponding to UL4 and UR4 may need to be positioned. The archform 100 may even omit connectors 102 associated with UL4 and UR4 because the patient lacks UL4 and UR4. As such, arms 326 relating to UL4 and UR4 may not need to be positioned.

FIG. 20C illustrates an example user interface 800 when the shaping system 300 is being used to position arms 326 to custom shape the archform 100. The arch status indicator 802 can indicate the positioning status of each arm 326 associated with the teeth of the dental arch. For example, the arch status indicator 802 may indicate whether each arm 326 has been positioned, has not been positioned, and/or is in the process of being positioned. For example, the arch status indicator 802 may change a color, pattern, and/or other feature of a tooth represented by the arch status indicator 802, which may indicate the positioning status of the arm 326 associated with the represented tooth.

As shown in FIG. 20C, the arms 326 associated with UL2-UL8, UR1, UR4, and UR8 have been positioned to hold the archform 100 in a custom 3D shape as described herein. Accordingly, the representations of UL2-UL8, UR1, UR4, and UR8 in the arch status indicator 802 have been indicated as positioned, which can at least include by way of a color (e.g., green), pattern, and/or other techniques. The arms 326 associated with UR2, UR3, UR5-UR7 have not been positioned. Accordingly, the representations of UR2, UR3, UR5-UR7 in the arch status indicator 802 have been indicated as not positioned, which can at least include by way of color (e.g., red), pattern, and/or other techniques. The arm 326 associated with UL1 is in the process of being positioned. For example, the robot 306 may be in the process of moving to indicate the position for the arm 326 and/or the robot 306 may be indicating the position for the arm 326 but the arm 326 may not yet have been positioned. Accordingly, the representations of UL1 in the arch status indicator 802 have been indicated as in the process of being positioned, which can at least include by way of color (e.g., yellow), pattern, and/or other techniques. Additionally, the user interface 800 may include a pop-up prompt 836 that asks “Has UL1 positioning been completed?”. As described herein, the robot 306 may indicate a position for an arm 326 and the arm 326 may be moved by an operator to the indicated position. Once the arm 326 for UL1 has been moved to the indicated position, the operator may interact with (e.g., touch) the yes input 838 displayed by the user interface 800, and in response, the UL1 can be indicated as positioned. The operator may interact with (e.g., touch) the no input 840 displayed by the user interface 800 to indicate that the arm 326 associated with UL1 has not been positioned. As described herein, the arms 326 and/or bases 324 on which the arms 326 are mounted can include button(s) (e.g., button 502) or the like that the operator can interact with (e.g., press) to indicate that an arm 326 is positioned in the position indicated by the robot 306.

In some variants, the operator may select a tooth representation of the arch status indicator 802 that is indicated as not positioned to begin positioning the arm 326 associated with the selected tooth representation. For example, the operator may select a tooth representation of the arch status indicator 802 that is indicated as not positioned, and in response, the user interface 800 may prompt the operator and ask whether the position for the arm 326 associated with the selected tooth representation should be indicated by the robot 306. In response, the user may indicate yes or no, which can include interacting with the yes input 838 and/or no input 840. If the operator indicates yes, the robot 306 can proceed to indicate the position for the arm 326 associated with the selected tooth representation. In some variants, the operator can manipulate (e.g., push) the first button 506 associated with an arm 326 to prompt the robot 306 to move to the approach position corresponding to that arm 326. The operator can manipulate (e.g., push) the second button 504 associated with the arm 326 to prompt the robot 306 to move to the indicating position corresponding to that arm 326, as described herein.

As shown in FIG. 20D, the arch status indicator 802 may indicate the positioning status of the arms 326 associated with the tooth representations of the arch status indicator 802 with alternative techniques. For example, graphical representations (e.g., letters, symbols, etc.) can be overlaid on the tooth representations of the arch status indicator 802 to indicate the positioning status of the associated arms 326. For example, a “Y” may be overlaid on the representations of UR2, UR3, and UR5-UR7 in the arch status indicator 802 to indicate that the arms 326 associated with UR2, UR3, and UR5-UR7 have been positioned. An “N” may be overlaid on the representations of UR2, UR3, and UR5-UR7 in the arch status indicator 802 to indicate that the arms 326 associated with UR2, UR3, and UR5-UR7 have not been positioned. A “P” may be overlaid on the representation of UL1 in the arch status indicator 802 to indicate that the arm 326 associated with UL1 is in the process of being positioned. The colors, patterns, graphical representations, etc. referenced herein are exemplary and should not be considered limiting.

FIG. 20E illustrates the arch status indicator 802 indicating the positioning status of the arms 326 associated with the tooth representations of the arch status indicator 802 with UL4 and UR4 with no treatment indications 828. Accordingly, the arms 326 associated with UL4 and UR4 may not require placement.

FIG. 20F illustrates the arch status indicator 802 indicating that all arms 326 associated with the tooth representations of the patient's arch have been positioned. For example, all of UL1-UL8 and UR1-UR8 are indicated as positioned, which may include the tooth representations including a color (e.g., green), pattern, graphical representation (letter, symbol, etc.), etc. With all the arms 326 positioned, the user interface 800 may display a pop-up prompt 836 that asks the operator “Has this arch positioning been completed?”. In response, the user may indicate yes or no, which can include interacting with the yes input 838 and/or no input 840.

With the arms 326 positioned, the operator may couple the archform 100 to the arms 326, which can at least include the techniques described herein. The user interface 800 may display a pop-up prompt 836 prompting the operator to indicate when the archform 100 has been coupled (e.g., loaded on) to the arms 326 in its entirety (e.g., all of the connectors 102 have been coupled to the arms 326), as shown in FIG. 20G. The operator may indicate that the archform 100 has been completely coupled to the arms 326 by interacting with (e.g., touching) the complete input 839 (e.g., virtual button).

In response to the operator indicating that the archform has been completely coupled to the arms 326, the user interface 800 can display a pop-up prompt 836 asking whether to begin shape setting (e.g., heat treating) the archform 100 in the custom 3D shape, as shown in FIG. 20H. In response, the user may indicate yes or no, which can include interacting with the yes input 838 and/or no input 840. The arch status indicator 802 may display loop heat status indications 842, which may be graphics (e.g., circles, ovals, loops, etc.). The loop heat status indication 842 may be disposed between adjacent tooth representations of the arch status indicator 802. The loop heat status indication 842 may include a color (e.g., red), pattern, graphical representation (letter, symbol, etc.), etc. to indicate heating status. For example, the loop heat status indications 842 in FIG. 20H all indicate a heating status of incomplete (e.g., not heated).

As shown in FIG. 20I, the user interface 800 may display a pop-up prompt 836 indicating that the shape setting process is in progress. As described herein, the robot 306 may expose a heating element to the archform 100 to shape set the archform 100 in the custom 3D shape. The archform 100 may be made of a shape memory material (e.g., alloy, polymer) that can be heated to set a new default shape (e.g., memorized shape) for the archform 100. The arch status indicator 802 may include tooth representations and loop heat status indications 842 indicating heating status indicating heating status for the connectors 102 and loops 104. For example, the representations of UL3-UL8 all indicate that the connectors 102 associated with UL3-UL8 have been heat set, which may include the tooth representations including a color (e.g., purple), pattern, graphical representation (letter, symbol, etc.), etc. The loop heat status indications 842 associated with the loops 104 between each of UL2 and UL3, UL3 and UL4, UL4 and UL5, UL5 and UL6, UL6 and UL7, UL7 and UL8 all indicate that they have been heat set, which may include the loop heat status indication 842 including a color (e.g., green), pattern, graphical representation (letter, symbol, etc.), etc.

FIG. 20J illustrates the arch status indicator 802 with all tooth representations and loop heat status indication 842 indicating that the corresponding connector 102 and loop 104 have been shape set (e.g., exposed to heat, which may include exposed to heat at a predetermined temperature and/or period of time). After being heated, the archform 100 may be hot. Accordingly, it may be advantageous to allow the archform 100 to cool to prevent operator injury and/or ensure that the custom 3D shape of the archform 100 is set before moving the archform 100. The user interface 800 may display a pop-up 836 indicating that the shape setting is complete and the archform 100 is cooling down period is beginning. As illustrated in FIG. 20K, the user interface 800 may display a pop-up 836 indicating that the cool down period is in progress. The user interface 800 may display a pop-up timer 846, indicating the remaining amount of time for the cool down period. In some variants, the cool down period may be sixty seconds.

As illustrated in FIG. 20L, the user interface 800 may display a pop-up 836 indicating when the cool down is complete. The user interface 800 may display a pop-up prompt 847 prompting the operator to remove (e.g., decouple) the archform 100 from the plurality of arms 326. The operator may indicate that the archform 100 has indeed been removed by interacting (e.g., touching) the complete input 848 (e.g., virtual button). The shaping system 300 can then be used to shape set another archform for the same patient or a different patient. When performing another shape setting for the same patient for the same arch, the process of shape setting may be repeated. If the arms 326 have not been moved from the positions indicated by the robot 306, the arms 326 may already be in positions to hold another archform 100 in the custom 3D shape.

As illustrated in FIG. 20M, after the operator indicates that the archform 100 has been removed from the plurality of arms 326, the user interface 800 may, once again, display an interface that corresponds to an arch positioning step (e.g., positioning the arms 326) or archwire loading step if the arms 326 are still in the positions indicated by the robot 306. If an arm 326 has been moved, the arm 326 may need to be repositioned to a location indicated by the robot 306.

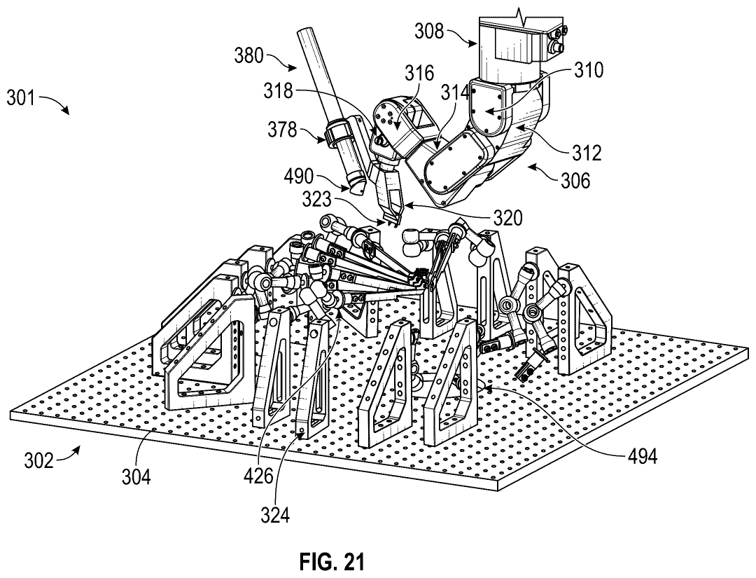

FIG. 21 illustrates a shaping system 301 that can custom shape an archform, which can at least include the archforms described herein. The shaping system 301 can include any of the features described in reference to shaping system 300. Likewise, the shaping system 300 can include any of the features described in reference to the shaping system 301. The robot 306 of shaping system 301 can be coupled to a fourth member 320, which can be coupled (e.g., rotatably coupled) to the third member of 318 of the robot 306.

The robot 306 (e.g., fourth member 320) can include (e.g., be coupled to) a probe 323 (e.g., indicator, guide, pointer, and/or protrusion(s)). The probe 323 can be rotatably coupled to the robot 306 (e.g., fourth member 320). The robot 306 can indicate a position for one of the arms 426 (e.g., holder of the arm 426) of the shaping system 301 with the probe 323 based on the position of a corresponding digital marker, digital bracket, and/or tooth in the digital model with the teeth in the planned alignment. An operator can move the arm 426 to interface with the probe 323 to position the arm 426 (e.g., holder of the arm 426). The robot 306 can be used to indicate positions for all of the plurality of arms 426. The robot 306 can indicate positions for holders of all the plurality of arms 426. The holders of the plurality of arms 426 can hold (e.g., secure, retain, clamp) the archform (e.g., connectors of the archform) in a custom 3D shape (e.g., custom nonplanar shape) corresponding to the digital teeth and/or digital brackets in the digital model with the digital teeth in the planned alignment. In some variants, each of the arms 426 can move to a position based on the positions of the corresponding digital markers, digital brackets and/or teeth in the digital model with the teeth in the planned alignment without the assistance of the robot 306.

The fourth member 320 can include (e.g., be coupled to) a heating element 380 (e.g., heat gun). The fourth member 320 can include a holder 378 (e.g., mount) that can couple (e.g., hold, secure) the heat gun 380 to the fourth member 320. The robot 306 can move (e.g., manipulate, maneuver, position) the heat gun 380. The robot 306 can heat an archform 100 held by the arms 426 of the shaping system 301 to set the archform 100 in a custom shape held by the arms 426. For example, the robot 306 can move the heat gun 380 to follow the shape of the archform 100 to shape set the archform in the custom shape that is digitally planned. The heat gun 380 can include a nozzle 490, which can be replaceable and/or interchangeable with nozzles of other configurations. The nozzle 490 can be angled relative to a center longitudinal axis of the heat gun 380. Heat can be directed out of the nozzle 490 in a targeted direction.

As described in reference to shaping system 300, the shaping system 301 can include a surface 302 (e.g., platform) with a plurality of holes 304. The plurality of arms 426 can be coupled to the surface 302. For example, the plurality of holes 304 can be used to couple the bases 324 of the plurality of arms 426 to the surface 302. The surface 302 can include a hole 494 (e.g., opening). Air (e.g., cool air) can be directed through the hole 494 to lower (e.g., cool) the temperature of the various features of the shaping system 301. For example, a fan, such as a cooling fan, can direct air through the hole 494 to lower the temperature (e.g., cool) the various features of the shaping system 301. As detailed herein, the robot 306 can use the heat gun 380 to heat the archform 100 to set the shape of the archform 100 in a custom arrangement, which can result in the archform 100, features of the shaping system 301 (e.g., arms 426, probe 323, fourth member 320, heat gun 380, surface 302, etc.), and/or environment (e.g., inside a chamber containing the robot 306 and/or arms 426) heating up to higher temperatures. In some variants, the archform 100, features of the shaping system 301, and/or environment can reach temperatures unsafe for human contact. Accordingly, directing air through the hole 494 can help to quickly lower temperatures of the archform 100, features of the shaping system 301, and/or environment for human contact.

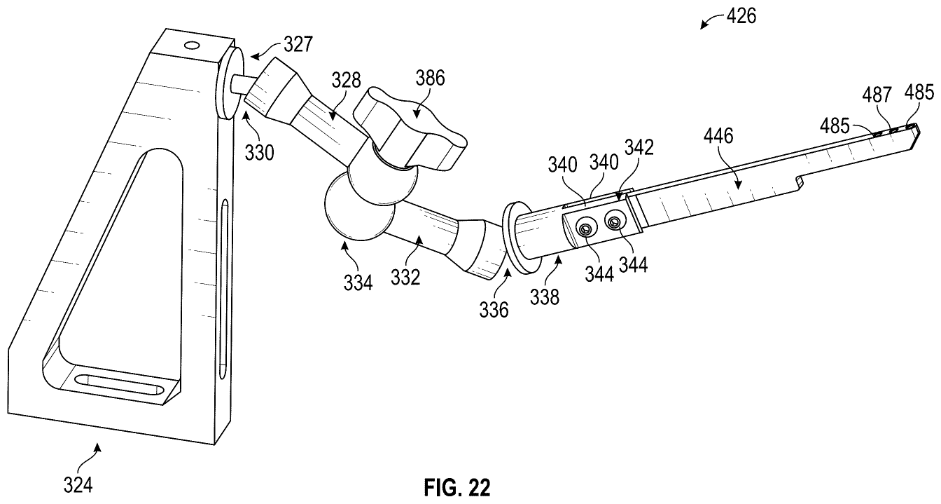

FIG. 22 illustrates one arm 426 of the plurality of arms 426 with a knob 386 (e.g., tightener, lock, locking mechanism). The arm 426 can at least include any of the features described in reference to the arm 326. The arms 326 can at least include any of the features described in reference to the arm 426. As described herein, the arm 426 can include a second joint 334. The second segment 332 of the arm 426 can be rotatably coupled to the first segment 328 of the arm 426 at the second joint 334. The knob 386 can be positioned at the second joint 334. The knob 386 can be manipulated (e.g., tightened, rotated) to lock the second joint 334 to maintain the relative positioning between the first segment 328 and the second segment 332. In use, the arm 426 can be manipulated (e.g., moved, maneuvered) to place an end of the third segment 446 of the arm 426 at a position indicated by the probe 323 of the robot 306, which can include the first segment 328 and the second segment 332 being moved relative to each other (e.g., angle between the first segment 328 and the second segment 332 can change). The knob 386 can be manipulated to lock the positioning of the first segment 328 and the second segment 332 relative to each other such that the holder (e.g., clamp) holding the archform 100 in the planned configuration remains stationary (e.g., in place) during heat setting. The second joint 334 can be unlocked by manipulating (e.g., loosening, rotating) the knob 386, which can enable the arm 426 to be repositioned (e.g., repositioned to set another archform in another planned configuration).

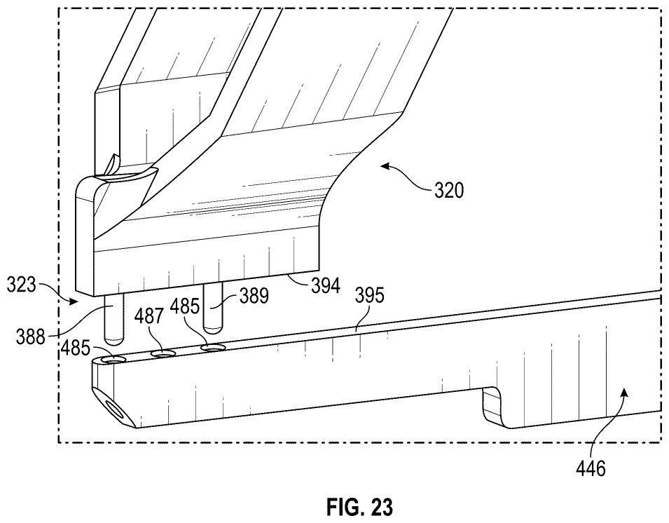

FIG. 23 illustrates the probe 323 indicating a position for a corresponding arm 426 of the shaping system 301. As detailed herein, the robot 306 can move the probe 323 to a position to interface with the corresponding arm 426. The probe 323 can include one or more features that interface with the arm 426. For example, the probe 323 can include one or more protrusions (e.g., two, three, four, or more), such as the protrusion 389 (e.g., pin, rod, cylinder, bar, etc.) and the protrusion 388 (e.g., pin, rod, cylinder, bar, etc.). The third segment 446 (e.g., end portion of the third segment 446) of the arm 426 can include one or more features that interface with the probe 323. For example, the third segment 446 can include one or more holes 485 (e.g., two, three, four, or more) that can receive the protrusions 388, 389. The arm 426 can be moved such that protrusions 388, 389 are positioned in the holes 485, which can include advancing the third segment 446 of the arm 426 until a surface 395 (e.g., upward-facing surface) of the third segment 446 contacts a surface 394 (e.g., downward-facing surface) of the robot 306 (e.g., fourth member fourth member 320 of the robot 306). The arm 426 can be locked in the position indicated by the robot 306, which can include tightening the knob 386. The robot 306 can indicate the positions for all of the arms 426 that correspond with teeth of a patient that are to be treated with orthodontics.

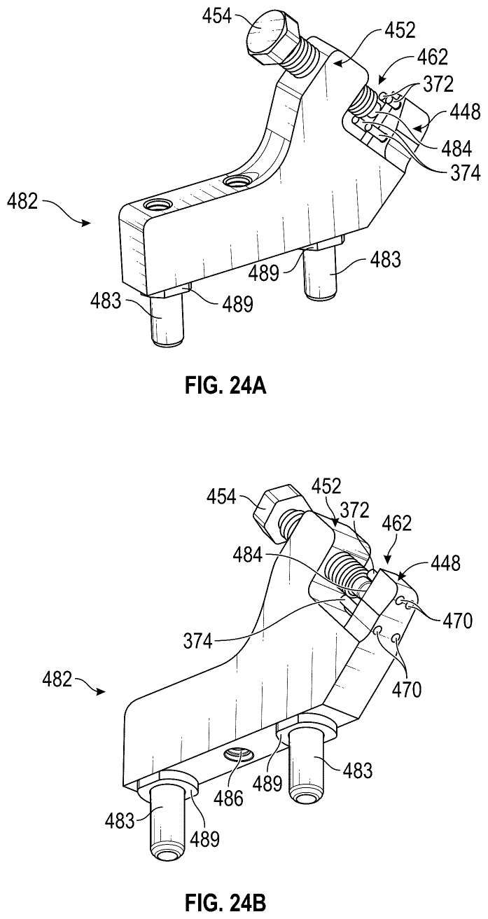

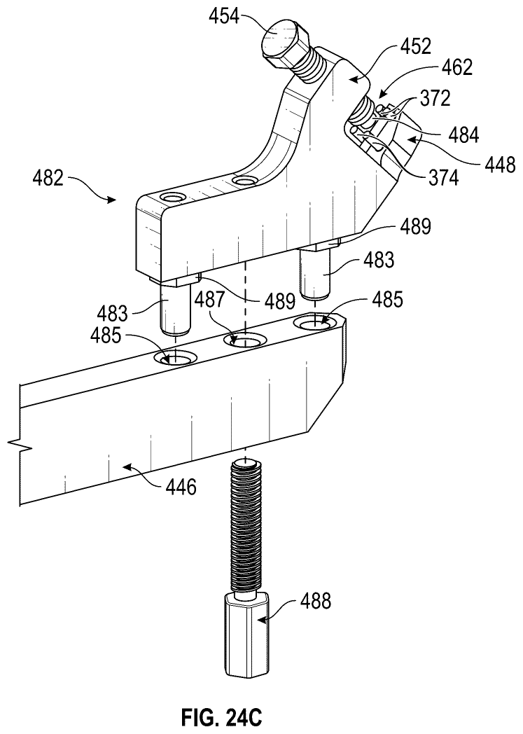

FIGS. 24A-24C illustrate various views of the holder 482 (e.g., clamp, jig, fastener). As described herein, the holder 482 can include pins 483 that can be inserted into the holes 485 of the third segment 446 to couple (e.g., position) the holder 482 on the third segment 446. As shown in FIG. 24C, a screw 488 (e.g., bolt) can be advanced through the hole 487 in the third segment 446 of the arm 426 and into a hole 486 in the holder 482 to secure the holder 482 on the arm 426 (e.g., third segment 446 of the arm 426). The hole 487 can be disposed between the holes 485. The holder 482 can include pin(s) that can support a connector 102 of the archform 100 thereon. For example, the holder 482 can include the upper pin(s) 372 (e.g., two upper pins 372) and/or lower pin(s) 374 (e.g., two lower pins 374). The upper pin(s) 372 and/or lower pin(s) 374 can extend away from the first fixed jaw 448 and toward the second fixed jaw 452 of the holder 482. The upper pin(s) 372 and/or lower pin(s) 374 can extend away from the first fixed jaw 448 and terminate at positions in the gap 462 between the first fixed jaw 448 and the second fixed jaw 452 of the holder 482. In some variants, the upper pin(s) 372 can extend a shorter distance away from the first fixed jaw 448 compared to the lower pin(s) 374. With the connector 102 of the archform 100 disposed on the upper pin(s) 372 and/or lower pin(s) 374, the screw 454 can be advanced to secure the connector 102 between the screw 454 and the first fixed jaw 448. The screw 454 can include a protrusion 484 disposed on an end thereof that can contact the connector 102. The holder 482 can include spacer(s) 489 (e.g., flange(s), rim(s)). The spacer(s) 489 can space a bottom surface of the holder 482 away from a top surface of the third segment 446 of the arm 426 such that there is a gap, which can reduce the rate at which heat is transferred from the holders 482 to the third segments 446 of the arms 426 to enable the archform 100 held by the holders 482 to be efficiently heated to shape setting temperatures. Without a gap, the heat imparted to the archform 100 may escape into the third segments 446 of the arms 426, which can increase the time to heat the archform 100 to high enough temperatures to set the archform 100 in a custom configuration held by the arms 426. The spacer(s) 489 can be incorporated into the pins 483.

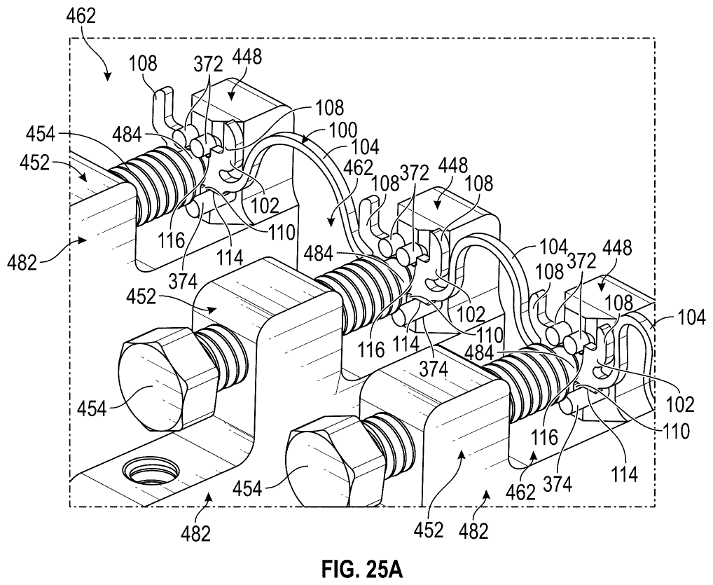

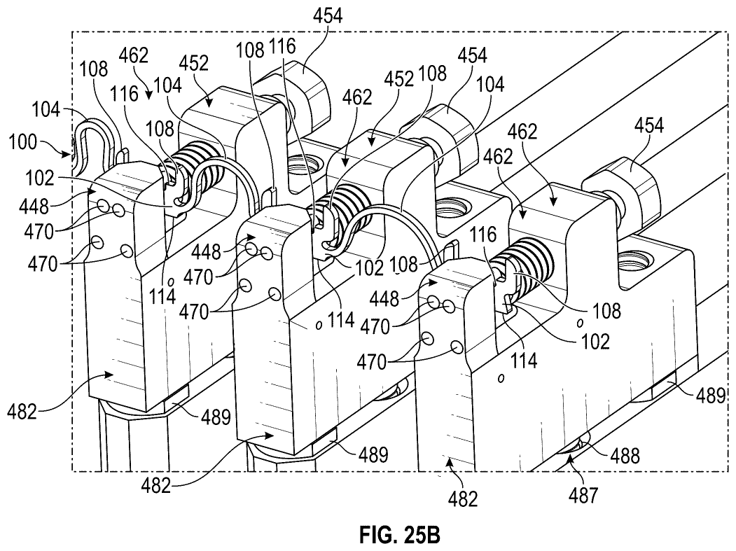

FIGS. 25A and 25B illustrate various views of connectors 102 of the archform 100 held by holders 482 of the shaping system 301. As illustrated, the connectors 102 can be suspended by the upper pins 372 and lower pins 374 in the gaps 462 between the first fixed jaws 448 and the second fixed jaws 452. For example, the tab 110 of the connector 102 can be disposed between the lower pins 374. The contact surfaces 114 of the connector 102 can contact the lower pins 374. The upper pins 372 can be disposed in the recess 116 of the connector 102. The screw 454 can be advanced (e.g., rotated) to secure the connector 102 between the screw 454 (e.g., protrusion 484 of the screw 454) and the first fixed jaw 448.

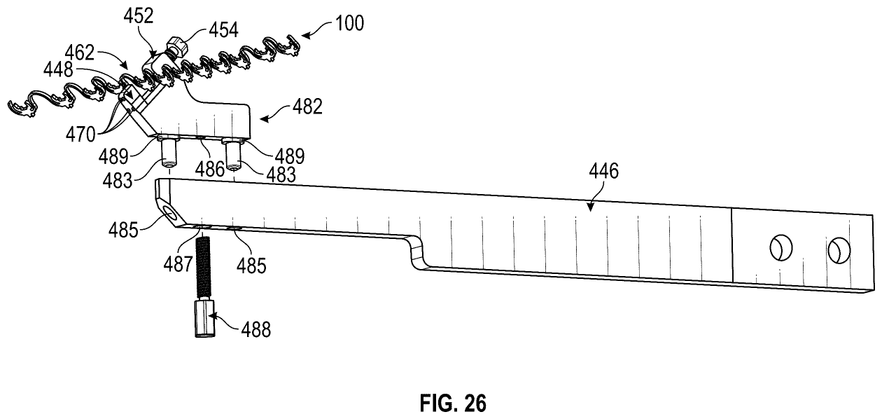

As illustrated in FIG. 26, the holder 482 can be coupled (e.g., clamped) to a connector 102 of the archform 100 prior to coupling the holder 482 to the arm 426 (e.g., third segment 446 of the arm 426). In some variants, all or some of the connectors 102 of the archform 100 can be clamped by holders 482 prior to coupling the holders 482 to the arms 426. In some variants, all or some of the connectors 102 of the archform 100 can be clamped by holders 482 after the holders 482 have been coupled to the arms 426 (e.g., third segments 446 of the arms 426).

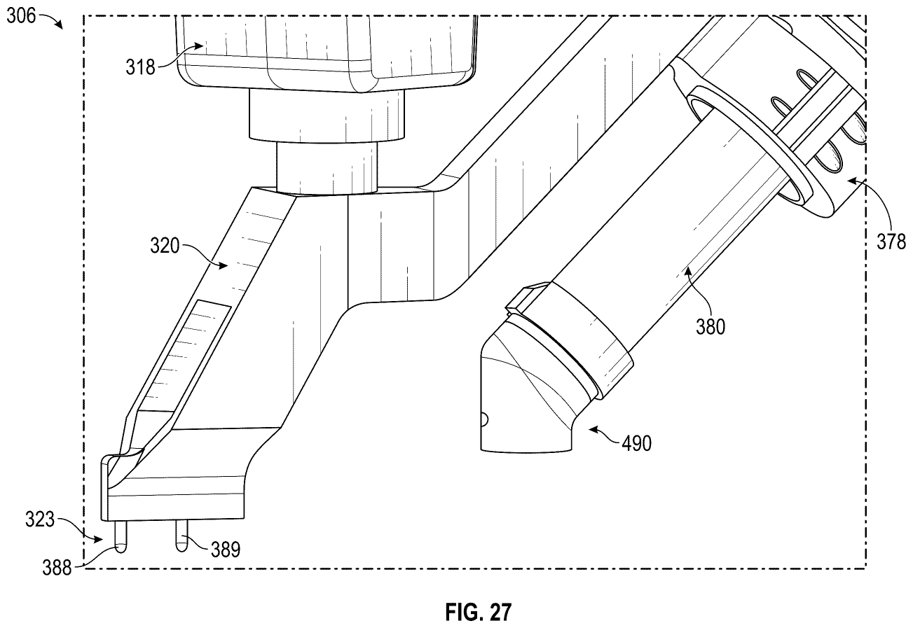

FIG. 27 illustrates the fourth member 320 of the robot 306. As described, the fourth member 320 can include a probe 323, which can include one or more protrusions or the like (e.g., protrusion 388 and protrusion 389) that can interface with features (e.g., holes 485) of the arm 426 (e.g., third segment 446 of the arm 426). The fourth member 320 can include the heat gun 380. For example, the fourth member 320 can include the holder 378 (e.g., mount) to hold the heat gun 380. The heat gun 380 can include the nozzle 490, which can be interchangeable with other nozzles. Heat can be directed through the nozzle 490. The nozzle 490 can be angled away from the fourth member 320 and/or probe 323.

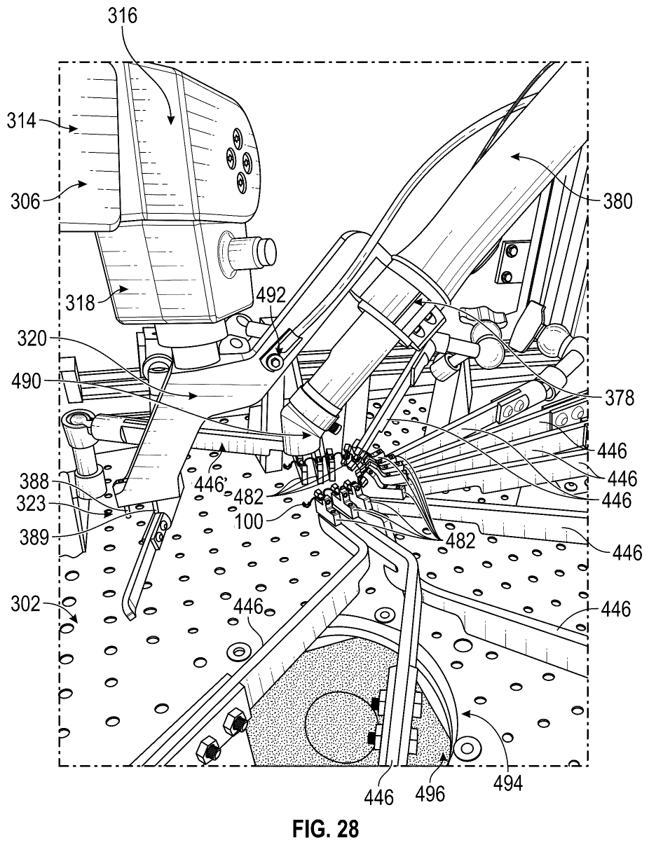

FIG. 28 illustrates the heat gun 380 heating an archform 100 being held by the holders 482 of the arms 426 in a custom configuration. The robot 306 can move the heat gun 380 along the archform 100. The heat gun 380 can move from connector 102 to connector 102 to heat the archform 100. In some variants, the loops 104 can be heated from the connectors 102 being heated. In some variants, the loops 104 can be heated by the heat gun 380 as the heat gun 380 moves between the connectors 102. The heat gun 380 can dwell at connectors 102 for a period of time, the length of which may depend on the thickness of the archform 100.

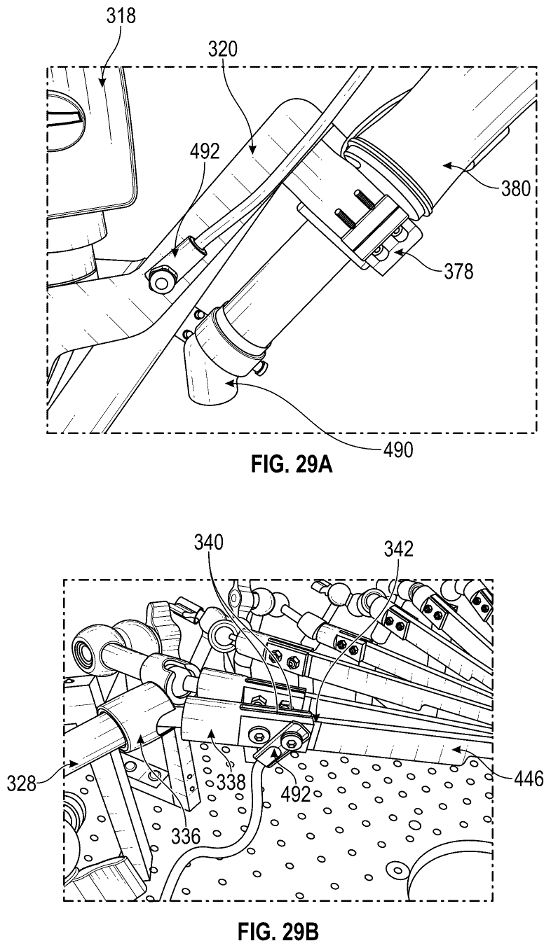

FIGS. 29A and 29B illustrate temperature sensors 492 (e.g., thermocouples) that can be incorporated into the shaping system 301. The shaping system 301 can include a plurality of temperature sensors 492 that can monitor temperatures throughout the shaping system 301 for safety and/or efficacy. The shaping system 301 can include a plurality of temperature sensors 492 (e.g., two) throughout a chamber containing the robot 306 and arms 426 to monitor an overall temperature in the chamber, which can be used to ensure safe temperatures are within the chamber (e.g., air temperature within the chamber) prior to operator access. The shaping system 301 can include a temperature sensor 492 on the heat gun 380 to verify that the heat gun 380 is producing sufficient heat and/or sufficiently cooled down for operator handling. As illustrated in FIG. 29A, a temperature sensor 492 can be disposed on the fourth member 320 of the robot 306 proximate the heat gun 380. As illustrated in FIG. 29B, the arm 426 (e.g., third segment 446) can include one or more temperature sensors 492 (e.g., two), which can include a temperature sensor 492 coupled to a flange 340 of the second mount 338 of the arm 426. The one or more temperature sensors 492 on the arm 426 can verify that the arm 426 has cooled to a temperature safe for operator handling. In some variants, the probe 323 and/or other portions of the fourth member 320 can include one or more temperature sensors 492.

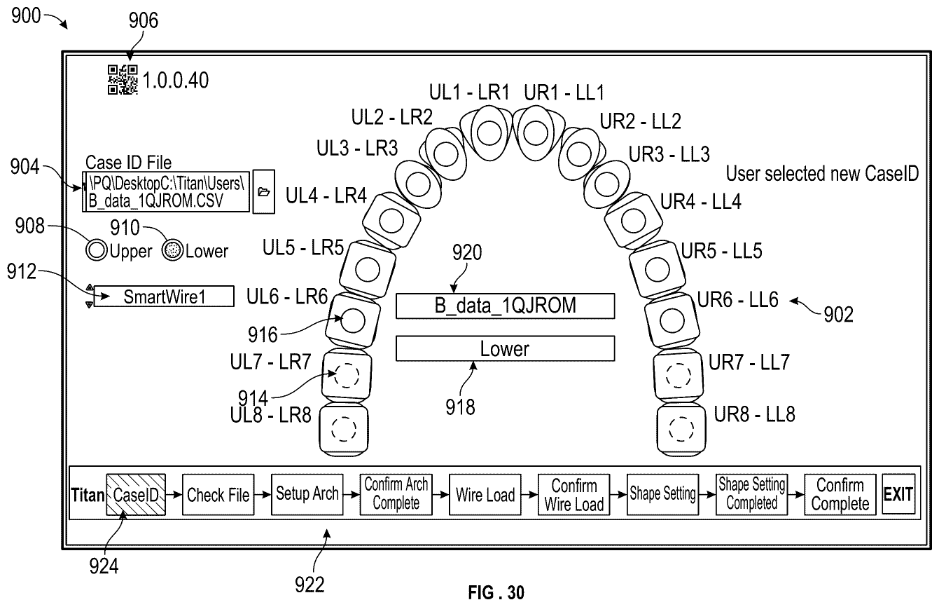

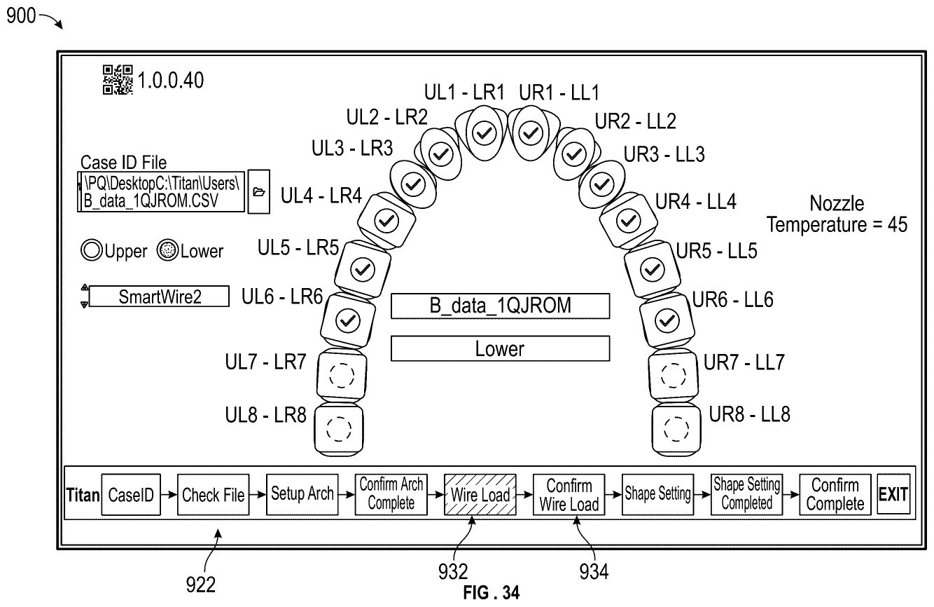

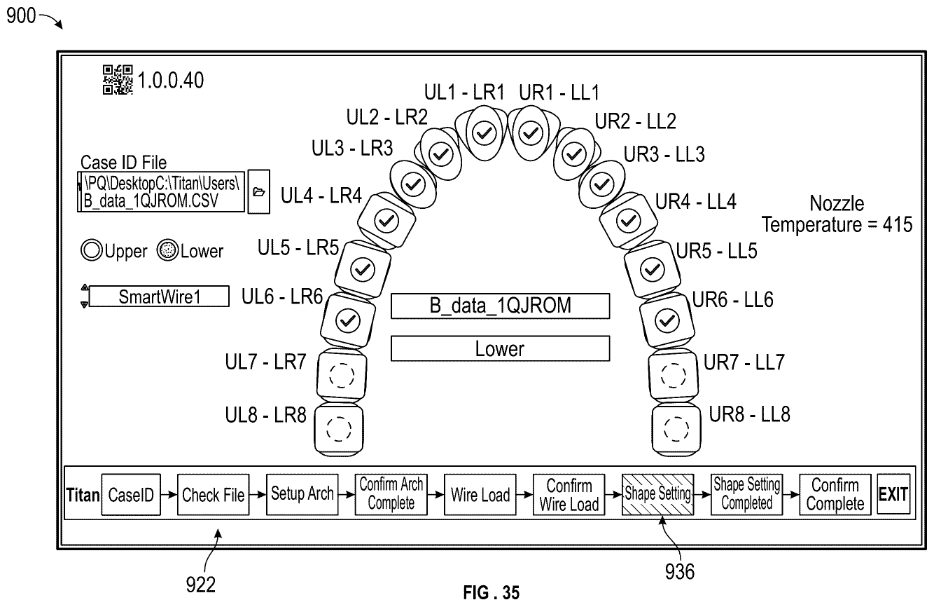

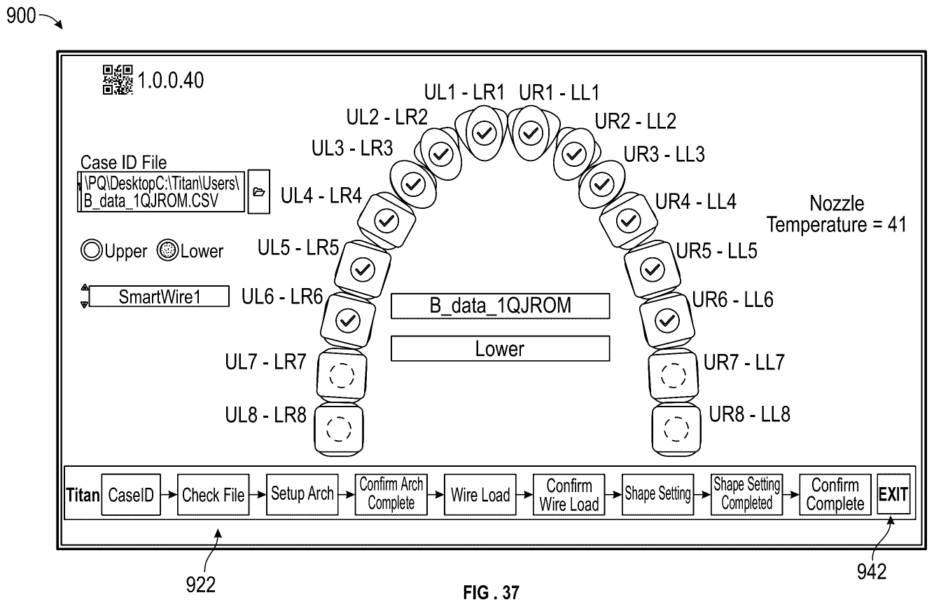

FIGS. 30-37 illustrate various example user interfaces that can be used with the shaping system 300 and/or shaping system 301. FIGS. 30-37 illustrate example user interfaces that may guide an operator through the shape setting process for one or more archforms 100 using the shaping system 300 and/or shaping system 301. The user interfaces can be displayed on a touch screen to both communicate information to an operator and/or receive input from the operator. The shaping system 300 and/or shaping system 301 may include another input device, such as a keyboard, pointing device (e.g., mouse), to enable an operator or the like to input to provide information and/or commands to the shaping system 300 and/or shaping system 301. The user interfaces shown are exemplary and should not be considered limiting.

As shown in FIG. 30, the user interface 900 can include a case identification (ID) file input 904 (e.g., case ID selection interface, patient case file selection interface, patient case file input, patient ID selection, etc.). An operator can navigate to a patient's treatment plan data (e.g., file) by way of the case ID file input 904. The data can include the planned configuration for archform(s) used in a patient's treatment plan (e.g., positioning of the digital markers in the virtual model), the types and/or numbers of archform(s) used in a patient's treatment plan, and/or other information. The patient's treatment plan data can be provided to the robot 306.

The user interface 900 can include an upper arch selection input 908 and/or a lower arch selection input 910. The operator can select (e.g., toggle) between the upper arch selection input 908 and/or lower arch selection input 910 to indicate the relevant arch (e.g., upper arch or lower arch) for configuring an archform. For example, the operator can begin with shape setting archform(s) for the upper arch and interact with the upper arch selection input 908 accordingly (e.g., click the upper arch selection input 908) to select the upper arch. The operator can then interact with the lower arch selection input 910 to select the lower arch to begin shape setting archform(s) for the lower arch.

The user interface 900 can include an archform selection input 912. The operator can select between different archform types by way of the archform selection input 912. For example, a patient's treatment plan data may indicate that three archforms (e.g., SmartWire1, SmartWire 2, and SmartWire 3) will be used in series to move the patient's teeth from an initial configuration to a planned configuration. The three archforms can be increasingly stiff to comfortably move the patient's teeth with the first archform being the least stiff and the third archform being the most stiff. The stiffness of the three archforms can be altered by increasing a thickness of the archforms (e.g., thickness in a buccal-lingual direction). For example, the second archform can be thicker than the first archform and the third archform can be thicker than the second archform. With differing thicknesses, the heat setting protocol for the three archforms can be different. For example, a thicker archform may be exposed to a heat source (e.g., heat from the heat gun 380) for a longer period of time compared to a thinner archform to set the thicker archform in the configuration held by the plurality of arms 426. Accordingly, the operator can select which archform of a selection of archforms will be shape set by way of the archform selection input 912, which can determine heat setting protocols used by the shaping system 300 and/or shaping system 301.

The user interface 900 can include a case indicator 920, which can indicate the patient case selected by the operator by way of the case ID file input 904. The case indicator 920 can include patient identifying information, which can at least include a patient's name, identification number, patient's file name, and/or other information.

The user interface 900 can include an arch indicator 918, which can indicate the arch (e.g., upper or lower) selected by the operator with the upper arch selection input 908 or lower arch selection input 910. The arch indicator 918 can indicate the arch (e.g., upper or lower) for which the current archform is being set.

The user interface 900 can include an arch status indicator 902. The arch status indicator 902 can digitally represent an arch of teeth (e.g., lower or upper arch). For example, the arch status indicator 902 can digitally represent a lower arch with UL1-UL8 and UR1-UR8, as shown in FIG. 30. As described herein, a connector 102 can correspond to an individual tooth of the arch. Accordingly, UL1 may correspond to a connector 102, UL2 may correspond to another connector 102, UL3 may correspond to yet another connector 102, etc. A connector 102 may correspond to each and every tooth of a dental arch and/or dental arch segment. A connector 102 may correspond to some teeth of a dental arch segment. Accordingly, the represented teeth in the arch status indicator 802 may correspond to associated connectors 102. As described herein, loops 104 may be disposed between adjacent connectors 102.

The arch status indicator 902 can include treatment indicators 916. A treatment indicator 916 can be associated with each tooth to be treated with orthodontic treatment. For example, if a tooth will not be connected with a connector 102 of an archform 100, the digital representation of that tooth in the arch status indicator 902 may not include an arch status indicator 902. Similarly, if a patient is missing a tooth, the digital representation of the tooth that corresponds to the missing tooth may not include an arch status indicator 902. The treatment indicator 916 can visually indicate to an operator if a tooth is to be treated by orthodontic treatment by the archform 100 (e.g., if there is a connector 102 to be positioned for that tooth by the shaping system 300 or shaping system 301). The treatment indicator 916 can be a circle or other shape defined by a solid line.

The arch status indicator 902 can include one or more no treatment indicators 914. A no treatment indicator 914 can be associated with each tooth to not be treated with orthodontic treatment. For example, if a tooth will not be connected with a connector 102 of an archform 100, the digital representation of that tooth in the arch status indicator 902 may include a no treatment indicator 914. Similarly, if a patient is missing a tooth, the digital representation of the tooth that corresponds to the missing tooth may include a no treatment indicator 914. The no treatment indicator 914 can visually indicate to an operator if a tooth is not to be treated by orthodontic treatment by the archform 100 (e.g., if there is not a connector 102 to be positioned for that tooth by the shaping system 301 or shaping system 301). The no treatment indicator 914 can be a circle or other shape defined by a dashed line.

The user interface 900 can include a process status indicator 922, which can indicate the current status of and/or step of the shape setting process being performed by the shaping system 300 and/or shaping system 301. The process status indicator 922 can display various possible steps and/or statuses in sequence, as illustrated in FIG. 30. The process status indicator 922 may display an archwire setting flow chart and indicate the current step and/or status of the shaping system 300 or shaping system 301. For example, the process status indicator 922 may at least display one or more of the possible steps for the process of shape setting the archform 100, which can at least include Case ID, Check File, Setup Arch, Confirm Arch Complete, Wire Load, Shape Setting, Shape Setting Completed, and/or Confirm Complete. As the shaping system 300 or shaping system 301 progresses through the steps, the process status indicator 922 can highlight and/or otherwise indicate (e.g., indicate, emphasize, etc.) when a step is in process and/or complete.

The process status indicator 922 can include a case ID input 924. The case ID input 924 can indicate that the operator is in the process of utilizing the case ID file input 904 to select a patient's treatment data, upper arch selection input 908, lower arch selection input 910, and/or archform selection input 912. In some variants, the operator may interact (e.g., select, touch, push) the case ID input 924 to utilize one or more of the case ID file input 904, upper arch selection input 908, lower arch selection input 910, and/or archform selection input 912. For example, the operator may use the case ID file input 904 to start shape setting archforms for another patient. The operator may use the upper arch selection input 908 and/or lower arch selection input 910 to switch between data corresponding to shaping an archform corresponding to the upper arch or the lower arch. The operator may use the archform selection input 912 to select a type of archform to shape set, which can be associated with different heating protocols.

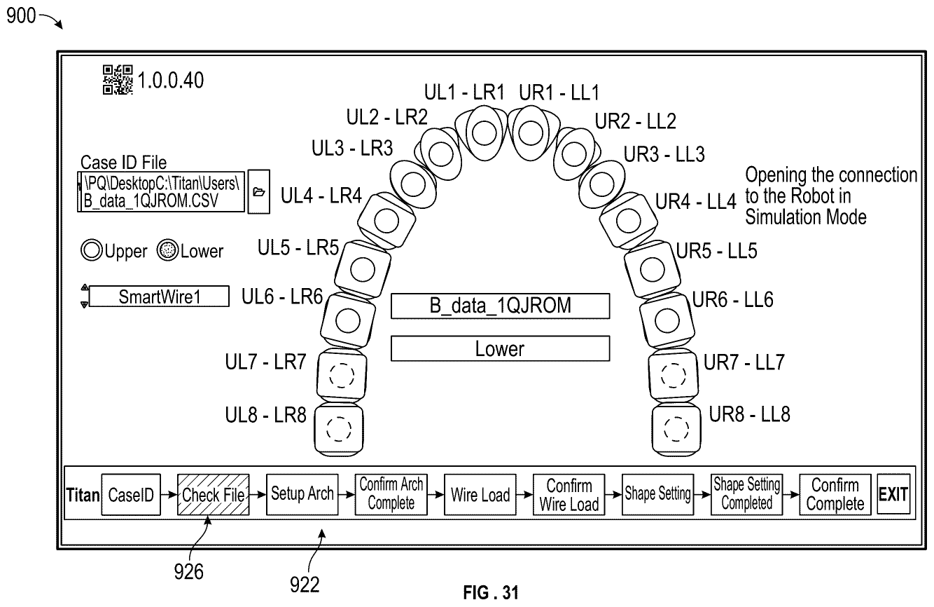

As illustrated in FIG. 31, the process status indicator 922 can include a check file input 926. The operator can interact with (e.g., select, touch, push) the check file input 926 to verify that the robot 306 can indicate the positioning for each arm 326 for each connector 102 of the archform 100. For example, the robot 306 can run a virtual simulation indicating all of the positions for the arms 326. The shaping system 300 and/or shaping system 301 can verify that the indications can be performed by the robot 306, which can include ensuring that there are no singularities, missing data, and/or an error in the patient's treatment data.

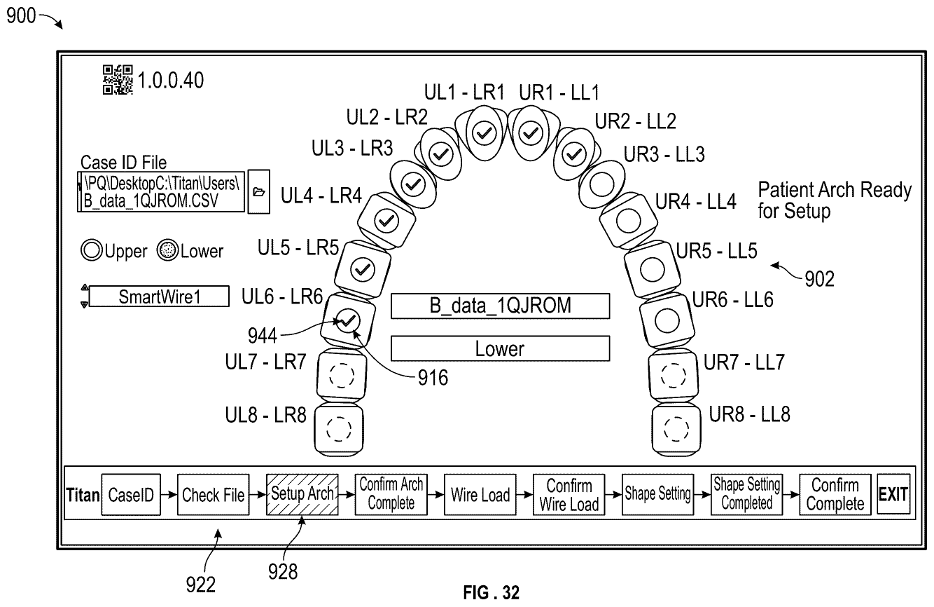

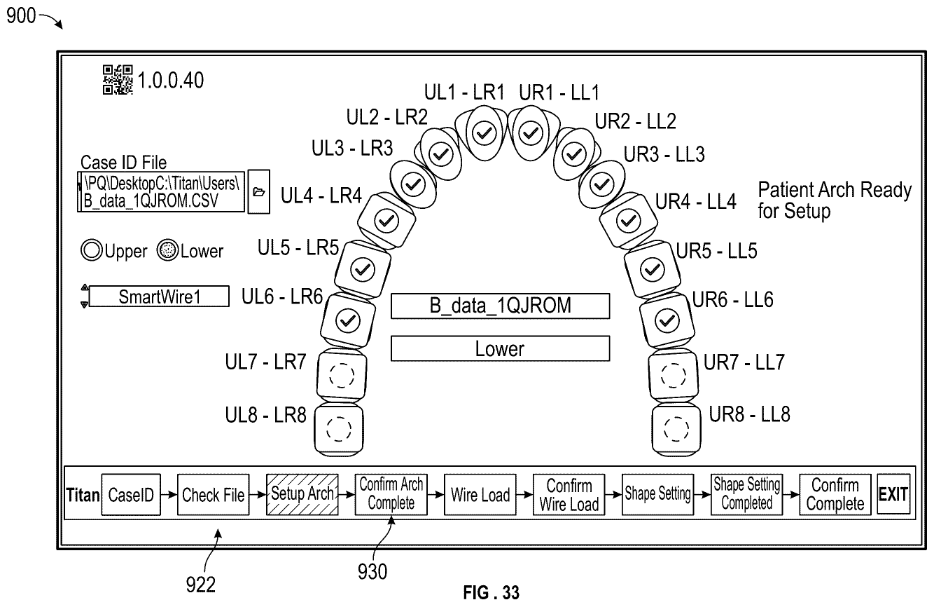

As illustrated in FIG. 32, the process status indicator 922 can include a setup arch input 928, which can proceed after the check file has been performed. At this step, the shaping system 300 and/or shaping system 301 can indicate the positioning for the arms 426. In some variants, the shaping system 300 and/or shaping system 301 can include an light (e.g., white light) and/or sound that can alert the operator that the shaping system 300 and/or shaping system 301 is ready for arm positioning. As described herein, the operator can initiate the positioning process by interacting (e.g., pushing) the first button 506 of an arm 426. The robot 306 can move the probe 323 to an approach position for the corresponding arm 426, which can be proximate an indicating position. In some variants, the operator must hold the first button 506 until the robot 306 moves the probe 323 to the approach position. The operator can then interaction with (e.g., press) the second button 504 to prompt the robot 306 to translate the probe 323 along a vector to the indicating position. In some variants, the operator must hold the second button 504 until the robot 306 moves the probe 323 to the indicating position. With the probe 323 in the indicating position, the operator can move the arm 426 such that the holes 485 receive the protrusion 389 and protrusion 388, which can include advancing the arm 426 until the surfaces of the third segment 446 around the holes 485 contact the surface of the probe 323 around the protrusion 388 and protrusion 389. With the arm 426 positioned, the arm 426 can be locked in place, which can include rotating the knob 386. The operator can then press the third button 502 to indicate that the arm 426 is positioned, which can prompt the user interface 900 to show an arm positioned indicator 944 (e.g., positioning complete indication) for the corresponding tooth in the arch status indicator 902. The arm positioned indicator 944 can visually indicate that the positioning of the arm 426 corresponding to the relevant tooth shown in the arch status indicator 902 is complete. The arm positioned indicator 944 can, in some variants, be a check mark or “x.” The operator can repeat this process for each tooth of the arch status indicator 902 with a treatment indicator 916. When the arms 426 are positioned, a confirm arch setup complete button 930 can become active, which the operator can interact with (e.g., select, touch, push) to confirm that all of the arms 426 that were planned to be positioned have been positioned, as shown in FIG. 33.

In response to the operator interacting with the confirm arch setup complete button 930, the process status indicator 922 can indicate the wire load indication 932 to indicate that the process is at the archform loading step. In some variants, the operator can interact with (e.g., select, touch, push) the wire load input 932 to initiate the wire load process. The robot 306 can move to a position away from the arms 426 (e.g., to an elevated position) to provide the operator with more space to couple the connectors 102 of the archform 100 to the arms 426. As detailed herein, the operator can couple (e.g., clamp) each connector 102 with a respective holder 482. The holders 482 can then be coupled to the arms 426. In some variants, the holders 482 may already be coupled to the arms 426 prior to coupling the holders 482 with the connectors 102. With the connectors 102 coupled to the holders 482 coupled to the third segment 446 of the arms 426, the operator may interact with (e.g., select, touch, push) a confirm load wire input 934 to confirm that the archform 100 is loaded.

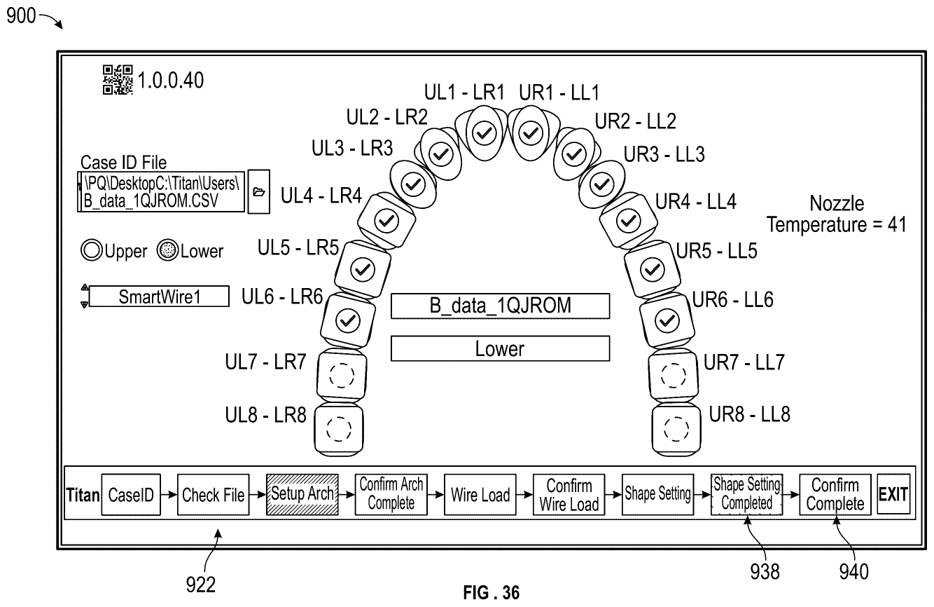

In response to the operator interacting with the confirm load wire input 934 to confirm the archform 100 is loaded, the process status indicator 922 can indicate (e.g., highlight) the shape setting indication 936 to indicate that the process is at the shape setting step. In some variants, the operator may interact with (e.g., select, touch, push) the shape setting indication 936 to initiate the shape setting process. The robot 306 can proceed to heat the archform 100 to set the archform 100 in the custom configuration held by the arms 426. As described herein, the robot 306 can use the heat gun 380 to heat the archform 100. In some variants, the robot 306 can target each connector 102 of the archform 100 with the heat gun 380 for a duration of time before proceeding to the next connector 102 until all have been targeted (e.g., heated). As detailed herein, the heat gun 380 can dwell at each connector 102 for a longer period of time for thicker archforms 100 compared to thinner archforms 100. In some variants, the chamber holding the robot 306 and arms 426 can be locked during the shape setting process. When the heating process is complete, the shaping system 300 and/or shaping system 301 can cool the robot 306, arms 426, archform 100, and/or chamber. In some variants, the chamber may remain locked until temperatures of the robot 306, arms 426, archform 100, and/or chamber have fallen below a threshold. As illustrated in FIG. 36, the process status indicator 922 can indicate (e.g., highlights) a shape setting completed indicator 938 when the shape setting process (e.g., heating and/or cooling) is completed. The process status indicator 922 can activate a confirm complete input 940, which the operator can interact with (e.g., select, touch, push) to indicate that the shape setting process for the present archform 100 is complete.

In response to the operator interacting with the confirm complete input 940, the process status indicator 922 can activate three inputs (e.g., buttons) for the operator—the case ID input 924, setup arch input 928, and/or wire load input 932. If the operator desires to begin shape setting archforms for a different patient, the operator can interact with the case ID input 924 and then proceed to utilize the case ID input 904 to select a different patient's data and proceed as described herein. If the operator desires to begin shape setting archforms for a different arch of the same patient, the operator can interact with the setup arch input 928, interact with the upper arch selection input 908 or lower arch selection input 910 to select an arch, and then proceed to position the arms 426 as described herein. If the operator desires to begin shape setting a different type of archform (e.g., different thickness) for the same patient, the operator can interact with the wire load input 932, the operator can interact with the archform selection input 912 to select an archform type (e.g., SmartWire 1, SmartWire 2), and then proceed to load the archform as described herein. Alternatively, the operator can interact with (e.g., touch, push) the exit input 942 to exit the application of the shaping system 300 and/or shaping system 301.

The user interface 900 can communicate other information to the operator. For example, the user interface 900 may indicate temperatures of features of the shaping system 300 and/or shaping system 301 and/or inside the chamber holding the robot 306 and/or arms 426. For example, as illustrated in FIG. 36, the user interface 900 is indicating that the temperature at the nozzle 490 of the heat gun 380 is 41 degrees Celsius. The user interface 900 can indicate the current status of the shape setting process.

In some embodiments, the systems, processes, and methods described herein can be implemented using a computing system. For example, the shaping system 300 and/or shaping system 301 can be implemented using a computing system. The shaping system 300 and/or shaping system 301 can be in communication with one or more computing systems and/or data sources by way of one or more networks. The computing system can facilitate carrying out the functions, methods, acts, and/or processes described herein. The computing system can include a module that can be executed by a central processing unit.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system can include one or more processing units (CPU), which may comprise a microprocessor. The computer system can include a physical memory, such as random-access memory (RAM) for temporary storage of information, a read only memory (ROM) for permanent storage of information, and a mass storage device, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system can be connected using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system can include one or more input/output (I/O) devices and interfaces, such as a keyboard, mouse, touch pad, and printer. The I/O devices and interfaces can include one or more display devices, such as a monitor, that allows the visual presentation of data to a user. More particularly, a display device provides for the presentation of GUIs as application software data, and multi-media presentations, for example. The I/O devices and interfaces can also provide a communications interface to various external devices. The computer system can include one or more multi-media devices, such as speakers, video cards, graphics accelerators, and microphones, for example.

The computer system can run on a variety of computing devices, such as a server, a Windows server, a Structure Query Language server, a Unix Server, a personal computer, a laptop computer, and so forth. In other embodiments, the computer system may run on a cluster computer system, a mainframe computer system and/or other computing system suitable for controlling and/or communicating with large databases, performing high volume transaction processing, and generating reports from large databases. The computing system can be generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system can be coupled to a network, such as a LAN, WAN, or the Internet via a communication link (wired, wireless, or a combination thereof). The network can communicate with various computing devices and/or other electronic devices. The network can communicate with one or more computing systems and one or more data sources. The module can access or may be accessed by computing systems and/or data sources through a web-enabled user access point. Connections may be a direct physical connection, a virtual connection, and other connection type. The web-enabled user access point may comprise a browser module that uses text, graphics, audio, video, and other media to present data and to allow interaction with data via the network.

Depending on the embodiment, certain acts, events, or functions of any of the processes or algorithms described herein can be performed in a different sequence, can be added, merged, or left out altogether (for example, not all described operations or events are necessary for the practice of the algorithm). Moreover, in certain embodiments, operations or events can be performed concurrently.

The various illustrative logical blocks, modular dispensers, routines, and algorithm steps described in connection with the embodiments disclosed herein can be implemented as electronic hardware, computer software, or combinations of both. To clearly illustrate this interchangeability of hardware and software, various illustrative components, blocks, modular dispensers, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modular dispensers described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

It is intended that the scope of this present invention herein disclosed should not be limited by the particular disclosed embodiments described above. This invention is susceptible to various modifications and alternative forms, and specific examples have been shown in the drawings and are herein described in detail. This invention is not limited to the detailed forms or methods disclosed, but rather covers all equivalents, modifications, and alternatives falling within the scope and spirit of the various embodiments described and the appended claims. Various features of the orthodontic brackets and archforms described herein can be combined to form further embodiments, which are part of this disclosure.

Methods of using the orthodontic brackets and/or archforms (including device(s), apparatus(es), assembly(ies), structure(s) or the like) are included herein; the methods of use can include using or assembling any one or more of the features disclosed herein to achieve functions and/or features of the system(s) as discussed in this disclosure. Methods of manufacturing the foregoing system(s) are included; the methods of manufacture can include providing, making, connecting, assembling, and/or installing any one or more of the features of the system(s) disclosed herein to achieve functions and/or features of the system(s) as discussed in this disclosure.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “tying a tie onto an orthodontic bracket” includes “instructing the tying of a tie onto an orthodontic bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

1-18. (canceled)

19. A method of custom shaping an archform, the method comprising:
indicating positions for a plurality of arms configured to hold portions of an archform, the positions corresponding to digital positions of digital markers in a virtual model of teeth of a patient in a planned alignment;
moving the plurality of arms to the indicated positions; and
securing the portions of the archform to the plurality of arms such that the archform assumes a custom nonplanar shape corresponding to the digital positions of the digital markers in the virtual model of the teeth of the patient in the planned alignment.

20. The method of claim 19, wherein indicating positions for the plurality of arms comprises actuating a robot to indicate the positions.

21. The method of claim 19, wherein the custom nonplanar shape is configured to move the teeth of the patient toward a configuration corresponding to the planned alignment of the teeth of the patient in the virtual model when the archform is coupled to brackets in a patient's mouth.

22. The method of claim 19, wherein the custom nonplanar shape is configured to move the teeth of the patient toward a configuration corresponding to the planned alignment of the digital teeth of the patient in the virtual model when the archform is bonded to the teeth of the patient.

23. The method of claim 19, wherein the portions of the archform are connectors configured to couple with orthodontic brackets.

24. The method of claim 19, wherein securing the portions of the archform comprises clamping the portions with clamps of the plurality of arms.

25. The method of claim 24, wherein securing the portions of the archform comprises coupling the clamps to the plurality of arms.

26. The method of claim 24, wherein securing the portions of the archform with the clamps further comprises positioning connectors of the archform between a moveable jaw and a fixed jaw of the clamps of the plurality of arms and advancing the moveable jaw toward the fixed jaw to clamp the connectors.

27. The method of claim 24, wherein clamping the portions with clamps further comprises positioning connectors of the archform between a screw and a fixed jaw of the clamps of the plurality of arms and advancing the screw toward the fixed jaw to clamp the connectors.

28. The method of claim 24, wherein securing the portions of the archform with the clamps comprises disposing connectors of the archform on pins of the clamps.

29. The method of claim 19, wherein the archform is a non-sliding archform configured to be installed on a lingual side of the teeth of the patient.

30. The method of claim 19, further comprising heat setting the archform in the custom nonplanar shape such that the custom nonplanar shape is a default shape of the archform.

31. The method of claim 30, wherein heat setting comprises heating the archform with a heat gun.

32. The method of claim 30, wherein heat setting comprises applying an electrical current to the archform.

33. The method of claim 19, further comprising heat treating the archform to set a transition temperature for the archform between a martensite phase and an austenite phase.

34. The method of claim 20, wherein actuating the robot to indicate positions for the plurality of arms comprises moving a probe with protrusions to the positions.

35. The method of claim 34, wherein moving the plurality of arms to the positions indicated by the robot further comprises moving each of the plurality of arms to position the protrusions of the probe into holes in the plurality of arms.

36-43. (canceled)

44. A system for custom shaping an archform for orthodontic treatment, the system comprising:
a plurality of arms, each of the plurality of arms comprising a clamp configured to hold a portion of the archform; and
an automated probe configured to indicate positions for each of the plurality of arms based on a positioning of digital markers in a virtual model of teeth of a patient in a planned alignment;
wherein the archform assumes a custom nonplanar shape corresponding to the positioning of the digital markers in the virtual model with the archform held by clamps of the plurality of arms in the positions indicated by the automated probe.

45. (canceled)

46. (canceled)

47. (canceled)

48. (canceled)

49. The system of claim 44, wherein the automated probe comprises a plurality of protrusions and each of the plurality of arms comprises a plurality of holes corresponding to the plurality of protrusions, the plurality of protrusions configured to be inserted into the plurality of holes to orient each of the plurality of arms to a position indicated by the automated probe.

50. (canceled)

51. The system of claim 44, wherein each of the plurality of arms comprises a feature configured to interface with the automated probe to assist in positioning the plurality of arms in the positions indicated by the automated probe.

52-60. (canceled)
